(19) United States
(12) Patent Application Publication
(10) Pub. No.: US 2002/0031141 A1
(43) Pub. Date: Mar. 14, 2002

(54) Method of detecting back pressure in a communication system using an utopia-LVDS bridge

(76) Inventor: Patrick McWilliams, Belfast (IE)

Correspondence Address: Robinson & Post, L.L.P., North Dallas Bank Tower, Suite 575, 12900 Preston Road, LB-41, Dallas, TX, 75230, US

(21) Appl. No.: 09/865,949

(22) Filed: May 25, 2001

Related U.S. Application Data
(60) Provisional application No. 60/207,102, filed on May 25, 2000.

(51) Int. Cl. H04L 12/66

(52) U.S. Cl. 370/463; 370/465; 370/466; 370/469; 370/474

(57) ABSTRACT

An UTOPIA-LVDS Bridge is a flexible Utopia to LVDS Bridge device. The LVDS Bridge transparently transports the UTOPIA bus over a high speed LVDS serial link. The device includes many reliability features such as an optional 1:1 protection and built in bit error rate checking. A parallel interface is user programmable for maximum flexibility. The user can choose between UTOPIA Level 2 ATM Layer (master) or PHY Layer 14 (slave) operation. The UTOPIA-LVDS Bridge supports a special MPHY (multi-PHY Layer 14) operation mode. The MPHY operation supports up to 248 standard UTOPIA Level 2 PHY ports without adding external circuitry. The serial interface uses LVDS Serializer and Deserializer technology. The 16:1 bit serialization allows conveying the full-duplex parallel bus over two differential transmission pairs. Bus LVDS technology also enables multi-drop configurations for distributing the UTOPIA bus to multiple Bridge receivers.

### BACKGROUND OF THE INVENTION

This application was originally filed as a Provisional Patent Application. Application No. 60/207,102, Filing Date: May 25, 2000

This invention relates to communication systems that include a flexible UTOPIA to LVDS Bridge device. The LVDS Bridge transparently transports the UTOPIA bus over a high speed LVDS serial link. The device includes many reliable features such as an optional 1:1 protection and built in bit error rate checking.

### DEFINITIONS

Cell

A unit of transmission in ATM. A fixed-size frame consisting of a 5-octet header and a 48-octet payload.

CLAV

A signal indicating that a level (ATM or PHY) has a full cell to transmit.

ENB

A signal indicating that a level (ATM or PHY) can accept the transfer of a full cell.

LVDS

A Low Voltage Differential Signaling Standard is an extension to the SCIIEEE 1596 standard (1596.3) for transmission of both narrow (4,4 bit) and wide (32,64,128 bit) links with transfer rate of at least 200 mega-transfers per second. The objectives of 1596.3 are: Technology independence, CMOS compatible, Backplane and cable applicable (up 5 m), scalable and supplementing SCI's 16 bit wide links with 4 and 8 bit. Typical characteristics are 500 Mbit/s per line and 250 mV to 400 mV signal swing centered at 1.2 Volt. Very low power dissipation.

OAM

Operations Administration and Maintenance: A group of network management functions that provide network fault indication, performance information, and data and diagnosis functions.

PDU

Protocol Data Unit for an ATM Cell.

PHY

OSI Physical Layer: The physical layer provides for transmission of cells over a physical medium connecting two ATM devices. This physical layer is comprised of two sublayers: the PMD Physical Medium Dependent sublayer, and the TC Transmission Convergence sublayer.

Physical Layer (PHY) Connection

An association established by the PHY between two or more ATM entities. A PHY connection consists of the concatenation of PHY links in order to provide an end-to-end transfer capability to PHY SAPs.

SAP

Service Access Point: A SAP is used for the following purposes:

1. When the application initiates an outgoing call to a remote ATM device, a destination SAP specifies the ATM address of the remote device, plus further addressing that identifies the target software entity within the remote device.

2. When the application prepares to respond to incoming calls from remote ATM devices, a local SAP specifies the ATM address of the device housing the application, plus further addressing that identifies the application within the local device.

There are several groups of SAPs that are specified as valid for Native ATM Services.

Utopia

Universal Test & Operations Interface for ATM: Refers to an electrical interface between the TC and PMD sublayers of the PHY Layer 14.

### DESCRIPTION OF THE PRIOR ART

ATM is a network protocol and switch-based method of communication which breaks down a communication process into several sub-processes arranged in a stack. Each layer of the protocol stack provides services to the layer above it which allows the top most processes to communicate. Each layer communicates with another layer over defined interfaces enabling two different devices, using hardware and software from different manufacturers, but still conforming to the ATM model, to communicate over an ATM network. Using ATM, information sent over a network is segmented into a fixed length cell. The ATM cell has a fixed length of 53 bytes comprising 5 bytes of header information and 48 bytes of data information (e.g. voice, data, or video information). However, since some PHY Layer 14 devices operate at high bandwidths, the ATM Layer 12 device is designed to operate at a high bandwidth in order to keep pace. However, some inexpensive PHY Layer 14 devices operate at only a fraction of the ATM Layer 12 bandwidth thereby wasting a large portion of the ATM Layer 12 bandwidth needlessly. In these mismatched bandwidth systems, the system cost is reduced if several low bandwidth PHY Layer 14 devices are connected to a single ATM Layer 12 device.

Two layers in the protocol stack are the asynchronous transfer mode (ATM) layer and the physical (PHY) layer. The PHY Layer 14 interfaces directly to network media (e.g. fiber optics, twisted pair, etc.) and also handles transmission convergence (extracting ATM cells from the transport encoding scheme). The ATM Layer 12 and the PHY Layer 14 communicate over a parallel bus termed the Universal Test and Operations PHY Interface for ATM (UTOPIA) developed by the ATM forum. The UTOPIA bus is a bi-directional bus which transmits and receives ATM cells simultaneously. The UTOPIA bus is defined to support numerous transmission rates defined for ATM, including transmission rates as high as 622 Mbps. The UTOPIA bus defines two interface signal groups: Transmit and Receive. As illustrated in FIG. 1a, the Transmit interface 16 moves data information from the ATM layer 12 to the PHY layer 14, while the Receive interface 18 moves information from the ATM layer 12 to the PHY layer 14.

As illustrated in FIG. 1b, the Transmit interface comprises a parallel transmit data bus TxData 20 which may be, for example, 8-bits or 16-bits wide, and a number of control signals which may be utilized in the Octet Level Handshaking (OLH) mode or the Cell Level Handshaking (CLH) mode. In CLH mode data is moved between ATM layer 12 and PHY layer 14 as an entire uninterrupted cell. The transmit control signals include: transmit enable signal TxEnb* 22 which when asserted low by ATM layer 12 indicates that TxData 20 contains valid cell data; transmit start of cell signal TxSOC 24 which is asserted high by ATM layer 12 when TxData 20 contains the first valid byte of cell data; transmit full/cell available signal TxFull*/TxClav 26 which in CLH mode is asserted high by PHY layer 14 when it can accept a full cell of data, and is asserted low by PHY layer 14 when it is “full” and cannot accept a full cell of data; and transmit clock signal TxClk 28 which is provided by ATM layer 12 for synchronization of the data transfer from ATM layer 12 to PHY layer 14. Transmitting data from ATM layer 12 to PHY layer 14 in the CLH mode of operation is generally as follows. PHY layer 14 indicates to ATM layer 12 that it can accept a complete cell of data (53 bytes) by asserting TxFull*/TxClav to a high logic level. When ATM layer 12 has a complete cell to transfer to PHY layer 14, it asserts TxEnb* to a low logic level and places the first byte of data onto data bus TxData 20. Additionally, ATM layer 12 asserts TxSOC 24 to a high logic level along with the first byte of data. TxSOC 24 remains at a high logic level for the first cycle only. Each of the remaining 52 bytes of cell data are then transferred to PHY layer 14 per clock cycle of TxCLK 28.

In like manner, FIG. 1b also illustrates the Receive interface comprising a parallel receive bus RxData 30 which may be, for example, 8-bits or 16-bits wide, and a number of control signals similar to the those described with respect to the Transmit interface. The receive control signals include: receive enable signal RxEnb* 32 which when asserted low by ATM layer 12 indicates that RxData 30 and RxSOC 34 will be sampled at the end of the next cycle; receive start of cell signal RxSOC 34 which is asserted by PHY layer 14 when RxData 30 contains the first valid byte of cell data; receive empty/cell available signal RxEmpty*/RxClav 36 which in CLH mode is asserted high by PHY layer 14 when it has a full cell of data to send to ATM layer 12, and is asserted low by PHY layer 14 when it is “empty” and does not have a full cell of data to send to ATM layer 12; and receive clock signal RxClk 38 which is provided by ATM layer 12 for synchronization of the data transfer from PHY layer 14 to ATM layer 12.

Receiving data from PHY layer 14 at ATM layer 12 in the CLH mode of operation is generally as follows. PHY layer 14 indicates to ATM layer 12 that it has a complete cell of data (53 bytes) to send by asserting RxEmpty*/RxCLAV to a high logic level. When ATM layer 12 can receive a complete cell, it asserts RxEnb* to a low logic level. In the next clock cycle, PHY layer 14 places the first byte of data onto the data bus RxData 30 and asserts RxSOC 34 to a high logic level along with the first byte of data. RxSOC 34 remains at a high logic level for one cycle only. Each of the remaining 52 bytes of cell data are then transferred to ATM layer 12 per clock cycle of RxCLK 38.

Typical applications using UTOPIA include Network Interface Cards (NICs) and ATM switches. ATM switches typically are built using a rack mounted architecture which include individual shelves of the rack each supporting PHY Layer 14 circuits or ATM Layer 12 circuits. Typically, the interconnect between the PHY Layer 14 circuits and the ATM Layer 12 circuits comprise wide parallel ribbon cables. The parallel ribbon cables may comprise as many as 40 conductors to accommodate the Transmit and Receive interfaces when the UTOPIA bus operates in a 16-bit mode. The use of wide ribbon cables to interconnect the ATM Layer 12 circuits and PHY Layer 14 circuits physically clutters the ATM switch. Additionally, the wide parallel ribbon cables connecting the various UTOPIA ports on a switch can extend to as much as a foot or more in length, depending on the distance between the PHY Layer 14 and ATM Layer 12 circuit shelves. The length of the ribbon cable poses a limitation on the ATM system as parallel ribbon cables which operate reliably at one frequency over a given distance, may not operate reliably if that distance is increased.

UTOPIA ports generally operate at high frequencies (e.g. 25 MHz). Appreciably long ribbon cables operating at high speeds introduce undesirable problems such as cross-talk between conductors and voltage reflections due to the uncontrolled impedance of the ribbon cable. These problems cause degradation of signal integrity and skew problems in which the timing relationships of the signals transmitted between the ATM Layer 12 and the PHY Layer 14 are altered. Skew problems can result in the violation of set-up and hold timing parameters and cause subsequent corruption of data communication.

One approach to address the signal integrity and skew problem is to employ specialized ribbon cable for transmitting differential signals, such as twisted pair conductors. However, this approach does not resolve the skew problem since skew can still result from differences in propagation delays for each signal through its respective differential driver, cable and receiver. Additionally, this approach doubles the number of conductors required for the parallel cable because each signal requires two conductors, thus the already bulky ribbon cable further clutters the area between the ATM Layer 12 and PHY Layer 14 circuits.

Another approach is to use ribbon cables interconnected with repeater circuits. The repeater circuits would operate as a bridge to reliably increase the effective length of the ribbon cable. However, this approach also compounds the problem of cluttering the space around the ATM switch, as well as, significantly increasing the cost of the system as the effective length of the ribbon cable grows.

U.S. Pat. No. 5,784,370 attempted to solve the above identified problems by disclosing that an extender circuit provides a serial communication interface between an ATM Layer 12 and a PHY Layer 14. The extender circuit includes a first circuit serially coupled to a second circuit. The first circuit is coupled to the ATM Layer 12 and communicates in parallel with the ATM Layer 12. The first circuit is operable to receive a control signal from the ATM Layer 12. The second circuit is coupled to the PHY Layer 14 and communicates in parallel with the PHY Layer 14. The first circuit does not transmit the control signal to the second circuit. The second circuit regenerates the control signal at the PHY Layer 14. The first circuit and the second circuit function in like manners. The first circuit receives a control signal generated by the ATM Layer 12. The control signal may comprise a start of cell signal. The first circuit transmits a first sequence of signals to the second circuit. The second circuit detects the occurrence of the first sequence of signals and reproduces the control signal at the PHY Layer 14 when the first sequence of signals is not detected. The first sequence of signals may comprise an idle character. In another embodiment, the first circuit transmits a second sequence of signals to the second circuit. The second circuit reproduces the control signal at the PHY Layer 14 when the second circuit detects the first sequence of signals followed by the second sequence of signals.

In previous ATM systems it was only possible to couple one ATM Layer 12 to one PHY Layer 14. If the PHY Layer 14 was running at a high frequency transmission rate, then the fast rate of the ATM Layer 12 was used with little waste. Usually, the PHY Layer 14 operated at a transmission speed which was much slower than the operational speed of the ATM Layer 12 resulting in waste due to unused performance in the ATM Layer 12.

The UTOPIA interface is an established standard for connecting PHY devices to ATM Layer 12 devices. However, when the ATM Layer 12 device and the PHY device(s) are on separate cards within a piece of equipment, or even on separate equipment, then the parallel nature of this standard becomes a limiting factor.

In order to solve this problem, the ability to couple multiple PHY Layer 14s to one ATM Layer 12 was researched but all implementations to date have resulted in cumbersome protocols, added pins to the ATM Layer 12 or PHY Layer 14 packages, and other undesirable results. Therefore, a multi-PHY to ATM Layer 12 protocol, system, and method is desired that is easy to use and does not result in added complexity or cost.

In order to couple several PHY Layer 14s to one ATM Layer 12, some problems are encountered. For example, the ATM Layer 12 device should have a minimum of I/O pins. Optimally, the number of I/O pins should be identical whether supporting a single PHY device or multiple PHY devices. Received ATM data cells are routed by a virtual connection identifier (VCI) contained in the header portion of each cell. The identifier of each connection on an individual physical link is unique. However, if cells from multiple physical links are routed through a common cell processor, the same identifier may be used by cells from different links thereby causing confusion. These cells must be distinguished in order to route them correctly, so the ATM Layer 12 device must have a method for knowing from which physical link each cell arrived. In addition, ATM data cells that are transferred from the ATM Layer 12 to the PHY Layer 14 are intended for only one of the PHY Layer 14 devices. There must be a method for the ATM cell processor to indicate which PHY Layer 14 device should copy the cell and which PHY Layer 14s should ignore that particular ATM data cell. Also, the addressed PHY Layer 14 device must communicate its inability to receive more cells if its FIFO is full without preventing other PHY Layer 14s from continuing to receive cells.

U.S. Pat. No. 5,485,456 disclosed a data interface between an asynchronous transfer mode (ATM) layer device and multiple PHY devices (PHY Layer 14 devices). An ATM Layer 12 device (either a cell processor or a Segmentation and Reassembly (SAR) device) is typically designed to work together with one PHY Layer 14 device of the same throughput. Since some PHY Layer 14 devices operate at high bandwidths, the ATM Layer 12 device is designed to operate at a high bandwidth in order to keep pace. However, some inexpensive PHY Layer 14 devices operate at only a fraction of the ATM Layer 12 bandwidth thereby wasting a large portion of the ATM Layer 12 bandwidth needlessly. In these mismatched bandwidth systems, the system cost is reduced if several low-bandwidth PHY Layer 14 devices are connected to a single ATM Layer 12 device.

Although the above cited references disclosed needed methods and apparatuses for implementing the architecture of the UTOPIA bus which does not have undesirable effects, such as, degrading signal integrity, creating timing skew problems, encountering physical space constraints, or employing high cost solutions, these devices were not able to provide connections to more that one PHY Layer 14 or to achieve the advantages and features of the disclosed invention.

### SUMMARY OF THE INVENTION

An UTOPIA-LVDS Bridge is a flexible UTOPIA to LVDS Bridge device. The LVDS Bridge transparently transports the UTOPIA bus over a high speed LVDS serial link. The device includes many reliability features such as an optional 1:1 protection and built in bit error rate checking.

The parallel interface is user programmable for maximum flexibility. The user can choose between UTOPIA Level 2 ATM Layer (master) or PHY Layer 14 (slave) operation. The UTOPIA-LVDS Bridge supports a special MPHY (multi-PHY Layer 14) operation mode. The MPHY operation supports up to 248 standard UTOPIA Level 2 PHY ports without adding external circuitry.

The serial interface uses LVDS Serializer and Deserializer technology. The 16:1 bit serialization allows conveying the full-duplex parallel bus over two differential transmission pairs. This enables low cost backplanes and cables. Cable transmission length can be up to 10 meters. Bus LVDS technology also enables multi-drop configurations for distributing the UTOPIA bus to multiple Bridge receivers.

The serial link carries Flow control information (back pressure) is passed in both directions. The Bridge device applies back pressure on a per queue basis over the 31 internal FIFO queues. In addition, the serial link includes an OAM channel that does not detract from link performance.

There are many applications where the UTOPIA-LVDS Bridge simplifies designs. Box-to-box connections can use UTOPIA-LVDS Bridge devices across a PCB backplane for point-to-point and lightly loaded multidrop configurations.

### BRIEF DESCRIPTION OF THE FIGURES

FIG. 1a & b are examples of the prior art interface between the ATM layer and the PHY Layer 14;

FIGS. 2a & b are a comparison between the prior art method and the method according to the invention;

FIG. 3 is a block diagram of the UTOPIA-LVDS Bridge 100;

FIG. 4 is an illustration of an UTOPIA-LVDS Bridge 100 in level 2 mode for 248 PHY ports

FIG. 5 is an illustration of the detailed connection of 1 sub-port for extended UTOPIA-LVDS Bridge 100 in level 2.

FIG. 6 illustrates a multi-bridge system;

FIG. 7 is a table showing the PDU cell format options;

FIG. 8 illustrates a PDU and link transport container format;

FIGS. 9 illustrates the MPHY byte;

FIG. 10 illustrate the flow control coding within the F byte;

FIG. 11 is a table illustrating the F channel byte usage within the frame;

FIG. 12 illustrates the remote alarm and signaling byte;

FIG. 13 illustrates the F channel bandwidth—Bytes;

FIG. 14 illustrates the F channel bandwidth—Mpbs;

FIG. 15 illustrates the F channel bandwidth—Percentage;

FIG. 16 is a table that list the software lock sequences;

FIG. 17 is a table describing the performance monitoring alarms;

FIG. 18 is a table describing the general alarms;

FIG. 19 is a table describing loopback options;

FIG. 20 is a drawing describing loopback options;

FIG. 21 is a table that provides the pin description;

FIG. 22 is a table of register map summary;

FIG. 23 illustrate the Software Lock registers;

FIG. 24 illustrates the Version Identification register;

FIG. 25 illustrates the General Control and Status register;

FIG. 26 illustrates the LVDS Control register;

FIG. 27 illustrates the PDU Configuration register;

FIG. 28 is an illustration of the Interrupt Source Register;

FIG. 29 is an illustration of the Interrupt Source Enables register;

FIG. 30 is an illustration of the Link Status and Control register;

FIG. 31 is an illustration of the Transmit Link La bel register;

FIG. 32 is an illustration of the ECC Transmit Buffer and Receive LVDS Alarms register;

FIG. 33 is an illustration of the ECC Tx and Rx LVDS Interrupt Enables register;

FIG. 34 is an illustration of the ECC Transmit Buffer Send register;

FIG. 35 is an illustration of the ECC Transmit Buffer register;

FIG. 36 is an illustration of the General Purpose Input Output register;

FIG. 37 is an illustration of the Test Error Control register

FIG. 38 is an illustration of the Error BIP Mask register;

FIG. 39 is an illustration of the Error HEC Mask registers;

FIG. 40 is an illustration of an ATM and LVDS Loopback Control register;

FIG. 41 is an illustration of an ATM Loopback MPhy register;

FIG. 42 is an illustration of an ATM Loopback Cell Format register;

FIG. 43 is an illustration of the Receive Port A Link Label register;

FIG. 44 is an illustration of the Receive Port A Expected Link Label register;

FIG. 45 is an illustration of the Receive Port A Local Alarms register;

FIG. 46 is an illustration of the Receive Port A Local Interrupt Enables register;

FIG. 47 is an illustration of the Receive Port A Control register;

FIG. 48 is an illustration of the ECC Receive Buffer A registers;

FIG. 49 is an illustration of the Receive Port A HEC Count registers;

FIG. 50 is an illustration of the Receive Port A HEC Threshold registers;

FIG. 51 is an illustration of the Receive Port A BIP Count registers;

FIG. 52 is an illustration of the Receive Port A BIP Threshold registers;

FIG. 53 is an illustration of the Receive Port A Performance Alarms register;

FIG. 54 is an illustration of the Receive Port A Performance Interrupt Enables register;

FIG. 55 is an illustration of the Receive Port A Remote Status and Alarms register; FIG. 56 is an illustration of the Receive Port A Remote Interrupt Enables register; FIG. 57 is an illustration of the Receive Port A Up2Down Loopback Cell Count register;

FIG. 58 is an illustration of the Receive Port A Cell Delineation Thresholds register;

FIG. 59 is an illustration of the Receive Port A Frame Delineation Thresholds register;

FIG. 60 is an illustration of the Receive Port A Descrambler Lock Thresholds register;

FIG. 61 is an illustration of the Receive Port A Bit Error Count register;

FIG. 62 is an illustration of the Receive Port B Link Label register;

FIG. 63 is an illustration of the Receive Port B Expected Link Label register;

FIG. 64 is an illustration of the Receive Port B Local Alarms register;

FIG. 65 is an illustration of the Receive Port B Local Interrupt Enables register;

FIG. 66 is an illustration of the ECC Receive Port B Control registers;

FIG. 67 is an illustration of the ECC Receive Port B Buffer register;

FIG. 68 is an illustration of the Receive Port B HEC Count registers;

FIG. 69 is an illustration of the Receive Port B HEC Threshold registers;

FIG. 70 is an illustration of the Receive Port B BIP Count registers;

FIG. 71 is an illustration of the Receive Port B BIP Threshold registers;

FIG. 72 is an illustration of the Receive Port B Performance Alarms register;

FIG. 73 is an illustration of the Receive Port B Performance Interrupt Enables register;

FIG. 74 is an illustration of the Receive Port B Remote Status and Alarms register;

FIG. 75 is an illustration of the Receive Port B Remote Interrupt Enables register;

FIG. 76 is an illustration of the Receive Port B Up2Down Loopback Cell Count register;

FIG. 77 is an illustration of the Receive Port B Cell Delineation Thresholds register;

FIG. 78 is an illustration of the Receive Port B Frame Delineation Thresholds register;

FIG. 79 is an illustration of the Receive Port B Descrambler Lock Thresholds register;

FIG. 80 is an illustration of the Receive Port B Bit Error Count register;

FIG. 81 is an illustration of the Utopia Configuration register;

FIG. 82 is an illustration of the Utopia Connected Port List registers;

FIG. 83 is an illustration of the Utopia Connected Sub-Port List register;

FIG. 84 is an illustration of the Utopia Sub-Port Address Location register;

FIG. 85 is an illustration of the Utopia Sub-Port Address Mask register;

FIG. 86 is an illustration of the MTB Queue Threshold registers;

FIG. 87 is an illustration of the MTB Queue Full registers;

FIG. 88 is an illustration of the MTB Queue Empty registers;

FIG. 89 is an illustration of the MTB Queue Flush registers;

FIG. 90 is an illustration of the MTB Cell Flush registers;

FIG. 91 is an illustration of the Queen Flush register;

FIG. 92 is an illustration of the MTB Queue Overflow registers;

FIG. 92 is an illustration of the Utopia Loopback Control register;

FIG. 93 is an illustration of the ATM Down2Up Loopback Cell Count registers;

FIG. 94 is an illustration of the Utopia and ATM Alarms registers;

FIG. 95 is an illustration of the Utopia and ATM Interrupt Enables registers;

FIG. 96 is an illustration of the ATM Loopback Cell Filter registers;

FIG. 97 is a block diagram indicating the Basic Utopia Level 2 UMODE Configuration;

FIG. 98 is a block diagram indicating the Extended Utopia Level 2 UMODE Configuration;

FIG. 99 is a block diagram indicating sub port address operation;

FIG. 100 is a block diagram indicating connected port connected sub-port usage;

FIG. 101 is a table with recommended maximum MTB Queue Thresholds;

FIG. 102 illustrates the state diagram for TC Delineation;

FIG. 103 illustrates the state diagram for Frame Delineation;

FIG. 104 illustrates the state diagram for Descrambler Synchrronization;

FIG. 105 is a block diagram indicating basic ECC structure;

FIG. 106 is a diagram of an ECC Transmit Flow Chart;

FIG. 107 is a diagram of an ECC Receive Flow Chart; and

FIG. 108 is a diagram of an ECC Signaling with Active and Standby links.

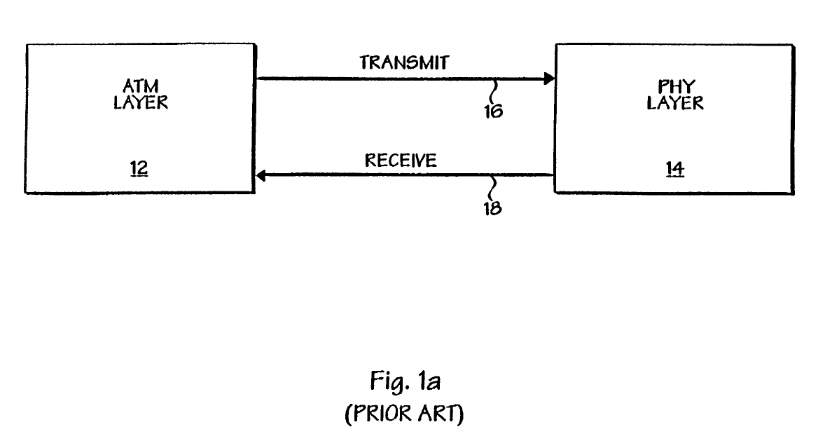

### DETAILED DESCRIPTION OF THE INVENTION

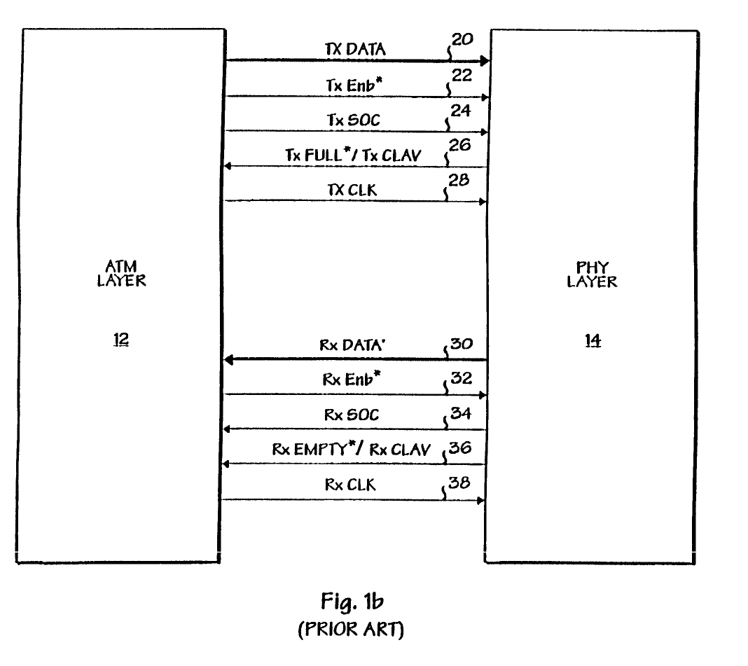

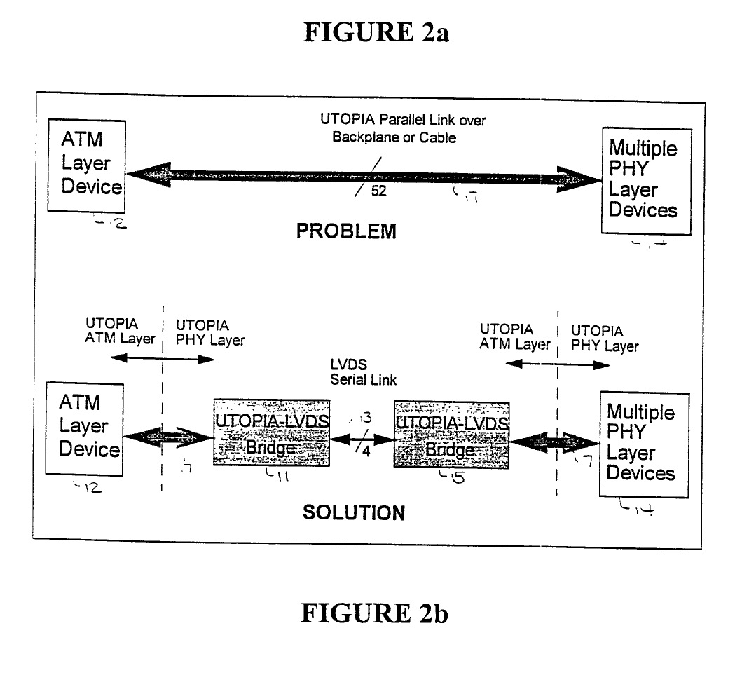

FIG. 2a represents the prior art problem where the ATM Layer 12 communicates over a UTOPIA parallel link 17 of 58 conductors to multiple PHY Layer 14s. The problems associated with this activity was discussed in the Background of the invention.

Application Overview

The UTOPIA interface is an established standard for connecting PHY Layer 14 devices to ATM Layer 12 devices. However, when the ATM Layer 12 device and the PHY device(s) are on separate cards within a piece of equipment, or even on separate equipment, then the parallel nature of this standard becomes a limiting factor.

The solution is to use the UTOPIA-LVDS Bridge 100 as is illustrated in FIG. 2b, which is a transparent Bridge that extends the UTOPIA bus over a serial LVDS interface, suitable for backplanes and cables. Full bidirectional flow control is incorporated, allowing back-pressure to be applied to the source of the ATM cells. The 31 PHY ports available with standard UTOPIA Level 2 may be extended to 248 ports without additional external circuitry. The UTOPIA-LVDS Bridge 100 achieves this by providing as many as 8 ENB and CLAV signals in both receive and transmit directions when acting as the ATM Layer 12 device. This allows addressing 248 PHYs that are configured as up to 31 ports that each have as many as 8 sub-ports.

To aid equipment management and maintenance, the UTOPIA-LVDS Bridge 100 passes an embedded OAM channel over the serial link. In addition, the device provides a number of loopback options that are both traffic affecting (line loopbacks) and non-traffic affecting (cell loopbacks), which simplify testing and diagnostic activities.

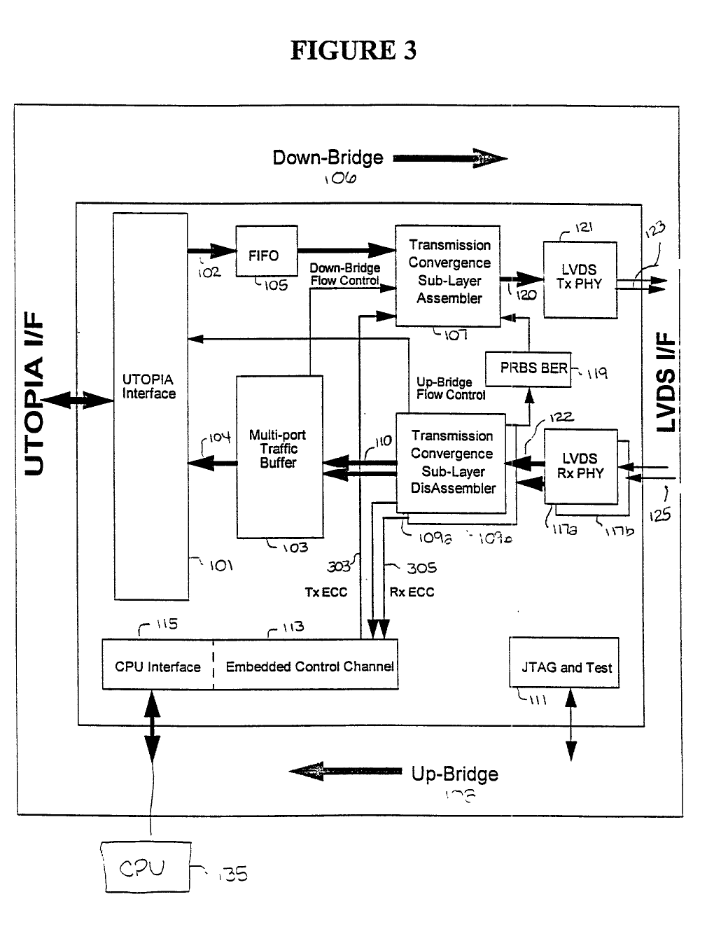

Referring to FIG. 3, there is illustrated a block diagram of the UTOPIA-LVDS Bridge 100. In discussions of the 100 down Bridge refers to the direction of data flow from the UTOPIA data bus 17 to a LVDS data bus 123 and is represented by arrow 106. Up Bridge refers to the direction of data flow from the LVDS data bus 125 to the UTOPIA data bus 17. An UTOPIA interface 101 interfaces the UTOPIA-LVDS Bridge 100 to the UTOPIA data bus 17 and provides a serial transfer of data and information to a FIFO 105 via bus 102 and receives data and information from a multi-port traffic buffer 103. In the downBridge direction 106 a simple 3 cell FIFO 105 is used to rate adapt the data from the UTOPIA clock domain to the LVDS clock domain for transmission over the serial line 13. Down-Bridge direction 106 data flow is provided from the FIFO 105 to a Cell Transmission Convergence (TC) sub-layer assembler 107 that performs cell rate de-coupling and prepares the cells for transport over the LVDS link by packaging them within link transport containers. In the reverse direction, cells are unpacked from the link transport containers by a Transport container sub-layer Disassembler 109. The LVDS Tx PHY 121 drives the assembled data and information received form the Transport container sub-layer Assembler 107 via bus 120 over the LVDS Tx bus 123. The LVDS bus 123 is connected to two LVDS Rx PHY receivers 117a and 117b each is capable of receiving the data form the PHY and LVDS receive bus 125 however, they operate as a primary and backup RxPHY. The out from the RxPHY receiver that is receiving data is applied to the Transport container sub-layer disassemble 109 via conductor 122 which disassembles the LVDS transport containers and applies the disassembled data and information to the Multi-port traffic buffer 103. There is and Embedded Communication Channel 113 that provides embedded communications to the Transport container sub-layer assembler 107 and decodes received embedded communications from the Transport container sub-layer Disassembler 109. The UTOPIA-LVDS Bridge 100 operates under instructions provide from a CPU via an interface 115. Testing is provided by a JTAG and Test port 111.

The Multiport traffic buffer 103 includes a resister file that stores PDU cells in an assigned register file for each port. When an assigned register accumulates enough data to reach a threshold then a flow control indiction is sent to the transmission convergence sub-assembler 107 for transmitting to the transmitter of the data informing them not to send any more data to from the port assigned to the register that has accumulated enough data to reached the threshold.

### FUNTIONAL DESCRIPTION

Utopia Interface

The UTOPIA-LVDS Bridge (100) has an industry standard UTOPIA interface as defined in “The ATM Forum UTOPIA Level 2, Version 1.0 Specification, af-phy-0039.000, June 1995” which is incorporated herein by reference. This interface supports Level 2 and Extended Level 2 operations. Depending on its position in the bridge link, it may operate as either the ATM Layer 12 or the PHY Layer 14 in the UTOPIA protocol. The operation is set by software configuration by the CPU 135.

In Level 2 mode, the interface can be either a 16-bit or an 8-bit wide data path, again with both octet and cell level handshaking and operate at a frequency as high as 52 MHz, facilitating 622 Mbps (STM4/OC12) line rates.

In UTOPIA Level 2 mode, the UTOPIA-LVDS Bridge 100 supports Multi-PHY (MPHY) operation, whereby up to 31 PHY ports may be connected to a shared ATM device. The presence of cells and availability of buffer space is indicated using the CLAV signals.

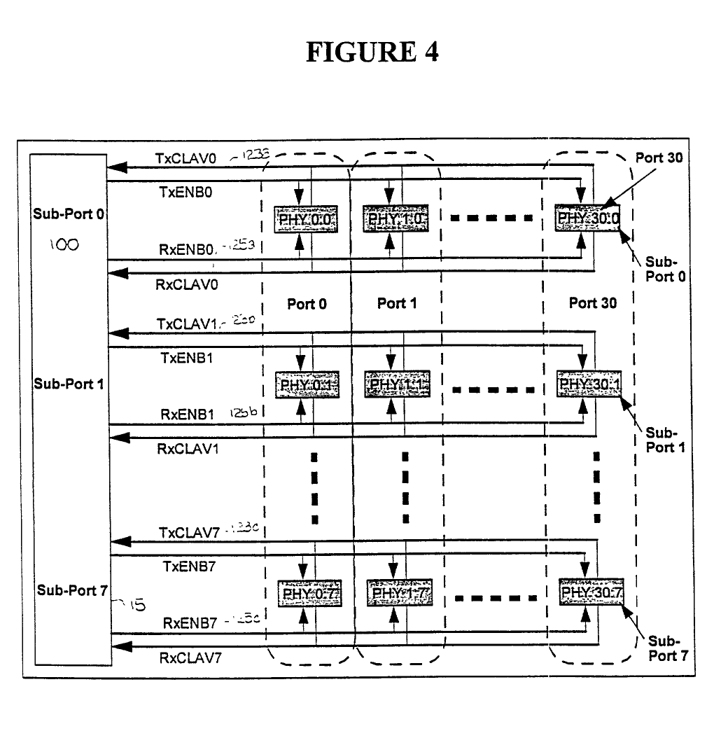

UTOPIA Level 2 define 1 ENB (a control signal indicating either transmit or receive enable) and 1 CLAV signal in each direction.(control signals indicating either transmit cell available or a receive cell is available) The UTOPIA-LVDS Bridge 100 has extended this to 8 ENB and 8 CLAV signals, enabling up to 248 PHY ports to be connected to a shared ATM device without additional external circuitry as illustrated in FIG. 4.

Referring to FIG. 4, there is illustrated a UTOPIA-LVDS Bridge 100 in Level 2 mode having a first sub-port 0 through an eight sub-port 7. Each sub-port is contestable to up to thirty one ports and each port may be connected to a PHY. This is indicated in FIG. 4 by the numerical notations of PHY x:y; with x being the number of the sub port at the LVDS Bridge and y being the number of the typical sub-port.

For the purpose of queuing, the 248 PHY ports are configured as sub-ports of the standard 31 ports so each port/queue has 8 sub-ports which will be discussed further in the description of the Up-bridge Multi-port Traffic Buffer (103). Each MPHY address corresponds to a port.

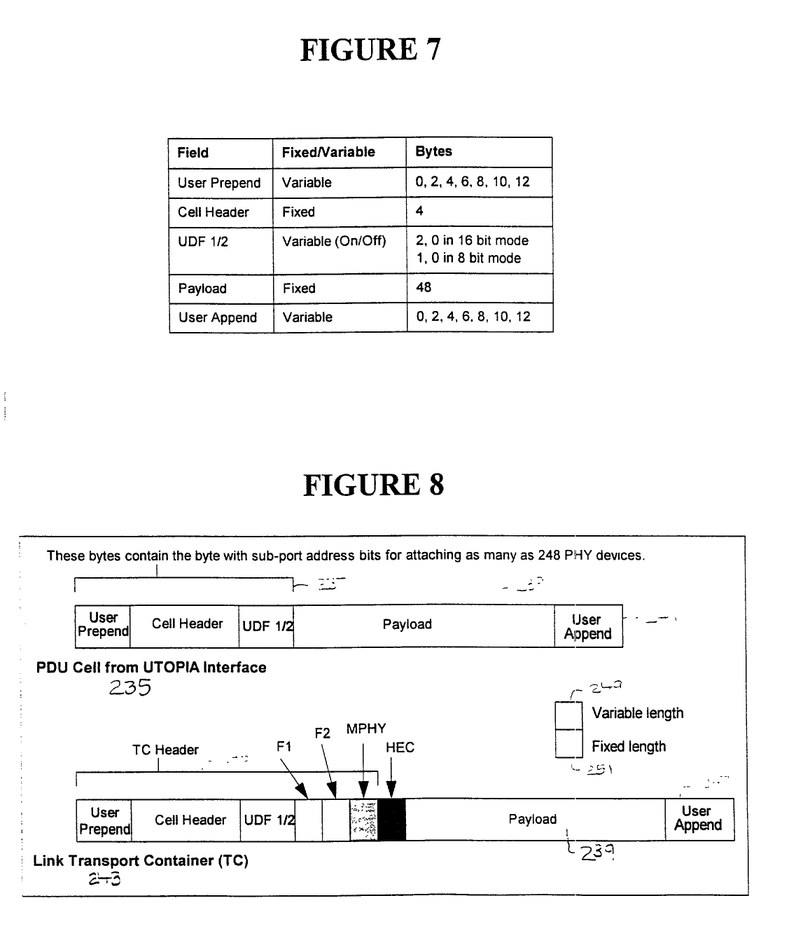

A 5 bit MPHY can address up to 31 PHY ports. At least 3 additional bits are required to give the total of 8 bits necessary for addressing 248 PHY ports. These additional address bits can be provided by the user in any of the User Prepend, Cell Header or UDF 1/2 bytes of the cell as illustrated in FIG. 7. The UTOPIA-LVDS Bridge 100 is configurable to extract/insert the extra address bits from/to any of these bytes.

PHY polling may be carried out as follows:

Standard UTOPIA Level 2 with 1 CLAV signal.

One CLAV polling 31 PHY ports.

UTOPIA-LVDS Bridge 100 Extended UTOPIA Level 2 with up to 8 CLAV signals.

Each CLAV can poll 31 PHY ports giving a total of 248 PHY ports.

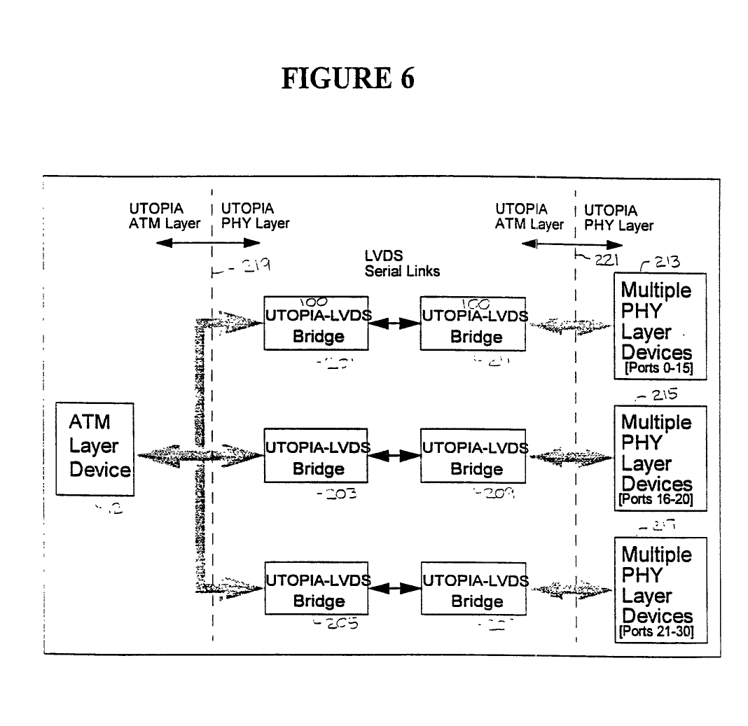

All 31 MPHY ports, or any subset may be assigned to one bridge device, with parallel device(s) supporting any remaining ports, as illustrated in FIG. 6. Each of these ports may have up to 8 sub-ports.

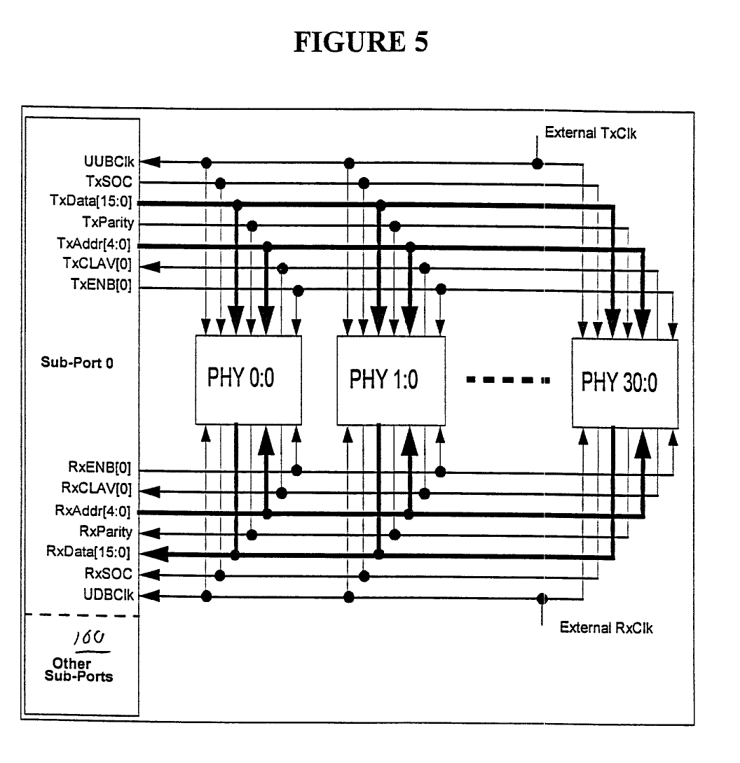

Referring to FIG. 7, a single ATM Layer 12 device drives 3 UTOPIA-LVDS Bridges 201, 203 and 205. Each of the bridges are connected to a Multiple PHY Layer 14 devices such that the UTOPIA-LVDS Bridge 201 is connected to a UTOPIA-LVDS Bridge 211 which interfaces to Multiple PHY layer devices 213 that provides ports 0 through 15. UTOPIA-LVDS Bridges 203 is connected to an UTOPIA-LVDS Bridge 209 that interfaces to Multiple PHY layer devices 215 and ports 16 through 20. The UTOPIA-LVDS Bridge 205 is connected to an UTOPIA-LVDS Bridge 207 which interfaces to Multiple PHY layer devices 217 which drives ports 21 through 30. Dotted line 219 shows the communication between the ATM layer device 12 and a UTOPIA PHY Layer 14 while dotted line 231 illustrates the interface between the Multiple PHY layer devices 213, 215 and 217. The UTOPIA-LVDS Bridges 100 of FIG. 5 are transparent to the operations of the ATM layer device 12 and the Multiple PHY layer devices 213, 215 and 217.

Parity generation and checking is available in all modes.

To support systems where routing tags and/or padding is added to the ATM cells at a previous device, the UTOPIA interface on the UTOPIA-LVDS Bridge 100 may be programmed to handle non-standard ATM cells of length 52 bytes up to 64 bytes. See FIGS. 7. In all cases, the Start Of Cell (SOC) signal must correspond to the first byte or word of the extended cell.

Referring the FIG. 8, there is illustrated a table in which the different fields of the PDU cells are defined including whether or not they have the fixed variable fields and the number of bytes associated with the different fields.

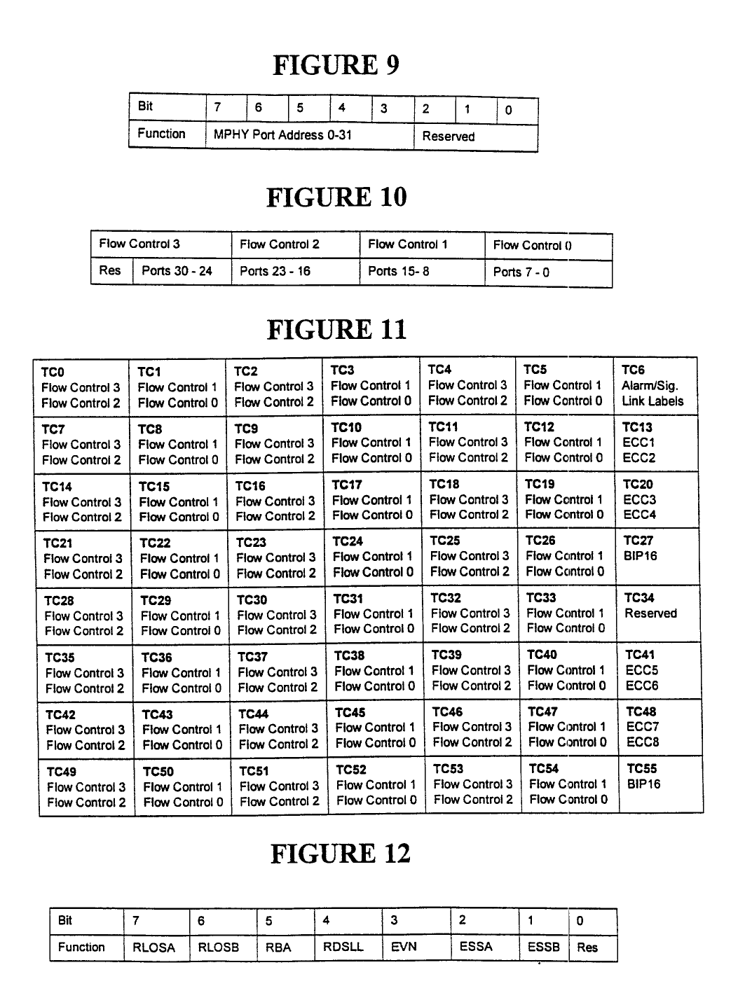

FIG. 9 should be used in conjunction with FIG. 8 in which the PDU cell 235 includes a header and address portion 237. The address portion can be used for attaching as many as 248 PHY devices. The port address bits must be contained in those bytes designated in the field 237. Additionally, there is a pay load portion 239 where the data and information is carried and then a trailer portion which is for an user append data at 241. The PDU cell 235 is a UTOPIA interface and includes data field. The link transport container 243 has a TC header 245 which includes a user prepend; a call header; a UDF 1/2 high; F1 and F2 are flow control bytes as shown in FIG. 10; a MPHY address; a HEC byte; and a tailing user prepend area 247. The cross hatch fields as indicated by the reference scale 249 are data fields with variable lengths and the non cross hatch field 251 are data portion with a fixed link.

Back-to-back cell transfer is supported in all modes.

When configured as an ATM Layer 12 device, receive polling and transmit polling of those ports with queued cells is Round-Robin. The UTOPIA-LVDS Bridge 100 will only poll those PHY ports configured as active.

### Traffic Buffers

Traffic Buffers include the FIFO 105 and the multiport Traffic Buffer 103 of FIG. 3.

Down-Bridge FIFO

In the down-bridge direction (arrow 106) the simple 3 cell FIFO (105) is used to rate adapt the data from the UTOPIA clock domain to the LVDS clock domain for transmission. Per port queuing and back pressure/flow control is handled by the corresponding up-bridge (arrow 108) Multi-port Traffic Buffer (103) in the far end UTOPIA-LVDS Bridge 100 device as described below.

Per port queuing and back pressure/flow control is handled by the corresponding upbridge Multi-port Traffic Buffer 103 in the second UTOPIA-LVDS Bridge 15.

Up-Bridge Multi-Port Traffic Buffer

In the up-bridge direction (arrow 108) the Multi-port Traffic Buffer (103), has a 160 cell linked list buffer that is shared across up to 31 port queues. Although each MPHY may be connected to 8 sub-ports/PHY's the Multi-port Traffic Buffer 103 treats these as a single port/queue, because it only uses the 5 bit MPHY address and does not access the sub-port address bits.

Each of the 31 ports has a programmable upper fill threshold. In the up-Bridge direction (arrow 108), queue overflow is avoided through the means of a per queue flow control protocol embedded in the LVDS link as described below. Should any queue reach this upper threshold, back-pressure is applied via the flow control mechanism over the serial link to the down-bridge (transmitting) device which uses the normal UTOPIA flow control handshaking to prevent any more cells being transferred and thus prevent an overflow.

The individual queue per port architecture ensures that the flow control is nonblocking across the 31 ports. However, the 8 sub-ports within each port can be blocking.

Furthermore, as is the nature of link-list buffers, each queue may be over-assigned memory space, working on the assumption that not every queue will back up simultaneously. To accommodate the rare occasions where the buffer as a whole approaches full but individual queues are below their full threshold, the device also compares the overall buffer fill against a threshold. The flow control mechanism provides a global ‘halt’ command to ensure that no cells will be lost should the overall buffer approach the overflow condition.

Transmisson Convergence Sub-layer (TCS)

In the down-bridge direction, the Transmission Convergence Sub-layer (TCS) Assembler 107 performs cell rate de-coupling. The TCS Assembler 107 then prepares the cells for transport over the LVDS link by packaging them within link transport containers (TC). In the reverse direction, cells are unpacked from the link transport containers by the Transport container sub-layer disassembler 109.

In the up-bridge direction, the Transport containers Dissassembler 109 unpack the link transport containers and route the cells to the Multi-port Traffic Buffer 103.

MPHY address, flow control, and OAM information is embedded within the link transport containers (243).

Cell Rate Decoupling

In the down-bridge direction (arrow 106), the Transport containers Assembler 107 inserts idle cells when no valid traffic cells are available from the FIFO (105) for onward transmission. In the up-bridge direction, the Transport containers Disassembler 109 rejects all received idle cells.

Link Transport Container (TC)

The ATM cells received on the UTOPIA interface (101) can be standard or userspecified cells. Cell length is programmable from 52 to 64 bytes. These cells are treated as Protocol Data Units (PDU cell 235) which are packaged into Transport Containers (TC) for transmission over the serial link. In the reverse direction, the cell PDUs are unpacked from the link Transport containers before being passed out on the UTOPIA interface. This is illustrated in FIG. 8.

The PDU fields are configurable as illustrated in FIG. 7. The total PDU cell length must be in the range 52 to 64 bytes and as the UTOPIA-LVDS Bridge 100 operates with an internal 16-bit data path it is required that variable length fields be programmed to an even number of bytes. The total number of bytes defined for User Prepend plus UDF 1/2 and User Append must not exceed 12 bytes to maintain the maximum PDU cell length of 64 bytes.

Although the UDF 1/2 bytes will always be present, the UTOPIA-LVDS Bridge 100 can be programmed to either transport these bytes or ignore them. If they are to be ignored, then the Transport containers strips them out in the down-bridge direction and the UTOPIA up-bridge section inserts a HEC byte in UDF 1. Otherwise, they can be transported transparently the same as any other PDU byte.

Each link Transport container (data stream 235) has an MPHY address byte, two F Channel bytes called F1 and F2 and a HEC byte for container delineation and cell header error detection in addition to the PDU cell. The two F1/F2 bytes per Transport container constitute the F Channel which is used for flow control and OAM purposes over the link.

MPHY Tagging and Routing

In the down-Bridge direction (arrow 106), the UTOPIA-LVDS Bridge 100 adds an additional byte (MPHY byte) to each PDU, containing the MPHY port address associated with that PDU, as illustrated in FIG. 9.

At the other end of the link, this byte is used to route the incoming PDU from the LVDS interface to the appropriate MPHY port queue.

Transport Container Delineation and Error Monitoring

In the down-bridge direction, the embedded communication control channel is created in the F1 and F2 bytes with software in the CPU 102, as is known in the art, calculates and applies a header 245 HEC byte using the CRC-8 polynomial x⁸+x²+x+1 and optional coset x⁶+x⁴ x² +1 defined in the ATM specification, to the Transport container sublayer assembler (107) for insertion into the HEC byte is calculated over the preceding 7-19 bytes which make up the link Transport container header. To aid delineation at the far end, the entire contents of the Transport container, excluding the HEC, are scrambled and the HEC is calculated on the scrambled Transport container header 245. A scrambler using the pseudo-random sequence polynomial x³¹+x²⁸ +1 defined in ATM specification, “ITU-T 1.432.1, B-ISDN User Network Interface—PHY Specification: General Characteristics, August 1996” which by reference is incorporated herein, is used.

In the up-bridge (arrow 108) direction, the embedded communication channel (113) determines the cell delineation within the received data by locking onto the HEC byte within the transport container, using the algorithm specified in ATM specifications.

During steady-state operation in the up-bridge (arrow 108) direction, the embedded control channel (113) monitors the HEC bytes for errors, with an option to reject cells containing errors HECs. A performance metric on the number of errors cells detected is maintained.

Although the HEC byte normally over-writes the UDF1 byte before cells are passed out over a physical medium, the UTOPIA-LVDS Bridge 100 has the option to retain the UDF1 and UDF2 information fields in order to provide a truly transparent UTOPIA bridge. If it is not necessary to pass the UDF 1/2 bytes between the ATM and PHY devices at either end of the link, then the user has the option to suppress them to improve link efficiency.

Furthermore, in order to easily share-out the bandwidth provided by the F Channel between flow control and various OAM functions, a frame structure is used, as illustrated in FIG. 11. A frame contains 56 transport containers with ATM cells. The start of a frame is indicated by the HEC byte of the first transport container of a frame (TC of FIG. 11) which has had the coset x⁶+x⁴+x²+1 added to the CRC polynomial. This differentiates the start of frame HEC from the normal cell HEC's.

Flow Control

The flow control mechanism within the UTOPIA-LVDS Bridge 100 allows back-pressure to be applied to the source of the ATM cells in both directions, independently per queue for all 31 queues. It is based upon a simple ‘halt/send’ command per PHY port. At the destination Multi-port buffer (103), the fill level of each port queue is examined against a programmed threshold. Should the threshold be reached, a halt command is returned to the source, which prevents any more cells being sent to that port until a ‘send’ command is subsequently received. Only the port in question is affected so this is a non-blocking protocol over the normal 31 ports. However, the 8 sub-ports within a port do not have individual flow control and so are blocking.

Since a regular flow control opportunity is provided via the F1/F2 bytes in the header 245 of the F Channel only a small amount of headroom need be reserved to allow for latency in this protocol. Furthermore, should a number of PHY ports approach their limit simultaneously and/or the overall buffer approach a defined global threshold, a global halt may be issued, temporarily blocking all traffic.

The global halt/send command also allows the user to safely maximize the use of the shared buffer of the Multi traffic buffer (103) by over-assigning the memory among the ports.

The flow control command is illustrated in FIG. 10 which the F1 and F2 bytes indicate which of the sub-ports are in overflow cavity. Each port is assigned a control bit in specified F-bytes within the frame structure, as illustrated in FIG. 11. Within the F byte logic 1 represents a ‘halt’ command to that port and logic 0 represents a ‘send’ command. A global halt is indicated by all ports containing a halt command. The MSB of Flow Control 3 byte is reserved.

F Channel Byte Usage Within the Frame

For the majority of time, the F Channel F1/F2 bytes are used as a flow control opportunity, providing a rapid throttle-back mechanism as described above. In addition, a small number of F bytes are stolen in a regular fashion to provide a low bandwidth Operation and Maintenance (OAM) channel. This is controlled by the Transport container number within the frame, as illustrated in FIG. 11. Hence, an OAM channel is formed by the F1/F2 bytes in Transport containers 6,13,20,27,34,41,48 and 55, with the F1/F2 bytes in the remaining containers forming a flow control signaling channel.

### Oam Channel

Remote Alarm and Signaling Byte

A byte-wide remote alarm and signaling channel is carried in the F1 byte in Transport container 6 as illustrated in FIG. 11. This provides a means for a port at the far end of a link to signal an alarm condition to the near end and vise-versa. This byte also contains the ECC flow control signals. The format of this byte is as illustrated in FIG. 12. Bits [1: 0] are reserved.

RLOSA—Remote Loss Of Signal lock at far end device receive port A.

RLOSB—Remote Loss Of Signal lock at far end device receive port B.

RBA—Remote far end device active receive port.

Set=port B, Clear=port A.

RDSLL—Remote far end device active receive port Descrambler Lock.

Clear=In lock, Set=Out of lock.

EVN—ECC receive data VALID/NULL indication.

ESSA—ECC RxA transmit START/STOP control.

ESSB—ECC RxB transmit START/STOP control

Link Trace Label Byte

Also in Transport container 6 a byte-wide link trace label is carried in the F2 byte as illustrated in FIG. 11. This allows the user to verify link connectivity, which is especially useful when a number of cable links are being used. The UTOPIA-LVDS Bridge 100 may be programmed with both a link label value to transmit and an expected link label. Should the received link label not mach the expected value, an alarm interrupt may be raised.

The received Link Label byte is software accessible and an interrupt may be raised on a change of received Link Label byte. So the Link Label byte may also be used as a user defined channel to pass one byte per frame across the link.

Embedded Communications Channel (ECC)

An Embedded Communications Channel (113) is provided over the link for software messaging, download, etc. in the F1/F2 bytes of Transport containers 13, 20, 41 and 48 as illustrated in FIG. 11. The ECC byte contents are not processed by the UTOPIA-LVDS Bridge 100. Hence the UTOPIA-LVDS Bridge 100 is transparent to and does not restrict the system messaging protocol.

The ECC (113) consists of an 8 byte Tx Buffer with corresponding Tx Buffer Ready and Tx Buffer Send flags, and an 8 byte Rx Buffer with a corresponding Rx Buffer Full flag. All bytes of the buffers are software read/write accessible. Tx Buffer Ready is read only.

On reset the Tx Buffer Ready flag is set and the Tx Buffer Send flag is clear. The software assembles a message for transmission in the Tx Buffer. To send a message the software simply sets Tx Buffer Send which automatically clears Tx Buffer Ready. The contents of the Tx Buffer (121) are transmitted to the LVDS Bridge at the opposite end and whenever they are received successfully Tx Buffer Ready is set and an interrupt raised to the software to indicate successful transmission. The Tx Buffer will automatically be retransmitted until the LVDS Bridge at the opposite end indicates that it has been successfully received. A new message may now be assembled in the Tx Buffer and transmitted by setting Tx Buffer Send. As all the Tx Buffer bytes are read/write the message to be transmitted can be assembled in any order and read back by the software before transmission. The same message can be retransmitted simply by setting Tx Buffer Send again.

On reset the Rx Buffer Full flag is clear. When all 8 bytes of a message has been successfully received and stored in the Rx Buffer, the Rx Buffer Full flag is set and an interrupt raised. As all the Rx Buffer bytes are read/write the message can be read in any order by the software. A new message will not overwrite the current received message until the Rx Buffer Full flag is cleared by the software indicating that the current Rx Buffer has been read.

The ECC data flow is controlled across the link using the EVN and ESS bits of the Remote Alarm and Signaling byte (FIG. 12).

As there are two independent LVDS receive ports, for example UTOPIA LVDS Bridge 201 and UTOPIA LVDS Bridge 2 the UTOPIA-LVDS Bridge 100 has two independent ECC receive sections. These are assigned to the LVDS receive ports PortA 117a and PortB 117b. The ECC of the standby link may therefore be used for software communication.

BIP 16

A Bit-Interleaved-Parity mechanism provides an error performance metric on the LVDS link. A BIP 16 value is calculated over a previous block of 28 containers and inserted in the F1/F2 bytes of containers 27 and 55, as illustrated in conjunction with FIG. 11. At the far end, the re-calculated BIP16 values are compared against the received values. Any bit errors in this comparison are counted. Should the number of errors exceed a pre-programmed value within a monitoring period determined by the local management software, then an Excessive Bit Error Rate (EXBER) alarm is raised.

F Channel (Flow Control and OAM) Bandwidth Analysis

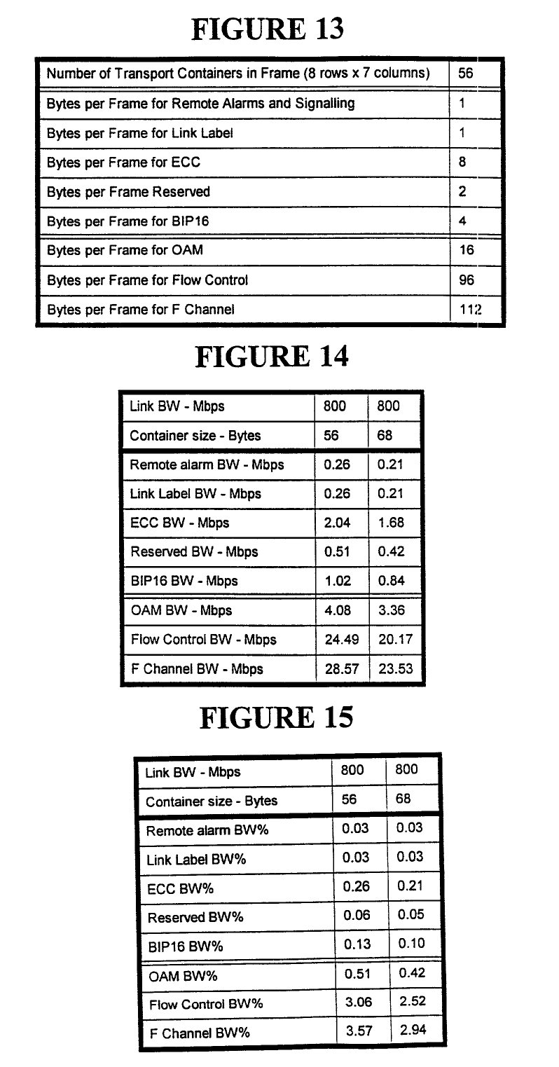

This section analyses the bandwidth used by the various components of the F Channel. FIG. 13 illustrates the F channel Bandwidth in bytes, FIG. 14 in Mbps, and FIG. 15 in percentage. The figures are dependent upon the link bandwidth and the size of the PDU/ATM cells being carried in the Transport Containers. This illustration is restricted to 800 Mbps and PDU sizes of 52 and 64 bytes giving Transport containers of 56 and 68 bytes respectively.

### LVDS Physical Interface

The UTOPIA-LVDS Bridge 100 provides one dual transmit and two independent receive high speed LVDS serial interfaces with 800 Mbps bandwidth. Data may be transmitted and received over lightly loaded backplanes or up to 10 m of cable. The two serial interfaces are denoted Port A 117a and 121a and Port B117b and 121b. Data can be transmitted simultaneously from both ports but only one receive port is selected for traffic at any one time. The standby receive port may be powered down. Alternatively the standby receive port OAM channel can be made available for software communications using the ECC (113), and for link performance monitoring. This allows the condition of the standby link to be determined. The LOCK status of both standby ports is monitored automatically.

The transmitted data stream contains embedded clock information. The clock may be recovered at the receiver on either random data or by instructing the transmitter to send SYNCH patterns on power-up or when synchronization is lost. The latter option requires a feedback loop in either hardware or software between the transmitter and the receiver, but has the benefit of a faster lock time. The LOCK status of both receive ports is reflected on external pins and alarm/status bits readable via the CPU interface (115). The LOCK status along with the currently active port is transmitted to the far-end receiver via the Remote Alarm and Signaling byte of the OAM channel as described in FIG. 12 and above. The UTOPIA-LVDS Bridge 100 may be configured to automatically switch to the standby port on local or remote Loss Of Signal for the active port. The recovered clocks are available on external pins.

The serial outputs of the ports may be independently placed in TRI-STATE either by an external pin or via microprocessor control. Similarly, the device may be forced to send SYNCH patterns on either or both ports by either assertion of external pins or via microprocessor control.

To assist in designer testing and system commissioning of the LVDS interface, the UTOPIA-LVDS Bridge 100 has a built in BER test facility 119. The device may be configured to send a PRBS pattern in place of ATM cells. At the receiver, the device locks onto this PRBS pattern and provides an error metric.

### CPU Interface

The UTOPIA-LVDS Bridge 100 contains a flexible microprocessor port capable of interfacing to any common system processor. Via this port, the system software can customize the behavior of the device from the various options provided, monitor the system performance and activate diagnostic facilities such as loop-backs and LVDS BER testing.

In addition to an 8-bit address and 8-bit data bus plus the associated bus protocol control signals, the CPU interface 115 includes an open-drain interrupt signal. This signal may be asserted on the detection of various alarms within the device, e.g. excessive HEC errors, ECC buffer full/empty, loss of lock etc. Any of the potential internal sources of this interrupt may be individually inhibited via an interrupt mask.

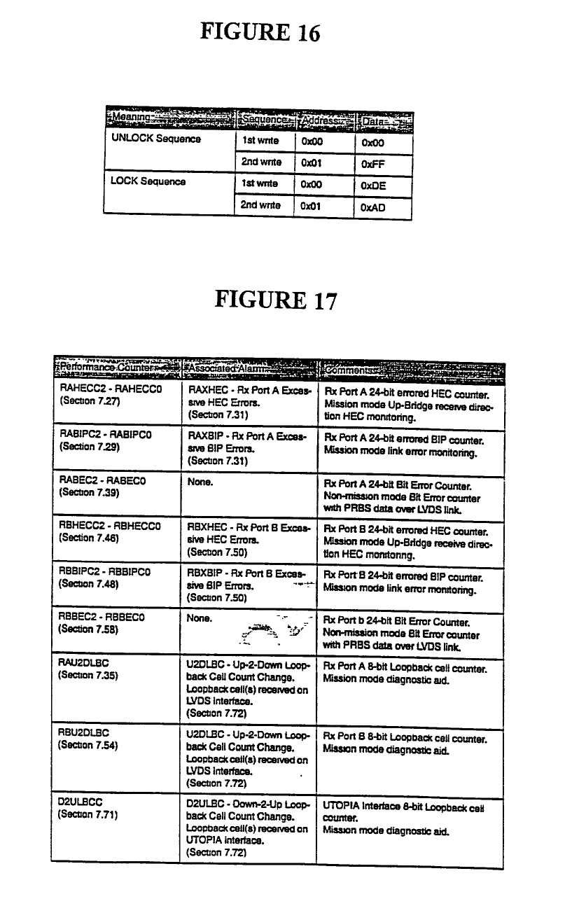

A software lock mechanism is implemented to prevent spurious modification of some of the UTOPIA-LVDS Bridge 100 software assessable registers. A predefined UNLOCK write sequence is necessary to allow unrestricted software write access to the UTOPIA-LVDS Bridge 100. A corresponding LOCK write sequence will prevent any software write access to the these registers although they can still be read. See FIG. 16. Only device configuration registers such as PDU cell length, UTOPIA interface mode, etc. are protected in this way. All other registers associated with the ECC, performance monitoring and interrupts are always write accessible by the software.

### Performance Monitoring and Alarms

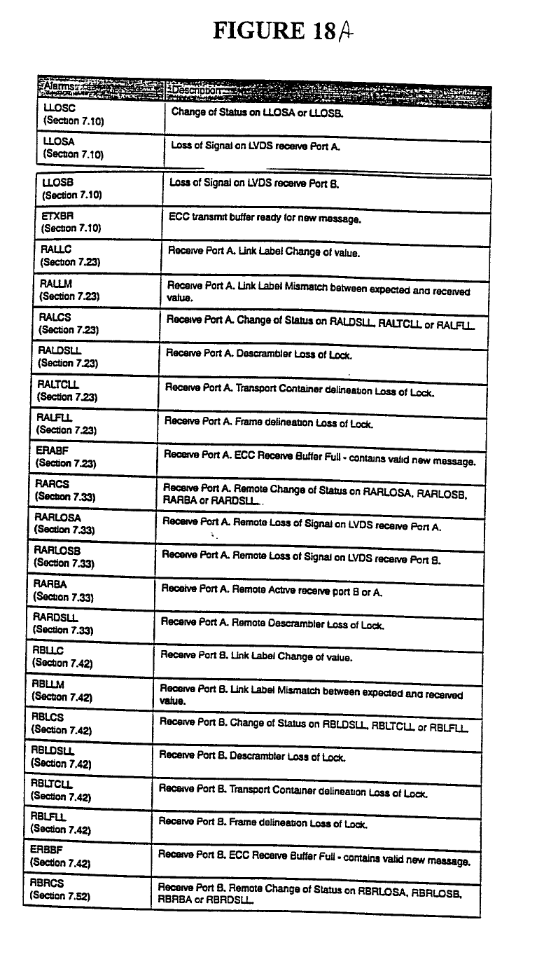

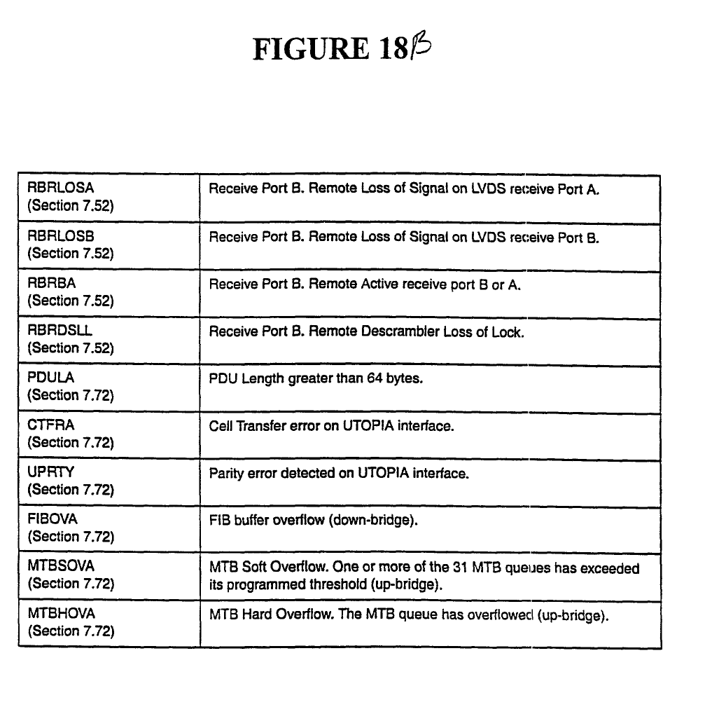

The UTOPIA-LVDS Bridge 100 provides a number of performance metrics and alarms to assist in equipment/network management. These alarms may be independently enabled or disabled to raise an interrupt. These alarms are illustrated in FIG. 17 and 18.

### Test Interface

The port (114) on the device provides access to the built-in test features such as boundary scan, internal scan and RAM BIT. It may be used to test the device individually or as part of a more comprehensive circuit board or system test.

Loopbacks

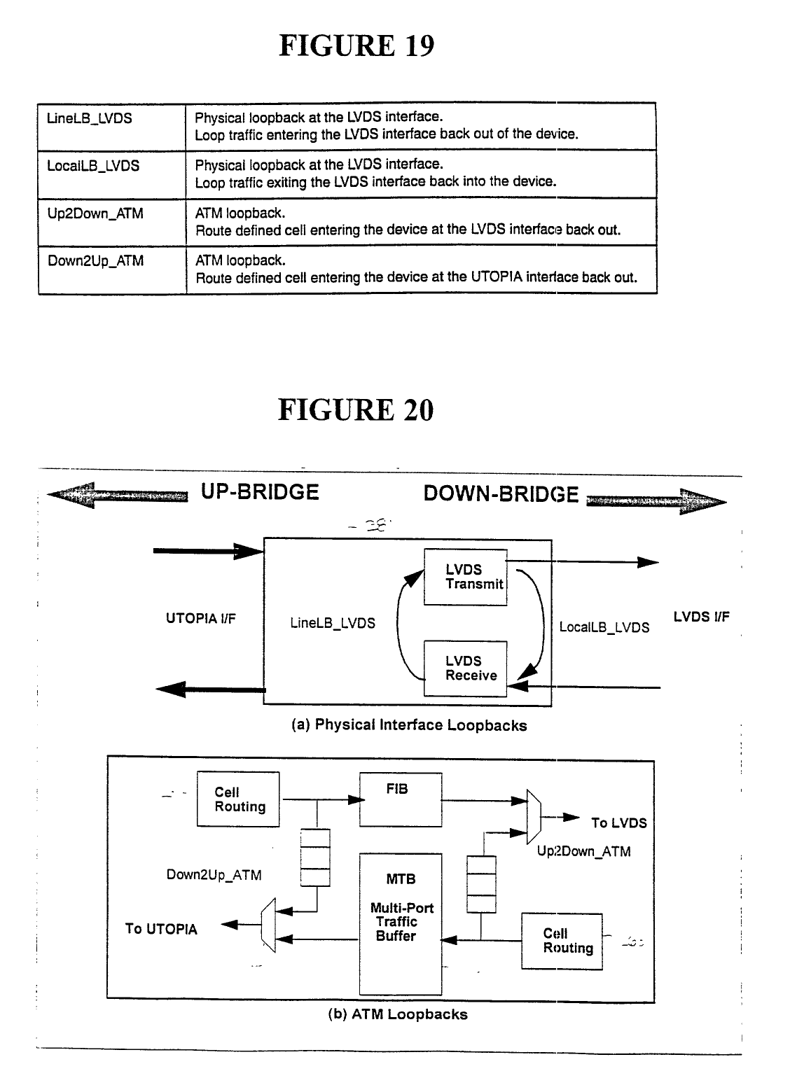

To assist in diagnostic testing, the device provides both physical interface loopbacks and ATM cell loopbacks. The former is suitable for designer or commission testing when the device is not passing live traffic. The latter allows cell trace testing on live traffic. The ATM cell loopback operates by recognizing the user-defined VPI/VCI of the special loopback cells. The available loopback options are illustrated in FIG. 19.

In addition to providing a live round trip test via the cell loopback, the UTOPIA-LVDS Bridge 100 helps pinpoint failures between transmit and receive paths by counting the number of loopback cells received.

All loopbacks are programmable via the CPU interface (115).

Referring to FIG. 20a, examples of a PHY interface loopback is illustrated and includes the loopback connection 281 this is occasion where referring to FIG. 2bthe multi-PHY devices 19 are interfaced to UTOPIA-LVDS Bridge 100 and it is connected via link 13 to a second UTOPIA Bridge 11. The Bridges are configured during loopback operation to have the up-Bridge (Bridge 11) communicating with the down Bridge (Bridge 15) over from the UTOPIA interface to the LVDS interface. The UTOPIA-LVDS Bridge 19 does an up to down LVDS loopback as illustrated in block 281 whereas the UTOPIA-LVDS Bridge 11 does a down to up UTOPIA loop. Similarly in FIG. 19 the traffic buffer 103 is connected such that the interface from the UTOPIA interface via the cell routing that is provided by the Transport container sub-layer 107 and is circulated through the traffic buffer 103 and combined by an end gate by a multiplexer 271. There is a register 269 used to provide a delay of the data that circulates through the traffic buffer 103. Similarly the Transport container sub-layer disassembler 109 provides cell routing and data is applied to the traffic buffer 103 the outputs of which is multiplex by multiplexer 265 and is delayed through a portion of the traffic buffer 103 via the registers 267 and is multiplexed by 265 to apply the data to the LVDS Bridge 13.

### SIGNAL DESCRIPTION FOR FIG. 21

Note 1 These pins are Inputs in ATM Layer 12 mode and Outputs in PHY Layer 14 mode.

Note 2 These pins Outputs in ATM Layer 12 mode and Inputs in PHY Layer 14 mode.

Note 3 These pins are only used in Extended 248 PHY mode. In Normal 31 PHY mode, they are unconnected.

Note 4 In PHY Layer 14 mode this is the Utopia TxClk and in ATM Layer 12 mode this is the Utopia RxClk.

Note 5 In PHY Layer 14 mode this is the Utopia RxClk and in ATM Layer 12 mode this is the Utopia TxClk.

Note 6 These pins are test data inputs when Text_bus dir_is set and outputs when Test_bus_dir is clear.

Note 7 These pins are not bonded out in BGA 196 production version.

FIG. 21 provides the pin description of the signals that are applied to and receive from the UTOPIA-LVDS Bridge 100.

### REGISTER DESCRIPTION

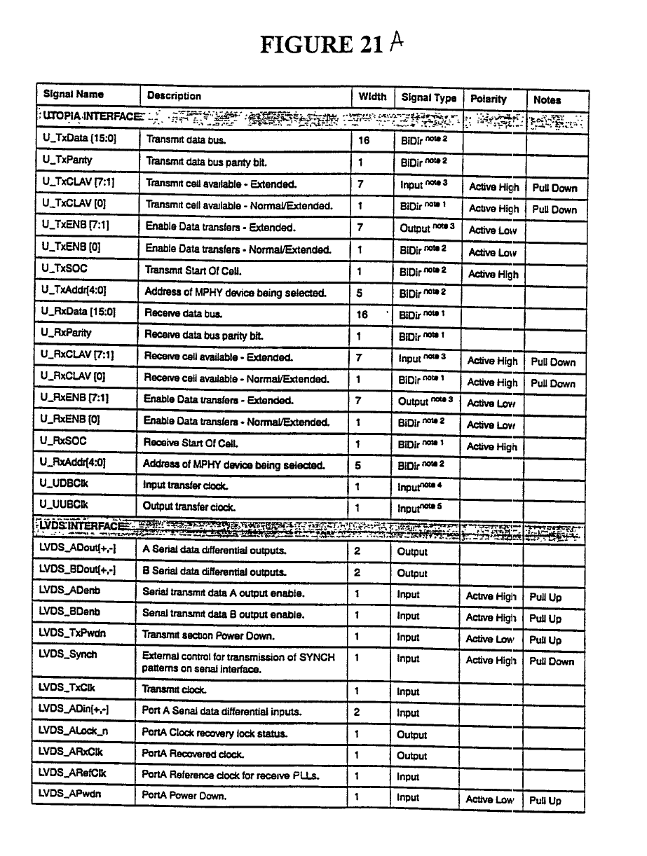

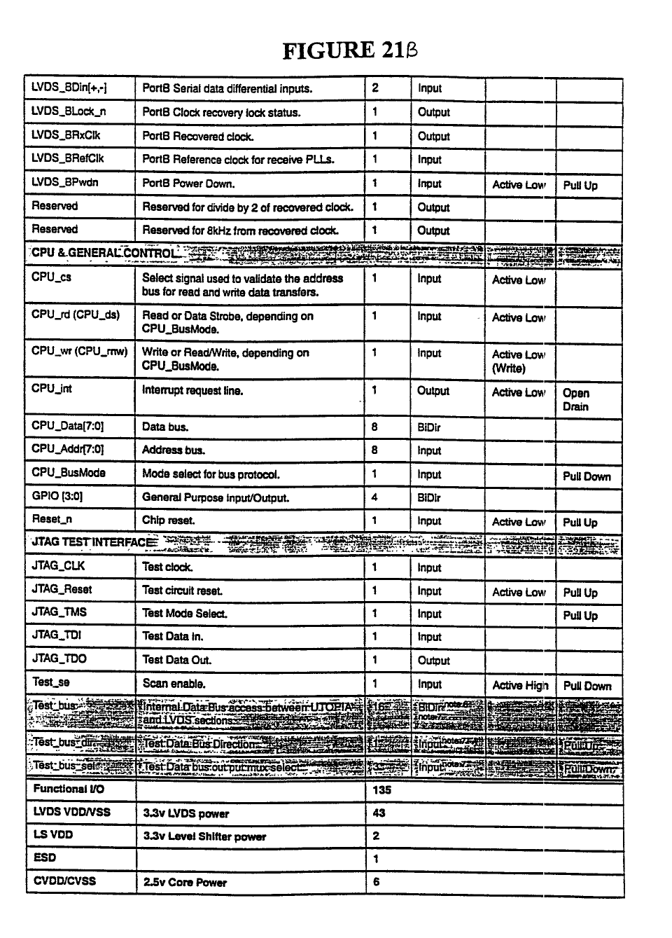

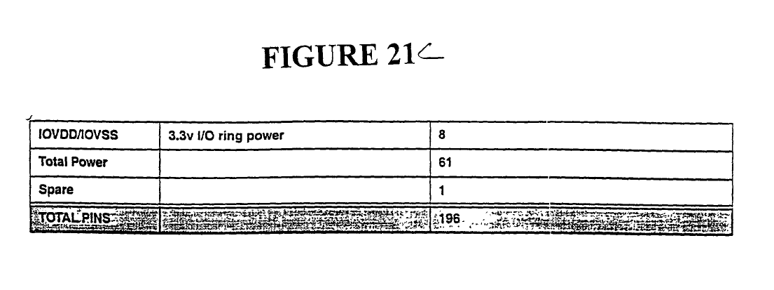

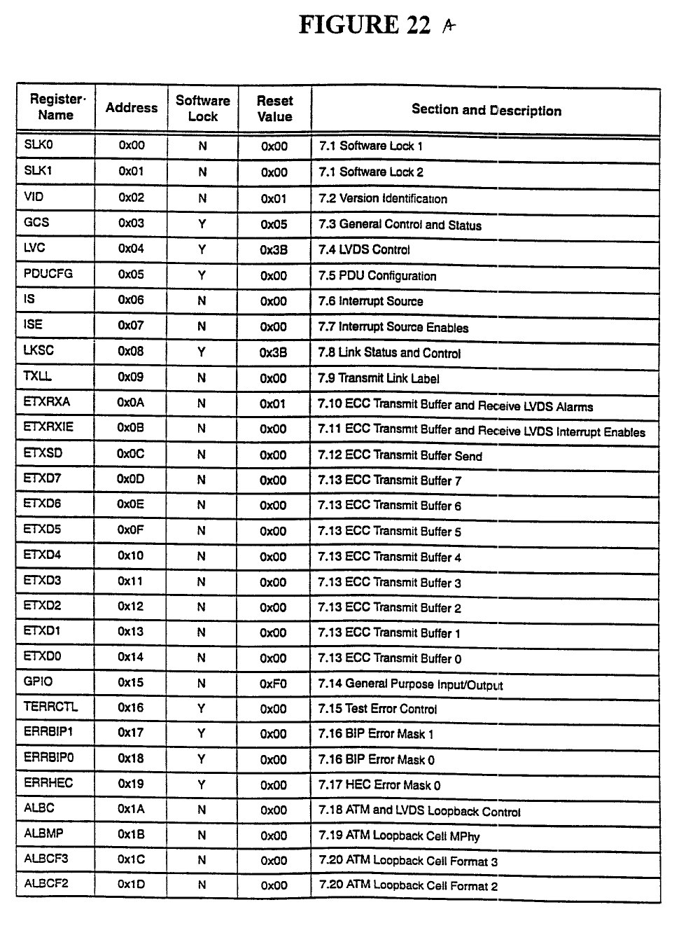

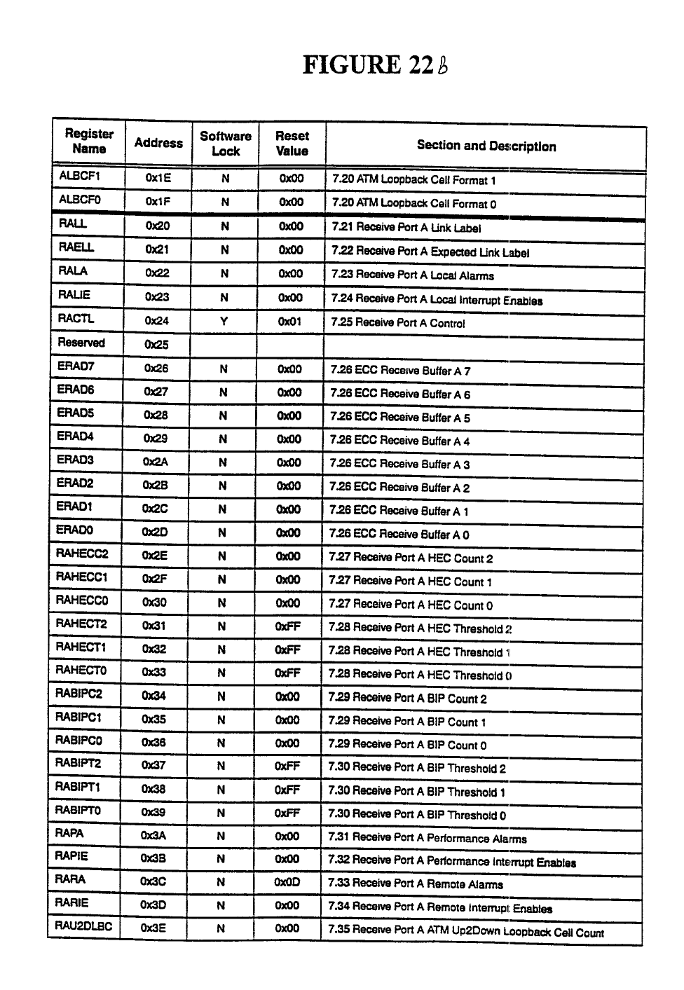

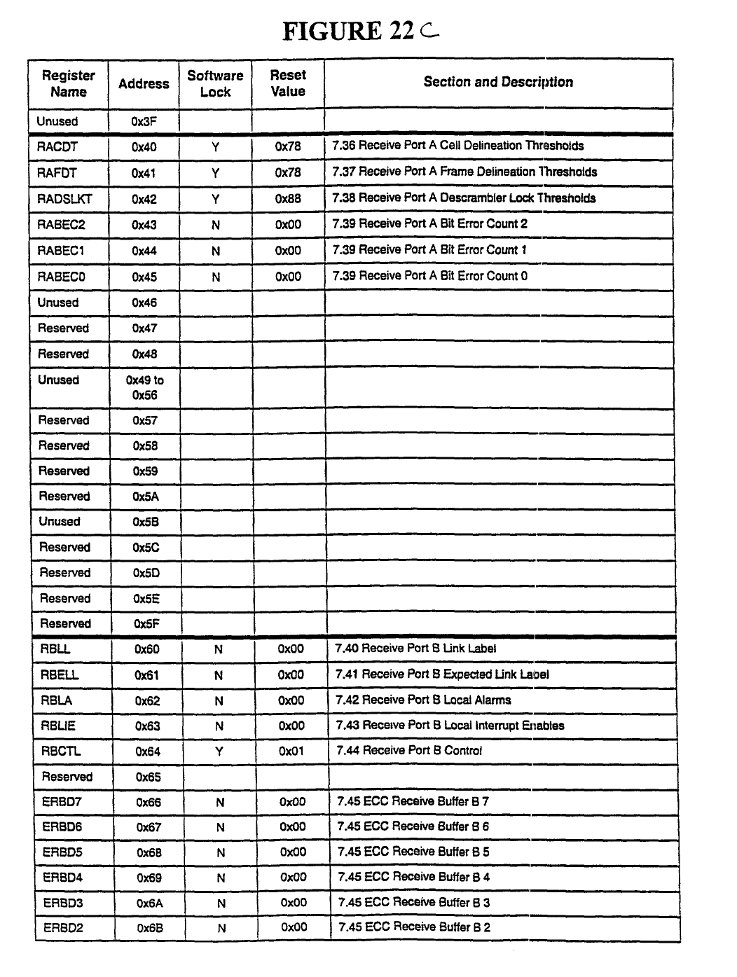

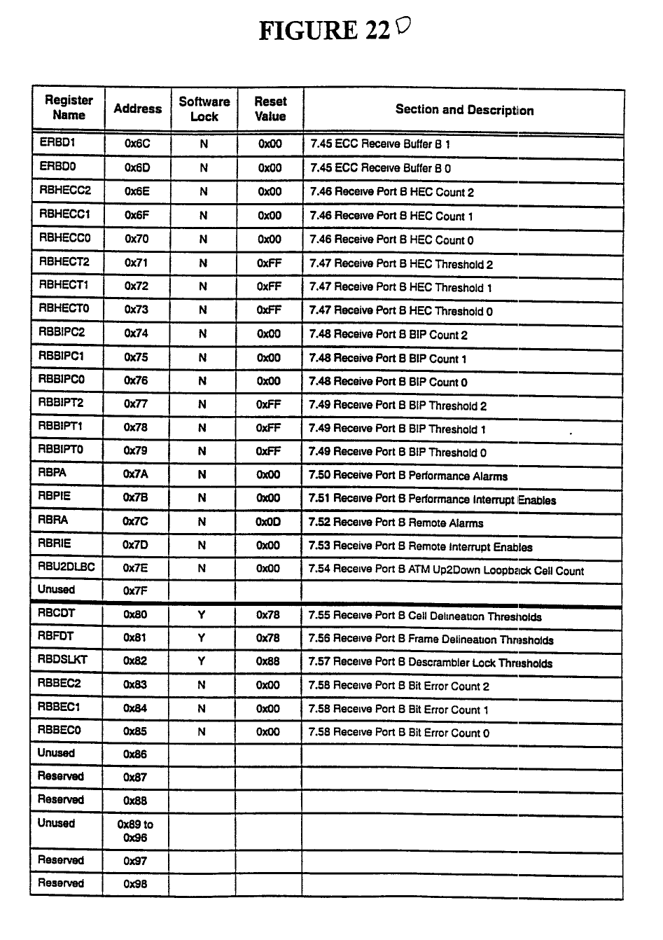

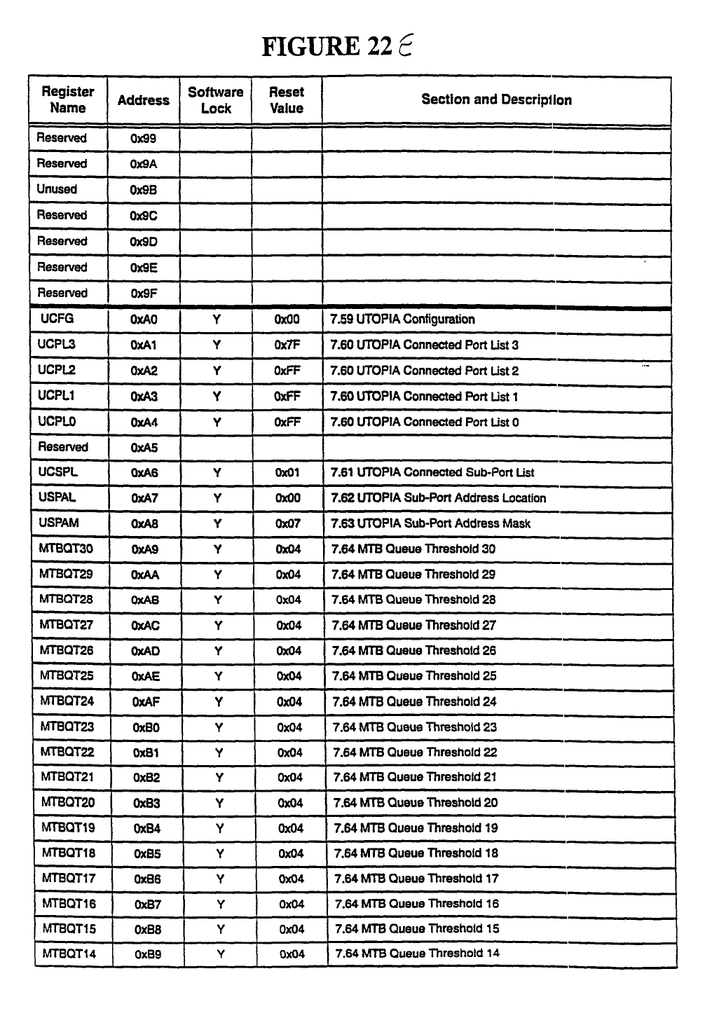

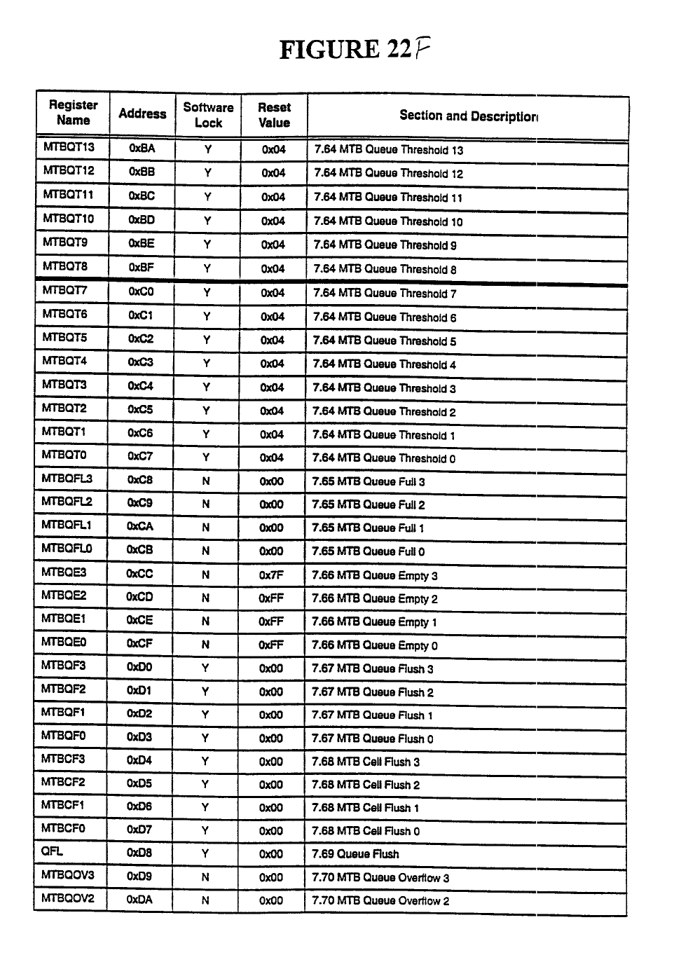

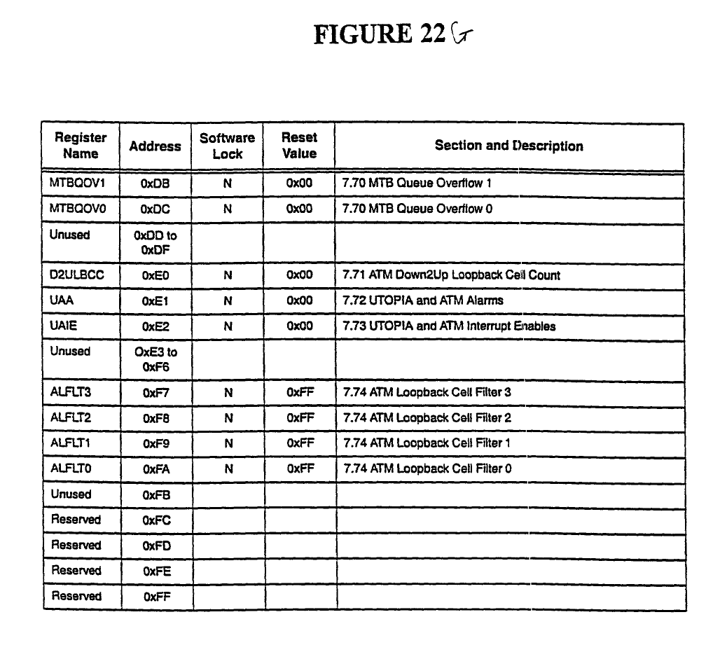

This section describes all the software accessible registers in the UTOPIA-LVDS Bridge 100. A summary of all registers is illustrated in FIGS. 22a-22g.

Note:

All configuration and control registers can be read so that the status of the UTOPIA-LVDS Bridge can be determined by the processor.

All reserved/unused bits will be read as zero and should be written as zero to ensure future compatibility.

Writing to read only register bits has no affect.

Software Lock—0x00 to 0x01 SLK0 to SLK1

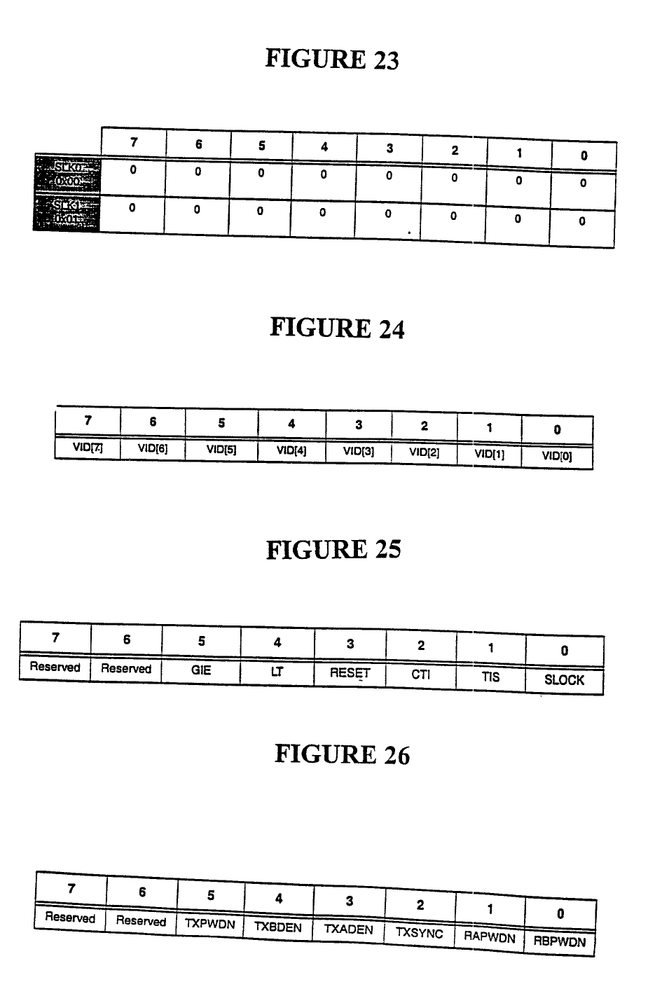

Software Lock register has the address of 0x00 to 0x01 SLK0 to SLK1 and is illustrated in FIG. 23.

Type: Read as 0x00

Software Lock: No

Reset Value: 0x00

The Software Lock registers are used to implement a software lock mechanism on configuration and control registers to prevent spurious software changes to the device which may affect its operation. On reset the Software Lock is ON. Writes to registers protected by this lock will have no affect. To switch the lock OFF the following sequence of writes to the SLK registers must occur.

UNLOCK SEQUENCE

1. Write data 0x00 to SLK0.

2. Write data 0xFF to SLK1.

The software lock is now OFF and those registers protected by it can be successfully written to. To switch the lock back On the following sequence of writes to the SLK registers must occur.

LOCK SEQUENCE

1. Write data 0xDE to SLK0.

2. Write data 0xAD to SLK1.

The software lock is now ON and those registers protected by it cannot be written to.

The order of the writes in each sequence must be followed. However, the sequence does not have to be contiguous. For instance, the processor can Write data 0xDE to SLK0, then carry out further read/write cycles to this or another device before completing the LOCK sequence with Write data 0xAD to SLK1.

The status of the Software Lock can be read at any time from the SLOCK bit of the GCS register.

Version Identification—0x02 VID

Version Identification has the address of 0x02 VID and is illustrated in FIG. 24.

Type: Read only

Software Lock: No

Reset Value: 0x01

VID[7:0] Version and identification number.

General Control and Status—0x03 GCS

General Control and Status Register has the address of 0x03 GSC and is illustrated in FIG. 25.

Type: Bits[5:2] Read/Write

Bit[1:0] Read only

Software Lock: Yes

Reset Value: 0x05

GIE: The Global Interrupt Enable enables the device interrupt output pin CPU_INT. Set=Interrupts enabled and Clear=Interrupts disabled.

LT: The Loop Timing bit enables the connection of the Active Rx port recovered clock to the LVDS Transmit clock (the active Rx port is as defined by the LBA bit of the LKSC register). LT Set=LVDS Tx clock sourced from Active Rx port recovered clock. LT Clear=LVDS Tx clock sourced from LVDS_TxClk pin.

RESET Set=Software reset of all registers except this bit. The Software Lock status as reflected by SLOCK is also not affected by a software reset.

CTI Configuration Traffic Inhibit. The setting of this bit initiates the Traffic Inhibit functionality which causes traffic flow to be stopped. The UTOPIA interface will stop transmitting and receiving cells, the LVDS transmit section will transmit Idle cells and the incoming cells on the active LVDS receive port will be discarded. The MTB (103) and FIB (105) queues will also be flushed. This bit should be set by the processor via CPU interface (115) whenever the device is being fundamentally reconfigured from the default settings, specifically whenever any of the PDUCFG, UCFG, USPAL or USPAM registers are being changed. The processor should set this bit before changing any of the above mentioned register settings. This will initiate Traffic Inhibit. The TIS bit should then be polled. When the TIS bit is set, then traffic is inhibited and the device can safely be reconfigured. When configuration is completed then the CTI bit can be cleared by the processor and normal operation resumed.

TIS Traffic Inhibit Status. This bit reflects the status of the Traffic Inhibit functionality. When set then traffic is inhibited as described for the CTI bit above. When clear then the device operates normally. The setting of the CTI bit will initiate Traffic Inhibit which sets the TIS bit. Clearing of the CTI bit clears the TIS bit.

SLOCK This reflects the status of the Software Lock functionality. Set=Software lock ON and Clear=Software Lock OFF. The processor can use this bit to determine the Software Lock functionality status when writing to lockable registers.

LVDS Control—0x04 LVC

Interrupt Source Register has the address of 0x04 LVC and is illustrated in FIG. 26.

Type: Read/Write

Software Lock: Yes

Reset Value: 0x3B

The LVDS control register configures the LVDS serializer/deserializers.

TXPWDN Transmit section LVDS power down. Set=Power Up and Clear=Power Down. This register value is combined with the LVDS_TxPwdn pin to generate the internal power down setting for transmit section. If either this register it or the LVDS_TxPwdn pin is clear then the transmit LVDS section is powered down.

TXBDEN LVDS B Transmit data output enable. Set=Enable and Clear Disable. This register value is combined with the LVDS_BDenb pin to generate the output enable for the LVDS transmit section B. If either this register bit or the LVDS_BDenb pin is clear then the transmitter B output is disabled.

TXADEN LVDS A Transmit data output enable. Set=Enable and Clear=Disable. This register value is combined with the LVDS_ADenb pin to generate the output enable for the LVDS transmit section A. If either this register bit or the LVDS_ADenb pin is clear then the transmitter A output is disabled.

TXSYNC Transmit LVDS synchronization pattern. Set=Enable and Clear Disable. This register value is combined with the LVDS_Synch pin to generate the SYNCH input to the LVDS transmit section. If either this register bit or the LVDS_SYNCH pin is set then SYNCH patterns are output from the LVDS transmit section.

RAPWDN Receive Port A LVDS power down. Set=Power Up and Clear=Power Down. This register value is combined with the LVDS_APwdn pin to generate the internal power down setting for receive Port A. If either this register bit or the LVDS_APwdn pin is clear then the receive port A LVDS section is powered down.

RBPWDN Receive Port B LVDS power down. Set=Power Up and Clear=Power Down. This register value is combined with the LVDS_BPwdn pin to generate the internal power down setting for receive Port B. If either this register bit or the LVDS_BPwdn pin is clear then the receive port B LVDS section is powered down.

PDU Configuration—0x05 PDUCFG

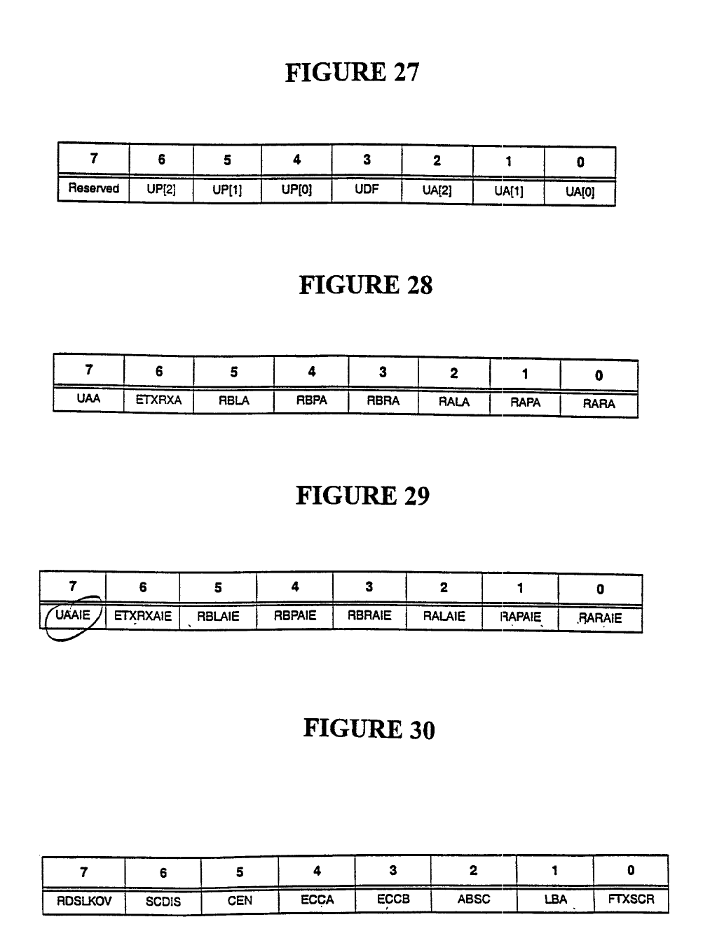

PDU Configuration Register has the address of—0x05 PDUCFG and is illustrated in FIG. 27

Type: Read/Write

Software Lock: Yes

Reset Value: 0x00

The PDU Configuration register defines the contents and size of the PDU cells. This is achieved by defining the size of the User Prepend, whether the UDF is present and the size of the User Append. The total size of the PDU must be in the range 52 to 64 bytes. Therefore the total size of the User Prepend, plus UDF and User Append must not exceed 12 bytes. Further, as the UTOPIA-LVDS Bridge 100 operates with an internal 16 bit datapath the size of the User Prepend and User Append is defined in words (16 bits/2 bytes). If the UDF is present it is 1 word. So in UTOPIA 16-bit mode UDF1 and UDF2 bytes are transported in this word and in UTOPIA 8-bit mode the UDF byte and a padding byte are transported in this word.

UP[2:0]: The UP bits define the length of the User Prepend. Range 0 to 6 words.

UDF: The UDF bit when set indicates that the UDF word is present. When cleared the UDF word is absent.

UA[2:0]: The UA bits define the length of the User Append. Range 0 to 6 words.

Interrupt Source—0x06 IS

Interrupt Source Register has the address of 0x06 and is illustrated in FIG. 28. Type: Read only/Clear on Read

Software Lock: No

Reset Value: 0x00

UAA Set=Interrupt pending in the UAA register.

ETXRXA Set=Interrupt pending in the ETXRXA register.

RBLA Set=Interrupt pending in the RBLA register.

RBPA Set=Interrupt pending in the RBPA register.

RBRA Set=Interrupt pending in the RBRA register.

RALA Set=Interrupt pending in the RALA register.

RAPA Set=Interrupt pending in the RAPA register.

RARA Set=Interrupt pending in the RARA register.

Interrupt Source Enables—0x07 ISE

Interrupt Source Enables Register has the address of 0x07 ISE and is illustrated in FIG. 29.

Type: Read/Write

Software Lock: No

Reset Value: 0x00

The register contains the interrupt enables for the corresponding alarms in the IS register. Set=interrupt sources enabled and Clear=interrupt sources disabled.

Link Status and Control—0x08 LKSC

Link Status and Control Register has the address of 0x08 LKSC and is illustrated in FIG. 30.

Type: Bits[6:3] Read/Write

Bits[2] Read only

Bits[1:0] Read/Write

Software Lock: Yes

Reset Value: 0x34

RDSLOV Remote Descrambler Lock Override. When clear, this allows the transmitter/assembler 107 to automatically send Idle cells containing the Scrambler sequence whenever the remote descrambler falls out of lock. This determined by either the RARDSLK bit or the RBRDSLK bit clear, depending on the Active receive port defined by the LBA bit. This action should force the remote descrambler back into lock. Traffic cells are not transmitted during this action until remote descrambler lock is achieved. If the RKSLKOV bit is set then the actual status of the remote descrambler (RARDSLK or RBRDSLK) is ignored and it is assumed that the remote descrambler is locked and therefor normal traffic cells are transmitted.

SCDIS: Transmit scrambler disable. When set the scrambler is disabled and unscrambled data is transmitted. When clear the scrambler is active and transmitted data is scrambled.

CEN: Coset enable. When set then the optional coset x⁶+x⁴+x²+1 is added to the generated CRC-8 used for the HEC. When clear the coset is not added to the HEC.

ECCA: ECC active on Port A bit. When set, this indicates to the ECC transmit section that the ETXBR bit will be set only when the far end ECC receiver connected to Port A indicates via the ECC signaling over Port A that the message has been received successfully. When clear the ECC signaling over Port A will be ignored as the ECC Port A receiver is disabled and ERABF bit will be held clear.

ECCB: ECC active on Port B bit. When set, this indicates to the ECC transmit section that the ETXBR bit will be set only when the far end ECC receiver connected to Port B indicates via the ECC signaling over Port B that the message has been received successfully. When clear the ECC signaling over Port B will be ignored as the ECC Port B receiver is disabled and ERBBF bit will be held clear.

ECCB and ECCA: Note that when both these bits are set then the ECC transmitter and both receivers are inactive. The ERABF and ERBBF bits will be held clear, the ECC signaling is ignored and no messages are transmitted or received.

ECCB and ECCA: Note that when both these bits are set, this indicates to the ECC receive transmit section that the ETXBR bit will only be set when both far end ECC receivers indicate that the transmitted message has been successfully received.

ABSC: A/B Switch completed. When switching active traffic receive port this bit can be polled by the processor to determine when the switch has been completed successfully. A change of the LBA bit will clear this bit. The ABSC bit should then be polled by the processor. The ABSC bit is set by the hardware when the active port switching is completed. This bit relates to the LBA active traffic switching bit and is not related to the ECC port switching bit ECCA and ECCB.

LBA: Local receive port A or B control. When this bit is set, then Receive Port B is Active and Port A is Standby. When clear, then Port A is Active and Port B is Standby. This bit defines the active traffic port and does not affect which ECC channel is active as defined by the ECCA and ECCB bits above.

FTXSCR Force Transmit Scrambler Sequence. When set this forces the transmission of the scrambler sequence which is used to lock the descrambler.

Transmit Link Label—0x09 TXLL

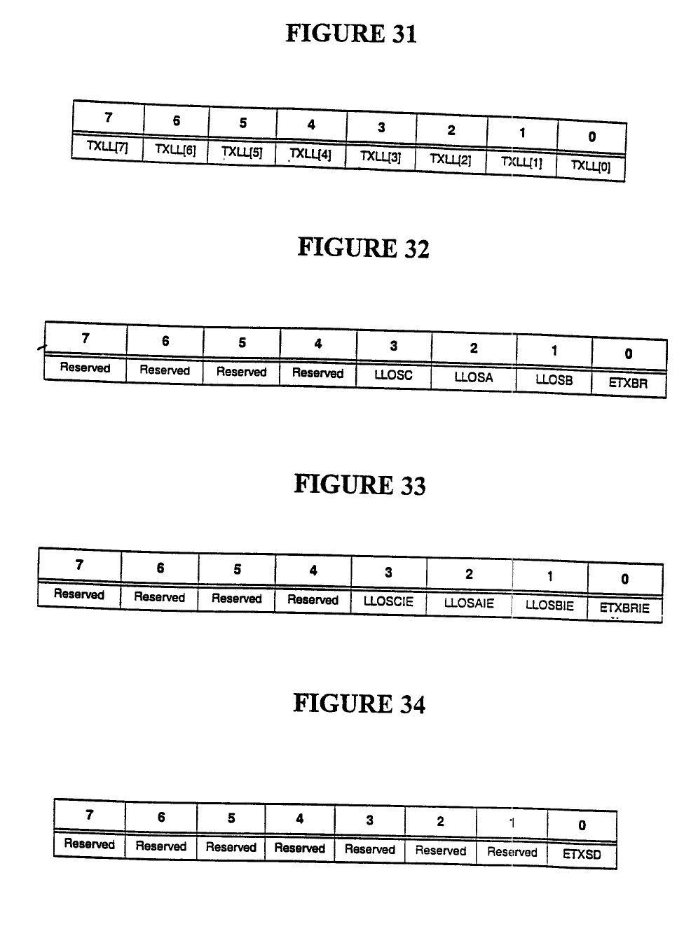

Transmit Link Label Register has the address of 0x09 TXLL and is illustrated in FIG. 31.

Type: Read/Write

Software Lock: No

Reset Value: 0x00

The Transmit Link Label register defines the contents of the Link Trace Label byte transmitted in Transport container 6.

TXLL[7:0] Transmitted Link Trace Label byte contents.

ECC Transmit Buffer and Receive LVDS Alarms—0x0A ETXRXA

ECC Transmit Buffer and Receive LVDS Alarms Register has the address of 0x0A ETXRXA and is illustrated in FIG. 32.

Type: Bits[3:1] Read only/Clear on Read

Bit[0] Read only

Software Lock: No

Reset Value: 0x01

This register contains the status of the ECC transmit buffer and the LOCK signals from the two LVDS receive ports. When set the LLOSA, LLOSB and LLOSC bits will raise an interrupt if the corresponding interrupt enable bit is set.

LLOSA: Local Loss Of Signal on receive Port A. When set this will also clear all the bits in the Receive Port A Remote Alarms register.

LLOSB: Local Loss Of Signal on receive Port B. When set this will also clear all the bits in the Receive Port B Remote Alarms register.

LLOSC: Local Loss Of Signal Change. When set this indicates that there has been a change of value for either LLOSA or LLOSB.

The ETXBR register bit indicates that the ECC transmit section has successfully transmitted the full ECC message consisting of the 8 data bytes contained in registers ETXD7-ETXDO and a new message can be assembled and transmitted. This is a read only bit that the processor must examine before assembling a new ECC message in the ETXD7 ETXDO data registers.

If this bit is not set then any writes to ETXD7-ETXDO will have no affect.

On reset the ETXBR will be set indicating a message can be assembled for transmission. The processor assembles a message in the ETXD7-ETXDO data registers. To send the message the processor 102 simply sets the ETXSD register bit. This clears the ETXBR bit which prevents write access to the ETXD7-ETXDO registers so that the message cannot be overwritten. When the far end ECC receiver indicates via the ECC signaling that the message has been received successfully, then the near end ECC transmitter ETXSD bit is cleared and the ETXBR bit is set. The setting of the ETXBR bit may raise a processor interrupt if the corresponding interrupt enable is set. The processor can therefore detect that a message has been successfully transmitted either by the interrupt or by polling the ETXBR bit.

ETXBR: The ETXBR bit when set indicates that the current ECC message has been successfully transmitted and a new message can be assembled. If this bit is not set then the current message has not been received at the far end and a new message cannot be assembled. The ETXBR bit is cleared by the setting of the ETXSD bit. The ETXBR bit is set either by the far end successfully receiving a message or by the processor clearing the ETXSD bit.

ECC Tx Buffer and Rx LVDS Interrupt Enables—0x0B ETXRXIE

ECC Tx Buffer and Rx LVDS Interrupt Enables Register has the address of has the address of 0x0B ETXRXIE and is illustrated in FIG. 33.

Type: Read/Write

Software Lock: No

Reset Value: 0x00

This register contains the interrupt enables for the alarms in the ETXRXA register. Set=interrupt enabled and Clear=interrupt disabled.

ECC Transmit Buffer Send—0x0C ETXSD

ECC Transmit Buffer Send Register has the address of 0x0C ETXSD and is illustrated in FIG. 34.

Type: Read/Write

Software Lock: No

Reset Value: 0x00

The ETXSD register bit controls the transmission of an ECC message.

ETXSD: The setting of the ETXSD bit initiates the transmission of the ECC message in the ETXD1-ETXD8 data registers if the ETXBR is also set. Once transmission of a message has been initiated in this way it will proceed until the far end ECC receiver indicates via the ECC signaling that the message has been received successfully. So, once set to start the transmission, the ETXSD bit can be cleared by the processor without affecting the message transmission. The ETXSD bit will be cleared automatically when the far end ECC receiver indicates that the message has been received successfully, in the same way that the ETXBR register bit is set. To re-send the same message simply set the ETXSD bit again. The processor can halt transmission of a message by clearing the ETXSD bit which sets the ETXBR bit to enable a new message to be constructed in the ETXD7-ETXDO registers.

ECC Transmit Buffer—0x0D to 0x14 ETXD7 to ETXDO

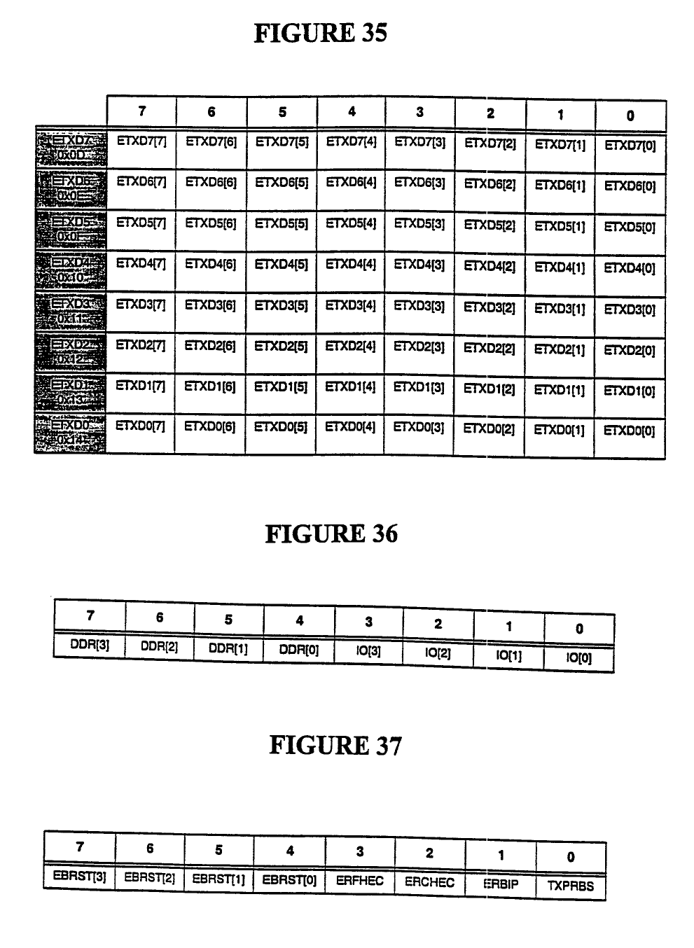

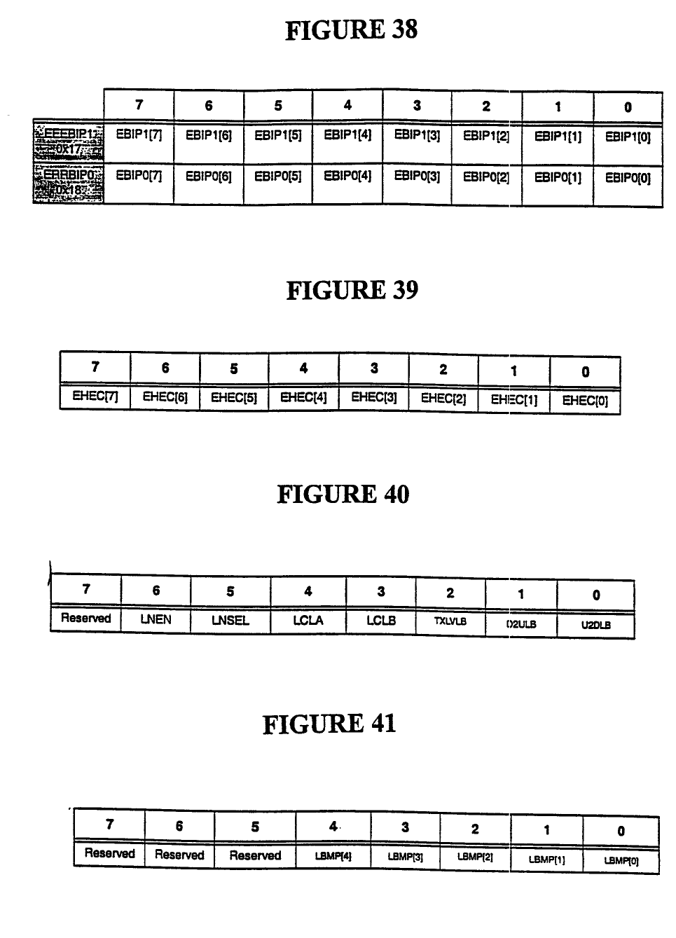

ECC Transmit Buffer Register has the address of 0x0D to 0x14 ETXD7 to ETXDO and is illustrated in FIG. 35.

Type: Read/Write

Software Lock: No

Reset Value: 0x00

The ETXD7, ETXD6, ETXD5, ETXD4, ETXD3, ETXD2, ETXD1 and ETXD0 registers contain the ECC message to be transmitted.

ETXD7-ETXD0: When the ETXBR bit is set then these registers have full read/write access to allow flexible assembly of the ECC message before transmission is initiated by setting the ETXSD bit. When the ETXBR is cleared, during message transmission, these registers are read only so that the message being transmitted cannot be overwritten and corrupted.

General Purpose Input Output—0x15 GPIO General Purpose Input Output Register has the address of 0x15 GPIO and is illustrated in FIG. 36.

Type: Bits [7:4] Read/Write

Bits [3:0] are Read only when defined GPIO [3:0] are defined as Inputs and Read/Write when GPIO [3:0] are defined as Outputs.

Software Lock: No

Reset Value: 0xF0

The General Purpose Input/Output register controls the four general purpose input/output pins GPIO[3:0].

DDR[3:0] The Data Direction bits DDR[3:0] define the function of the GPIO [3:0] pins. When a DDR bit is set the corresponding GPIO pin is an input and when the DDR bit is clear the corresponding GPIO pin is an output.

IO[3:0] The IO bits reflect the value of the GPIO pins. When defined as an output by the DDR bit, then the IO bit value is driven out on the corresponding GPIO pin. When defined as an input by the DDR bit, then the IO bit value captures the incoming value on the corresponding GPIO pin.

Test Error Control—0x16 TERRCTL

Test Error Control Register has the address of 0x16 TERRCTL and is illustrated in FIG. 37.

Type: Read/Write

Software Lock: Yes

Reset Value: 0x00

The Test Error Control register is used to control the transmission of a PRBS pattern for Bit Error Rate testing, or to introduce HEC and BIP errors so that the Cell Delineation, Frame Delineation, Descrambler Lock and performance monitoring functions can be tested. This is a test register and should not be used on live traffic. The exact nature of the errored HEC and BIP bytes is determined by the ERRBIP1, ERRBIP1 and ERRHEC registers.

EBRST[3:0] The Error Burst bits EBRST[3:0] define the number of consecutive erred HEC's and/or BIP's to be generated and transmitted.

ERFHEC The Error Frame HEC bit, when set, will cause EBRST consecutive Frame HEC's to be errored. When this has been completed the hardware will clear this bit.

ERCHEC The Error Frame HEC bit, when set, will cause EBRST consecutive Cell HEC's to be errored. When this has been completed the hardware will clear this bit.

ERBIP The Error BIP bit, when set, will cause EBRST consecutive BIP's to be errored. When this has been completed the hardware will clear this bit.

TXPRBS Transmit PRBS pattern. When set, the transmit section sends the raw scrambler pseudo-random sequence 9polynomial x³¹+x²⁸+1). No data is transmitted. The Transport containers Assembler 107 will be paused and no cells will be read from the FIB queue. The far end receiver can lock to this PRBS pattern to count bit errors if the RABEC/RBBEC bit is set in the RACTL/RBCTL register. This is not a live traffic test.

Error BIP Mask—0x17 to 0x18 ERRBIP1 to ERRBIP0

The Error BIP Mask Register has the address of 0x17 to 0x18 ERRBIP1 to ERRBIP0 and is illustrated in FIG. 3 8.

Type: Read/Write

Software Lock: Yes

Reset Value: 0x00

The Error BIP Mask registers controls how errors are introduced into the BIP bytes when bit ERBIP of the TERRCTL register is set. If a bit is set in the ERRBIP1 or ERRBIP0 register then the corresponding bit in the transmitted BIP is inverted. ERRBIP1 corresponds to the first transmitted BIP byte and ERRBIP0 corresponds to the second transmitted BIP byte.

Error HEC MASK—0x19 ERRHEC

Error HEC MASK Register has the address of 0x19 ERRHEC and is illustrated in FIG. 39.

Type: Read/Write

Software Lock: Yes

Reset Value: 0x00

The Error HEC Mask register controls the introduction of errors into the HEC byte when the ERFHEC and/or ERCHEC bits of the TERRCTL register are set. If a bit is set in the ERRHEC register, then the corresponding bit in the transmitted HEC is inverted.

ATM and LVDS Loopback Control—0x1A ALBC

ATM and LVDS Loopback Control Register has the address of 0x1A ALBC and is illustrated in FIG. 40.

Type: Read/Write

Software Lock: No

Reset Value: 0x00

The ATM and LVDS Loopback Control register controls the loopback functions of the device.

Note that the LVDS Line and Local loopbacks should not be on at the same time.

LNEN :LVDS Line Loopback enable. Set=ON and Clear=OFF. When set this enables the loopback of the LVDS receive section, determined by LNSEL, to the transmitter.

LNSEL: LVDS Line Loopback receive section select. Set=Receive B and Clear=Receive A.

LCLA :LVDS Local Loopback transmit to receive Port A. Set=ON and Clear=OFF.

LCLB :LVDS Local Loopback transmit to receive Port B. Set=ON and Clear=OFF.

TXLVLB When set, this initiates the transmission of a single loopback cell Down Bridge on the LVDS transmitter. This cell will be transmitted with MPhy address defined in the ALBMP register and will have a header format as defined in the ALBCF3-ALBCFO registers. When clear the cell has been transmitted. The processor sets the bit to initiate the transmission and then polls this bit to determine when transmission has been completed, at which time the process can be repeated to transmit another loopback cell.

D2ULB When set, this enables the ATM Down2Up loopback circuit. Any incoming cells from the UTOPIA interface which match the format of ALBCF3-ALBCF0 registers, masked by the ALFLT3-ALFLT0 registers, are not stored in the FIB traffic queue but transmitted back out over the UTOPIA interface.

U2ULB When set, this enables the ATM Up2 Down loopback circuit. Any incoming cells from the active LVDS receive port which match the format of ALBCF3-ALBCF0 registers, masked by the ALFLT3-ALFLT0 registers, are not stored in the MTB traffic queue but transmitted back out over the LVDS transmitter. Note that although there are two independent receivers, this loopback is designed to operate on live traffic and so only affects cells from the active receiver as defined by the LBA bit of the LKSC register.

ATM Loopback MPhy—0x1B ALBMP ATM Loopback MPhy Register has the address of 0x1B ALBMP and is illustrated in FIG. 41.

Type: Read/Write

Software Lock: No

Reset Value: 0x00

The ATM Loopback MPhy register defines the MPhy address attached to any ATM cell loopback initiated by setting the TXLVLB bit in the ALBC register

LBMP[4:0] ATM loopback cell five bit MPHY address.

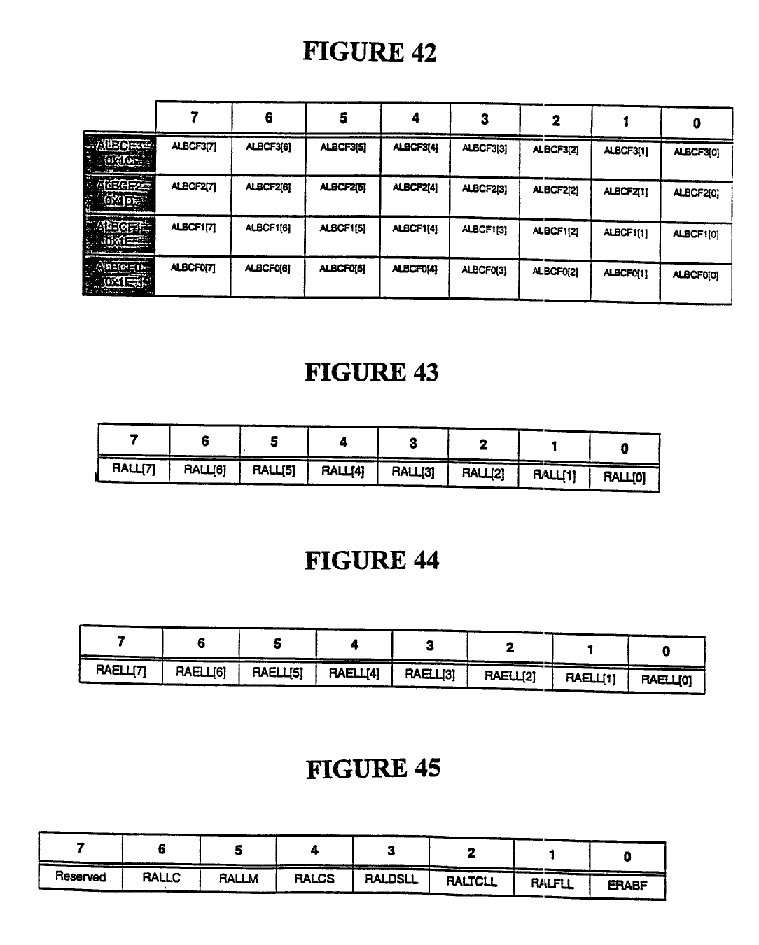

ATM Loopback Cell Format—0x1C to 0x1F ALBCF3 to ALBCF0 ATM Loopback Cell Format Register has the address of 0x1C to 0x1F ALBCF3 to ALBCF0 and is illustrated in FIG. 42.

Type: Read/Write

Software Lock: No

Reset Value: 0x00

The ALBCF3, ALBCF2, ALBCF1 and ALBCF0 registers define the format of the ATM loopback cell header.

ALBCF3[7:0] Loopback Cell header byte H1 format.

ALBCF2[7:0] Loopback Cell header byte H2 format.

ALBCF1[7:0] Loopback Cell header byte H3 format.

ALBCF0[7:0] Loopback Cell header byte H4 format.

Receive Port A Link Label—0x20 RALL

Receive Port A Link Label Register has the address of 0x20 RALL and is illustrated in FIG. 43.

Type: Read only

Software Lock: No

Reset Value: 0x00

The Receive Port A Link Label register contains the Link Trace Label byte received in Transport container 6 on receive Port A. Whenever the received link label changes value the RALLC alarm bit in the RALA register is set which will raise an interrupt if the corresponding interrupt enable bit is set.

RALL[7:0] Port A Received Link Trace Label byte contents.

Receive Port A Expected Link Label—0x21 RAELL Receive Port A Expected Link Label Register has the address of—0x21 RAELL and is illustrated in FIG. 44.

Type: Read/Write

Software Lock: No

Reset Value: 0x00

The Receive Port A Expected Link Label register defines the expected contents of the Link Trace Label byte received in Transport container 6 on receive Port A. If the actual received value, as stored in the RALL register is not the same as the expected value defined here the RALLM alarm bit in the RALA register is set, which may raise a processor interrupt if the corresponding interrupt enable is set.

RAELL[7:0] Port A Expected Received Link Trace Label byte contents.

Receive Port A Local Alarms—0x22 RALA

Receive Port A Local Alarms Register has the address of 0x22 RALA and is illustrated in FIG. 45.

Type: Bits[6:1] Read only/Clear on Read

Bit[0] Read/Write

Software Lock: No

Reset Value: 0x00

The Receive Port A Local Alarms register contains information on the status of the Port A disassembler. When set RALLC, RALLM, RALDSLL, RALTCLL and RALFLL will raise an interrupt if the corresponding interrupt enable bits are set. Also a change in value on RALDSLL, RALTCLL and RALFLL will set the RALCS bit which will raise an interrupt if the corresponding interrupt enable bit is set.

RALLC: Receive Port A, Local Link Label Change of Status. Set=Change in RALL register value.

RALLM Receive Port A, Local Link Label Mismatch. Set=Received link label RALL different than expected link label RAELL.

RALCS Receive Port A, Local Change of Status.

RALDSLL Receive Port A, Local Descrambler Loss of Lock. Set=Out of Lock and Clear=Lock.

RALTCLL Receive Port A, Local Transport Container Delineation Loss of Lock.

Set=Out of Lock and Clear=Lock.

RALFLL Receive Port A, Local Frame Delineation Loss of Lock. Set=Out of Lock and Clear=Lock.

The ERABF register bit indicates that the ECC receive section for Port A has successfully received a full ECC message consisting of the 8 data bytes contained in registers ERAD7-ERAD0 and a the message can now be read by the processor 102.

On reset the ERABF will be clear indicating no valid message has been received. When a valid message is received and stored in the ERAD7-ERAD0 data registers the ERABF bit will be set will raise an interrupt if the corresponding interrupt enable bit is set. The processor can therefore detect a received message on the interrupt or by polling the ERABF bit. When the processor has finished reading the message from the ERAD7-ERAD0 data registers and is ready to receive a new message it simply clears the ERABF bit. When a full message has been successfully received this is communicated to the far-end device via the ECC signaling.

ERABF The ERABF bit when set indicates that ERAD7-ERAD10 data registers contain a fill valid received message. The data in the ERAD7-ERAD0 data registers cannot be overwritten with a new received message while ERABF is set. When ERABF is cleared this allows the ERAD7-ERAD0 data registers to be overwritten with a new received message.

Receive Port A Local Interrupt Enables—0x23 RALIE

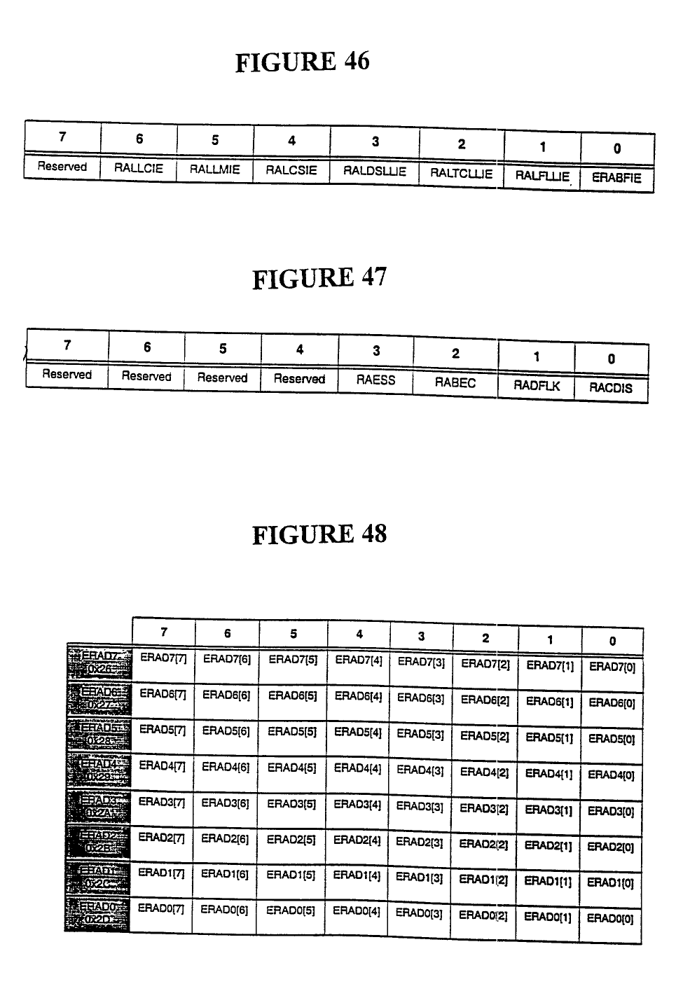

Receive Port A Local Interrupt Enables Register has the address of 0x23 RALIE and is illustrated in FIG. 46.

Type: Read/Write

Software Lock: No

Reset Value: 0x00

This register contains the interrupt enables for the alarms in the RALA register. Set=interrupt enabled and Clear=interrupt disabled.

Receive Port A Control—0x24 RACTL

Receive Port A Control Register has the address of 0x24 RACTL and is illustrated in FIG. 47.

Type: Read/Write

Software Lock: Yes

Reset Value: 0x01

The Receive Port A Control register defines the operation of the Port A Transport containers DisAssemler section.

RAESS Receive Port A, Valid Received ESS bit select. Two ESS bits are received in the Remote Alarm and Signaling Byte as described. Only one of these received bits may be designated as valid. The valid bit is extracted and passed to the ECC transmit section as the ECC signaling bit (ESS) received on Port A. When RAESS is set then Remote Alarm and Signaling Byte bit[1], ESSB, is selected as valid and bit[2], ESSA is ignored. When RAESS is clear then the Remote Alarm and Signaling Byte bit[2], ESSA, is selected as valid and bit [1], ESSB is ignored. The names ESSA and ESSB of these bits refers to the remote receiver port from which they originated and are not associated with the local receivers Port A and Port B.

RABEC Receiver Port A, Bit Error Count mode. When set the receiver expects to receive the raw scrambler PRBS pattern. See TXPRBS bit of the TERRCTL register. The descrambler will lock to this sequence and then count individual bit errors in the PRBS stream. This bit error count will be reflected in the RABEC2 RABECO registers. As there is no data cell delineation, the frame delineation will be lost. This is not a live traffic test.

RADFLK Receive Port A, Descrambler Force Lock. When set the descrambler will be forced out of lock and will immediately begin to re-lock. The hardware will clear this bit and descrambler lock status can be monitored on the RALDSLL bit of the RALA register.

RACDIS Receive Port A, Cell Discard. When set then cells with an errored HEC are discarded.

ECC Receive Buffer A—0x26 to 0x2D ERAD7 to ERADO

ECC Receive Buffer A Register has the address of 0x26 to 0x2D ERAD7 to ERAD0 and is illustrated in FIG. 48.

Type: Read only

Software Lock: No

Reset Value: 0x00

The ERAD7, ERAD6, ERAD5, ERAD4, ERAD3, ERAD2, ERAD1 and ERAD0 registers contain the Port A received ECC message.

ERAD7-ERAD0 When the ERABF bit is set then these registers contain a valid received ECC message for Port A and cannot be overwritten by any incoming messages. When the ERABF bit is clear these registers may not contain a valid message and should not be interpreted as such.

Receive Port A HEC Count—0x2E to 0x30 RAHECC2 to RAHECC0

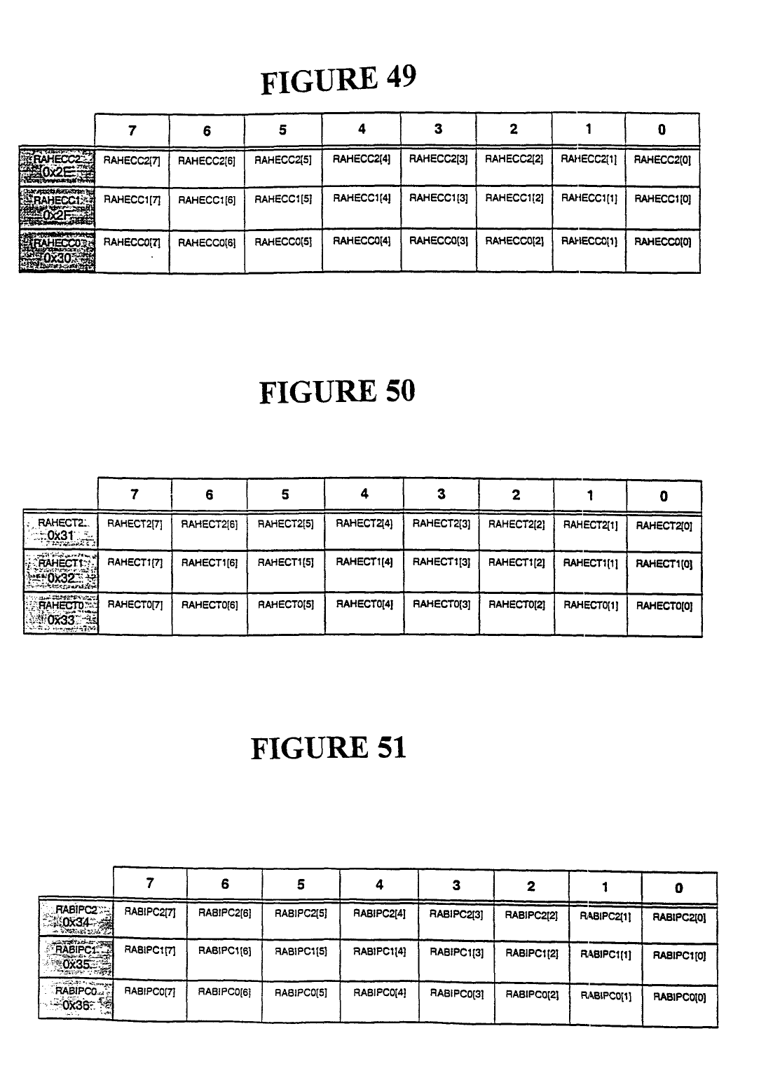

Receive Port A HEC Count Register has the address of 0x2E to 0x30 RAHECC2 to RAHECC0 and is illustrated in FIG. 49.

Type: Read only/Clear on Read

Software Lock: No

Reset Value: 0x00

The RAHECC2, RAHECC1 and RAHECC0 registers contain the Port A received errors HEC count.

RAHECC2-RAHECC0: This register must be read in the order of most significant byte RAHECC2 first and least significant byte RAHECC0 or the value read will not be valid. This counter will not roll-over from 0xFFFFFF to 0x000000 but will stick at 0xFFFFFF.

Receive Port A HEC Threshold—0x31 to 0x33RAHECT2 to RAHECT0

Receive Port A HEC Threshold Register has the address of 0x31 to 0x3RAHECT2 to RAHECT0 and is illustrated in FIG. 50.

Type: Read/Write

Software Lock: No

Reset Value: 0xFF

The RAHECT2, RAHECT1 and RAHECT0 registers contain the Port A received errors HEC threshold. When the error count RAHECC equals the threshold RAHECT then the RAXHEC alarm will bet set.

RAHECT2-RAHECT0: Most significant byte RAHECT2 and least significant byte RAHECT0.

Receive Port A BIP Count—0x34to 0x36RABIPC2 to RABIPC0

Receive Port A BIP Count Register has the address of 0x34 to 0x36 RABIPC2 to RABIPC0 and is illustrated in FIG. 51.

Type: Read only/Clear on Read

Software Lock: No

Reset Value: 0x00

The RABIPC2, RABIPC 1 and RABIPC0 registers contain the Port A received errors BIP count.

RABIPC2-RABIPC0: This register must be read in the order of most significant byte RABIPC2 first and least significant byte RABIPC0 or the value read will not be valid. This counter will not roll-over from 0xFFFFFF to 0x000000 but will stick at 0xFFFFFF.

Receive Port A BIP Threshold—0x36 to 0x39RABIPT2 to RABIPT0

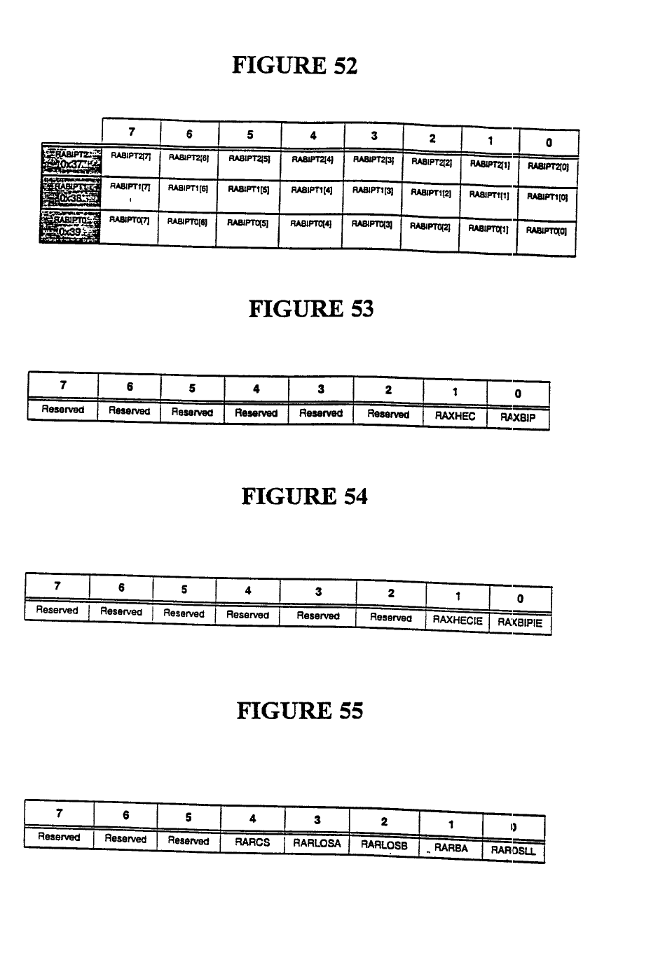

Receive Port A BIP Threshold register has the address of 0x36 to 0x39RABIPT2 to RABIPT0 and is illustrated in FIG. 52.

Type: Read/Write

Software Lock: No

Reset Value: 0x00

The RABIPT2, RABIPT1 and RABIPT0 registers contain the Port A received errors BIP threshold. When the error count RABIPC equals the threshold RABIPT then the RAXBIP alarm will bet set.

RABIPT2-RABIPT0: Most significant byte RABIPT2 and least significant byte RABIPT0.

Receive Port A Performance Alarms—0x3A RAPA

Receive Port A Performance Alarms register has the address of 0x3A RAPA and is illustrated in FIG. 53.

Type: Read only/Clear on Read

Software Lock: No

Reset Value: 0x00

The Receive Port A Performance Alarms register contains information error performance of Port A. When set RAXHEC and RAXBIP will raise an interrupt if the corresponding interrupt enable bits are set.

RAXHEC: Receive Port A, Excessive HEC Errors. Set=Number of HEC errors counted in RAHECC equals the threshold set in RAHECT.

RAXBIP: Receive Port A, Excessive BIP Errors. Set=Number of BIP errors counted in RABIPC equals the threshold set in RABIPT.

Receive Port A Performance Interrupt Enables—0x3B RAPIE Receive Port A Performance Interrupt Enables register has the address of 0x3B RAPIE and is illustrated in FIG. 54.

Type: Read/Write

Software Lock: No

Reset Value: 0x01

This register contains the interrupt enables for the alarms in the RAPA register. Set=interrupt enabled and Clear=interrupt disabled.

Receive Port A Remote Status and Alarms—0x3C RARA

Receive Port A Remote Alarms register has the address of 0x3C RARA and is illustrated in FIG. 55.

Type: Read only

Software Lock: No

Reset Value: 0x0D

The Receive Port A Remote Alarms register contains information on the status of the far-end device which is connected to Port A. On a local Loss of Signal on Port A, LLOSA alarm, these bits are all cleared. When set the RARLOSA, RARLOSB and RARDSLL bits will raise an interrupt if the corresponding interrupt enable is set. A change in value on RARBA will raise an interrupt if the corresponding interrupt enable is set. Also a change in value on RARLOSA, RARLOSB, RARDSLL and RARBA will set the RARCS bit. When set the RARCS bit will raise an interrupt if the corresponding interrupt enable is set.

RARCS: Receive Port A, Remote Change of Status at far end device LVDS receive Ports.

RARLOSA: Receive Port A, Remote Loss Of Signal at far end device LVDS receive Port A.

RARLOSB: Receive Port A, Remote Loss Of Signal at far end device LVDS receive Port B.

RARBA: Receive Port A, Remote far end device active receive Port. Set=Port B active and Clear=Port A active.

RARDSLL: Receive Port A, Remote far end device active receive port Descrambler Loss of Lock. Set=Out of Lock and Clear=Lock.

Receive Port A Remote Interrupt Enables—0x3D RARIE

Receive Port A Remote Interrupt Enables register has the address of 0x00 RAPIE and is illustrated in FIG. 56.

Type: Read/Write

Software Lock: No

Reset Value: 0x00

This register contains the interrupt enables for the alarms in the RARA register. Set=interrupt enabled and Clear=interrupt disabled.

Receive Port A Up2Down Loopback Cell Count—0x3E RAU2DLBC

Receive Port A Up2Down Loopback Cell Count Register has the address of 0x3E RAU2DLBC and is illustrated in FIG. 57.

Type: Read only/Clear on Read

Software Lock: No

Reset Value: 0x00

The Receive Port A Up2Down Loopback Cell count register counts the number of incoming loopback cells detected from the Port A LVDS interface when Up2Down loopback is enabled with the U2DLB bit of the ALBC register.

RAU2DLBC[7:0] Port A Up2Down Loopback Cell Count value. This register will not roll-over from 0x00 to 0xFF but will stick at 0xFF.

Receive Port A Cell Delineation Thresholds—0x40 RACDT

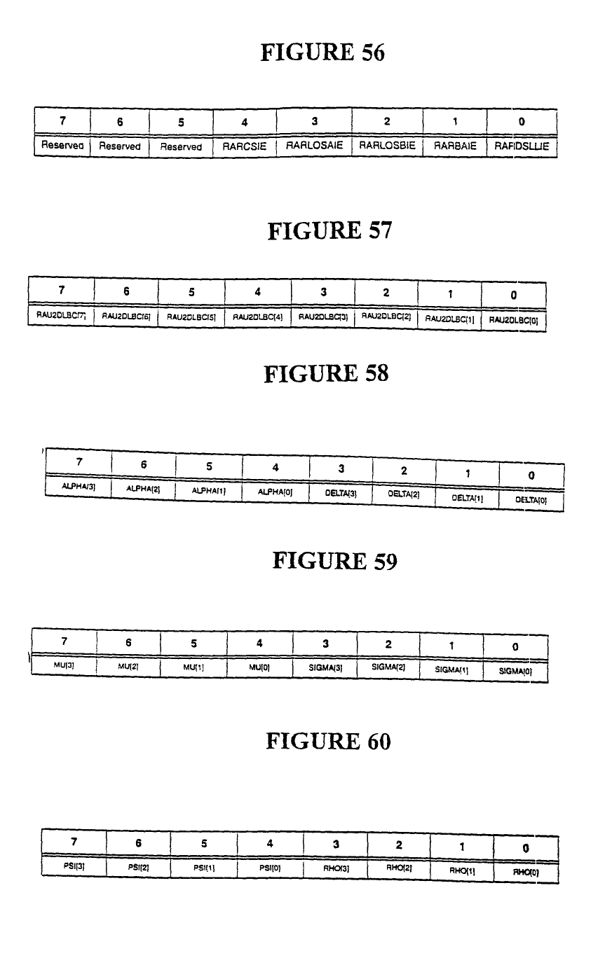

Receive Port A Cell Delineation Thresholds Register has the address of 0x40 RACDT and is illustrated in FIG. 58.

Type: Read/Write

Software Lock: Yes

Reset Value: 0x78

The Receive Port A Cell Delineation Thresholds register controls the operation of the Port A cell delineation state machine. The cell delineation lock status is reflected in the RALTCLL bit of the RALA register.

ALPHA[3:0] When in lock this is the number of consecutive incorrect cell HEC's required to lose cell delineation lock.

DELTA[3:0] When out of lock this is the number of consecutive correct cell HEC's required to gain cell delineation lock.

Receive Port A Frame Delineation Thresholds—0x41 RAFDT

Receive Port A Frame Delineation Thresholds Register has the address of 0x41 RAFDT and is illustrated in FIG. 59.

Type: Read/Write

Software Lock: Yes

Reset Value: 0x78

The Receive Port A Frame Delineation Thresholds register controls the operation of the Port A frame delineation state machine. The frame delineation lock status is reflected in the RALFLL bit of the RALA register.

RU[3:0] When in lock this is the number of consecutive incorrect frame HEC's required to lose frame delineation lock.

SIGMS[3:0] When out of lock this is the number of consecutive correct frame HEC's required to gain frame delineation lock.

Receive Port A Descrambler Lock Thresholds—0x42 RADSLKT

Receive Port A Descrambler Lock Thresholds Register has the address of 0x42 RADSLKT and is illustrated in FIG. 60.

Type: Read/Write

Software Lock: Yes

Reset Value: 0x88

The Receive Port A Descrambler Lock Thresholds register controls the operation of the Port A descrambler lock state machine confidence counter. The descrambler lock status is reflected in the RALDSLL bit of the RALA register.

PSI[3:0] When in lock this is the threshold that the descrambler confidence counter must reach to lose descrambler lock. When in lock the descrambler confidence counter increments on incorrect HEC predictions and decrements on good HEC predictions.

RHO[3:] When out of lock this is the threshold that the descrambler confidence counter must reach to gain descrambler lock. When out of lock the descrambler confidence counter decrements on incorrect HEC predictions and increments on good HEC predictions.

Receive Port A Bit Error Count—0x43 to 0x45 RABEC2 to RABEC0

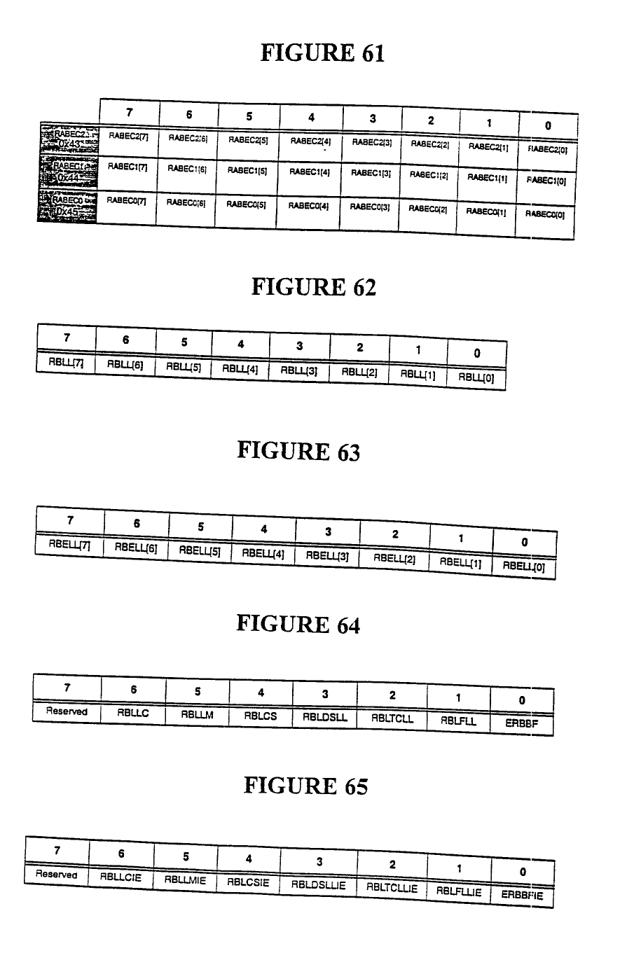

Receive Port A Bit Error Count Register has the address of 0x43 to 0x45 RABEC2 to RABEC0 and is illustrated in FIG. 61.

Type: Read only/Clear on Read

Software Lock: No

Reset Value: 0x00

The RABEC2, RABEC 1 and RABEC0 registers contain the Port A received bit error count whenever the RABEC bit of the RACTL register is set. If the RABEC bit of the RACTL register is clear these registers are cleared.

RABEC2-RABEC0 This register must be read in the order of most significant byte RABEC2 first and least significant byte RABEC0 last, or the value read will not be valid. This counter will not roll-over from 0xFFFFFF to 0x000000 but will stick at 0xFFFFFF.

Receive Port B Link Label—0x60 RBLL

Receive Port B Link Label register has the address of 0x60 RBLL and is illustrated in FIG. 62.

Type: Read only

Software Lock: No

Reset Value: 0x00

The Receive Port B Link Label register contains the Link Trace Label byte received in Transport container 6 on receive Port B.

Whenever the received link label changes value the RBLLC alarm bit in the RBLA register is set which will raise an interrupt if the corresponding interrupt enable bit is set.

RBLL[7:0]: Port B Received Link Trace Label byte contents.

Receive Port B Expected Link Label—0x61 RBELL

Receive Port B Expected Link Label register has the address of 0x61 RBELL and is illustrated in FIG. 63.

Type: Read/Write

Software Lock: No

Reset Value: 0x00

The Receive Port B Expected Link Label register defines the expected contents of the Link Trace Label byte received in Transport container 6 on receive Port B. If the actual received value, as stored in the RBLL register is not the same as the expected value defined here the RBLLM alarm bit in the RBLA register is set, which may raise a processor interrupt if the corresponding interrupt enable is set.

RBELL[7:0]: Port B Expected Received Link Trace Label byte contents.

Receive Port B Local Alarms—0x62 RBLA

Receive Port B Local Alarms register has the address of 0x62 RBLA and is illustrated in FIG. 64.

Type: Bits[6:1] Read only/Clear on Read

Bit[0] Read/Write

Software Lock: No

Reset Value: 0x00

The Receive Port B Local Alarms register contains information on the status of the Port B disassembler. When set RBLLC, RBLLM, RBLDSLL, RBLTCLL and RBLFLL will raise an interrupt if the corresponding interrupt enable bits are set. Also a change in value on RBLDSLL, RBLTCLL and RBLFLL will set the RBLCS bit which will raise an interrupt if the corresponding interrupt enable bit is set.

RBLLC: Receive Port B, Local Link Label Change of Status. Set=Change in RBLL register value.

RBLLM: Receive Port B, Local Link Label Mismatch. Set=Received link label RBLL different than expected link label RBELL.

RBLCS: Receive Port B, Local Change of Status.

RBLDSLL: Receive Port B, Local Descrambler Loss of Lock. Set=Out of Lock and Clear=Lock.

RBLTCLL: Receive Port B, Local Transport Container Delineation Loss of Lock. Set=Out of Lock and Clear=Lock.

RBLFLL: Receive Port B, Local Frame Delineation Loss of Lock. Set=Out of Lock and Clear=Lock.

The ERBBF register bit indicates that the ECC receive section for Port B has successfully received a full ECC message consisting of the 8 data bytes contained in registers ERBD7-ERBD0 and a the message can now be read by the processor.

On reset the ERBBF will be clear indicating no valid message has been received. When a valid message is received and stored in the ERBD7-ERBD0 data registers the ERBBF bit will be set will raise an interrupt if the corresponding interrupt enable bit is set. The processor can therefor detect a received message on the interrupt or by polling the

ERBBF bit. When the processor has finished reading the message from the ERBD7-ERBD0 data registers and is ready to receive a new message it simply clears the ERBBF bit. When a full message has been successfully received this is communicated to the far-end device via the ECC signaling.

ERBBF: The ERBBF bit when set indicates that ERBD7-ERBD0 data registers contain a full valid received message. The data in the ERBD7-ERBD0 data registers cannot be overwritten with a new received message while ERBBF is set. When ERBBF is cleared this allows the ERBD7-ERBD0 data registers to be overwritten with a new received message.

Receive Port B Local Interrupt Enables—0x63 RBLIE

Receive Port B Local Interrupt Enables register has the address of 0x63 RBLIE and is illustrated in FIG. 65.

Type: Read/Write

Software Lock: No

Reset Value: 0x00

This register contains the interrupt enables for the alarms in the RBLA register. Set=interrupt enabled and Clear=interrupt disabled.

Receive Port B Control—0x64 RBCTL

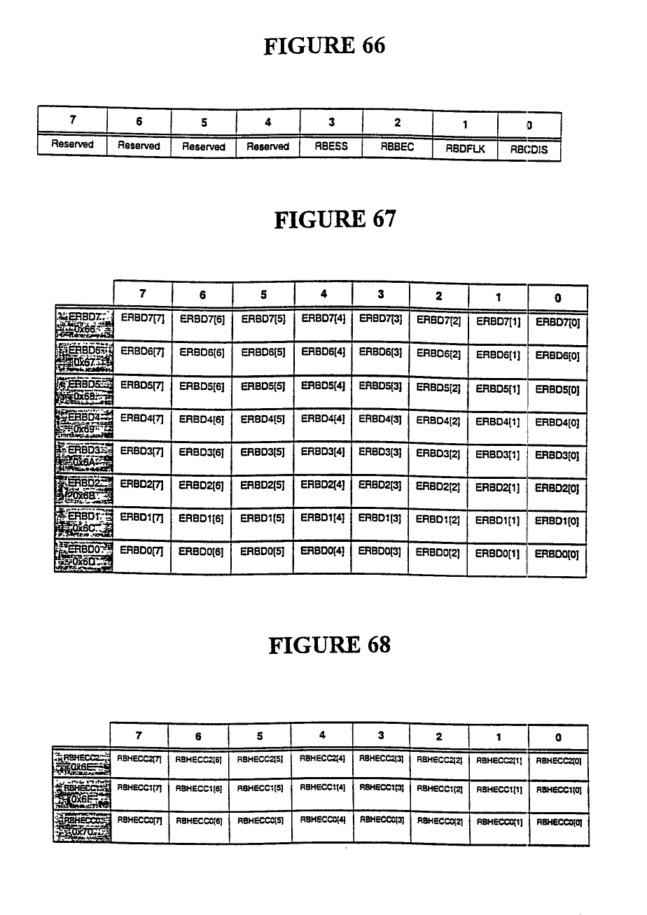

Receive Port B Control Register has the address of 0x64 RBCTL and is illustrated in FIG. 66.

Type: Read/Write

Software Lock: Yes

Reset Value: 0x01

The Receive Port B Control register defines the operation of the Port B Transport containers DisAssembler section.

RBESS Receive Port B, Valid Received ESS bit select. Two ESS bits are received in the Remote Alarm and Signaling Byte as described. Only one of these received bits may be designated as valid. The valid bit is extracted and passed to the ECC transmit section as the ECC signaling bit (ESS) received on Port A.

When RBESS is set then the Remote Alarm and Signaling Byte bit[1], ESSB, is selected as valid and bit[2], ESSA, is selected as valid and bit[1], ESSB is ignored. The names ESSA and ESSB of these bits refers to the remote receiver port from which they originated and are not associated with the local receivers PortA and Port B.

RBBEC Receive Port B, Bit Error Count mode. When set the receiver expects to receive the raw scrambler PRBS pattern. See TXPRBS bit of the TERRCTL register. The descrambler will lock to this sequence and then count individual bit errors in the PRBS stream. This bit error count will be reflected in the RBBEC2 RBBEC0 registers. As there is no data cell delineation, the frame delineation will be lost. This is not a live traffic test.

RBDFLK Receive Port B, Descrambler Force Lock. When set the descrambler will be forced out of lock and will immediately begin to re-lock. The hardware will clear this bit and the descrambler lock status can be monitored on the RBLDSLL bit of the RBLA register.

ECC Receive Buffer B—0x66 to 0x6D ERBD7 to ERBD0

ECC Receive Buffer B—0x66 to 0x6D ERBD7 to ERBD0 and is illustrated in FIG. 67.

Type: Read only

Software Lock: No

Reset Value: 0x00

The ERBD7, ERBD6, ERBD5, ERBD4, ERBD3, ERBD2, ERBD1 and ERBD0 registers contain the Port B received ECC message.

ERBD7-ERBD0: When the ERBBF bit is set these registers contain a valid received ECC message for Port B and cannot be overwritten by any incoming messages. When the ERBBF bit is clear these registers may not contain a valid message and should not be interpreted.

Receive Port B HEC Count—0x6E to 0x70 RBHECC2 to RBHECC0

Receive Port B HEC Count register has the address of 0x6E to 0x70 RBHECC2 to RBHECC0 and is illustrated in FIG. 68.

Type: Read only/Clear on Read

Software Lock: No

Reset Value: 0x00

The RBHECC2, RBHECC1 and RBHECC0 registers contain the Port B received errors HEC count.

RBHECC2-RBHECC0: This register must be read in the order of most significant byte RBHECC2 first and least significant byte RBHECC0 or the value read will not be valid. This counter will not roll-over from 0xFFFFFF to 0x000000 but will stick at 0xFFFFFF.

Receive Port B HEC Threshold—0x71 to 0x73 RBHECT2 to RBHECT0

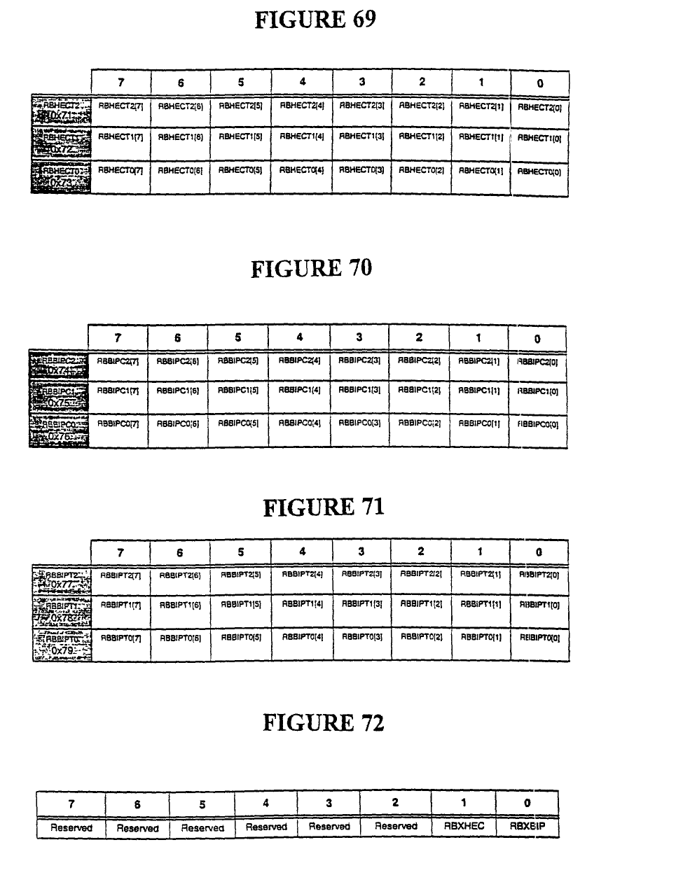

Receive Port B HEC Threshold register has the address of 0x71 to 0x73 RBHECT2 to RBHECT0 and is illustrated in FIG. 69.

Type: Read/Write

Software Lock: No

Reset Value: 0xFF

The RBHECT2, RBHECT1 and RBHECT0 registers contain the Port B received errors HEC threshold. When the error count RBHECC exceeds the threshold RBHECT the RBXHEC alarm will bet set.

RBHECT2-RBHECT0: Most significant byte RBHECT2 and least significant byte RBHECT0.

Receive Port B BIP Count—0x74 to 0x76 RBBIPC2 to RBBIPC0

Receive Port B BIP Count register has the address of 0x74 to 0x76 RBBIPC2 to RBBIPC0 and is illustrated in FIG. 70.

Type: Read only/Clear on Read

Software Lock: No

Reset Value: 0x00

The RBBIPC2, RBBIPC 1 and RBBIPC0 registers contain the Port B received errors BIP count.

RBBIPC2-RBBIPC0: This register must be read in the order of most significant byte RBBIPC2 first and least significant byte RBBIPC0 or the value read will not be valid. This counter will not roll-over from 0xFFFFFF to 0x000000 but will stick at 0xFFFFFF.

Receive Port B BIP Threshold—of 0x77 to 0x79 RBBIPT2 to RBBIPT0

Receive Port B BIP Threshold register has the address of 0x77 to 0x79 RBBIPT2 to RBBIPT0 to and is illustrated in FIG. 71.

Type: Read/Write

Software Lock: No

Reset Value: 0xFF

The RBBIPT2, RBBIPT1 and RBBIPT0 registers contain the Port B received errors BIP threshold. When the error count RBBIPC exceeds the threshold RBBIPT the RBXBIP alarm will bet set.

RBBIPT2-RBBIPT0: Most significant byte RBBIPT2 and least significant byte RBBIPT0.

Receive Port B Performance Alarms—0x7A RBPA

Receive Port B Performance Alarms register has the address of 0x7A RBPAL and is illustrated in FIG. 72.

Type: Read only/Clear on Read

Software Lock: No

Reset Value: 0x00

The Receive Port B Performance Alarms register contains information error performance of Port B. When set RBXHEC and RBXBIP will raise an interrupt if the corresponding interrupt enable bits are set.

RBXHEC: Receive Port B, Excessive HEC Errors. Set=Number of HEC errors counted in RBHECC exceeds threshold set in RBHECT.

RBXBIP: Receive Port B, Excessive BIP Errors. Set=Number of BIP errors counted in RBBIPC exceeds threshold set in RBBIPT.

Receive Port B Performance Interrupt Enables—0x7B RBPIE

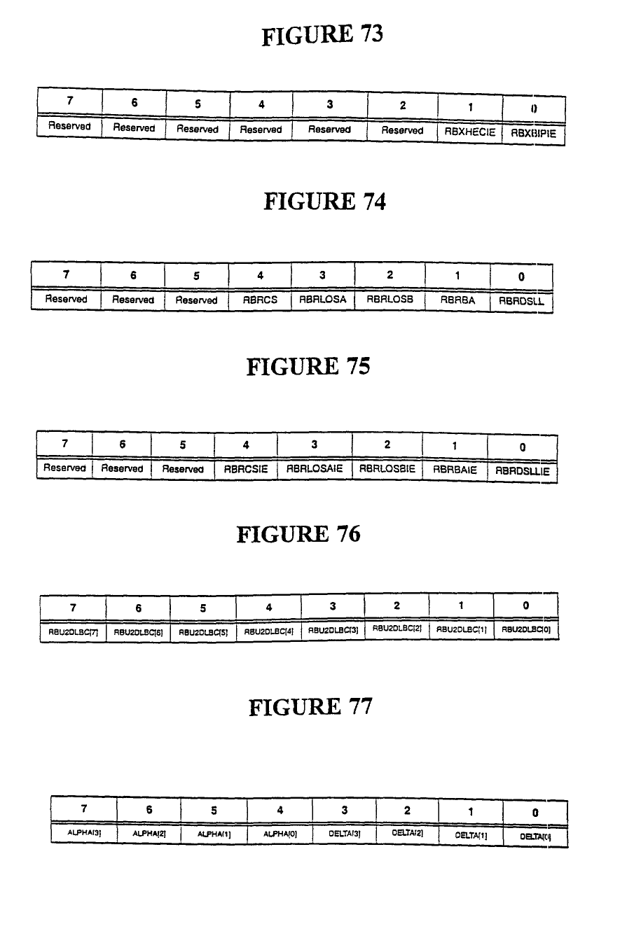

Receive Port B Performance Interrupt Enables register has the address of 0x7B RBPIE and is illustrated in FIG. 73.

Type: Read/Write

Software Lock: No

Reset Value: 0x00

This register contains the interrupt enables for the alarms in the RBPA register. Set interrupt enabled and Clear=interrupt disabled.

Receive Port B Remote Status and Alarms—0x7C RBRA

Receive Port B Remote Status and Alarms register has the address of 0x00 RBRA and is illustrated in FIG. 74.

Type: Read only

Software Lock: No

Reset Value: 0x0D

The Receive Port B Remote Alarms register contains information on the status of the far-end device which is connected to Port B. On a local Loss of Signal on Port B, LLOSB alarm, these bits return to the reset value. When set the RBRLOSA, RBRLOSB and RBRDSLL bits will raise an interrupt if the corresponding interrupt enable is set. A change in value on RBRBA will raise an interrupt if the corresponding interrupt enable is set. Also a change in value on RBRLOSA, RBRLOSB, RBRDSLL and RBRBA will set the RBRCS bit. When set the RBRCS bit will raise an interrupt if the corresponding interrupt enable is set.

RBRCS: Receive Port B, Remote Change of Status at far end device LVDS receive Ports.

RBRLOSA: Receive Port B, Remote Loss Of Signal at far end device LVDS receive Port A.

RBRLOSB: Receive Port B, Remote Loss Of Signal at far end device LVDS receive Port B.

RBRBA: Receive Port B, Remote far end device active receive Port. Set=Port B active and Clear-Port A active.

RBRDSLL: Receive Port B, Remote far end device active receive port Descrambler Loss of Lock. Set=Out of Lock and Clear=Lock.

Receive Port B Remote Interrupt Enables—0x7D RBRIE—Receive Port B Remote Interrupt Enables register has the address of 0x7D RBRIE and is illustrated in FIG. 75.

Type: Read/Write

Software Lock: No

Reset Value: 0x00

This register contains the interrupt enables for the alarms in the RBRA register. Set=interrupt enabled and Clear=interrupt disabled.

Receive Port B Up2Down Loopback Cell count—0x7E RBU2DLBC

Receive Port B Up2Down Loopback Cell count Register has the address of 0x7E RBU2DLBC and is illustrated at FIG. 76.

Type: Read only/Clear on Read

Software Lock: No

Reset Value: 0x00

The Receive Port B Up2Down Loopback Cell Count register counts the number of incoming loopback cells detected from the Port B LVDS interface when Up2Down Loopback is enabled with the U2DLB bit of the ALBC register.

RBU2DLBC[7:0] Port B Up2Down Loopback Cell Count value. This register will not roll-over from 0x00 to 0xFF but will stick at 0xFF.

Receive Port B Cell Delineation Thresholds—0x80 RBCDT

Receive Port B Cell Delineation Thresholds Register has the address of 0x08 RBCDT and is illustrated in FIG. 77.

Type: Read/Write

Software Lock: Yes

Reset Value: 0x78

The receive Port B Cell Delineation Thresholds register controls the operation of the Port B cell delineation state machine. The cell delineation lock status is reflected in the RBLTCLL bit of the RBLA register.

ALPHA[3:0] When in lock this is the number of consecutive incorrect cell HEC's required to lose cell delineation lock.

DELTA[3:0] When out of lock this is the number of consecutive correct cell HEC's required to gain cell delineation lock.

Receive Port B Frame Delineation Thresholds—0x81 RBFDT

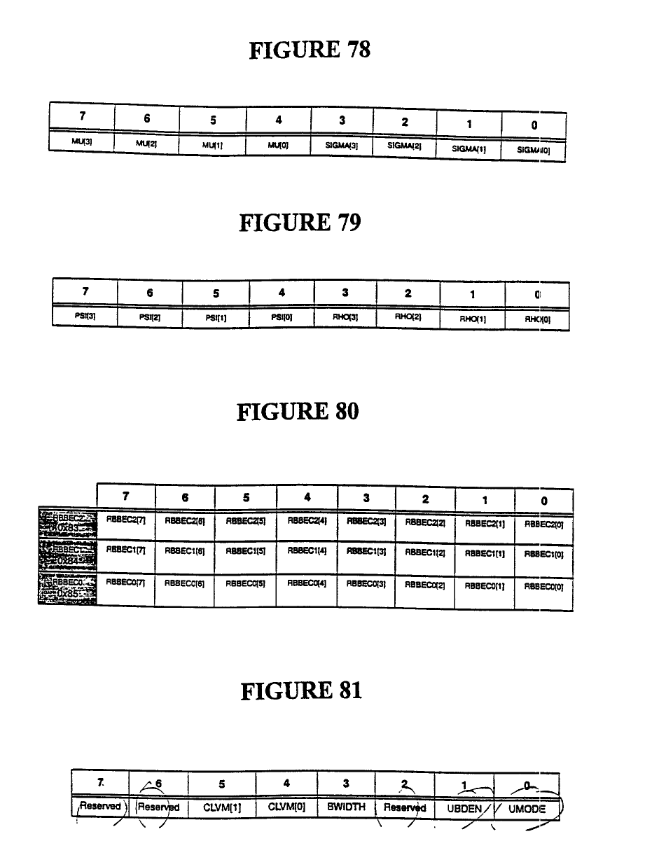

Receive Port B Frame Delineation Thresholds Register has the address of 0x81 RBFDT and is illustrated in FIG. 78.

Type: Read/Write

Software Lock: Yes

Reset Value: 0x78

The Receive Port B Frame Delineation Thresholds register controls the operation of the Port B fram delineation state machine. The frame delineation lock status is reflected in the RBLFLL bit of the RBLA register.

MU[3:0] When in lock this is the number of consecutive incorrect frame HEC's required to lose frame delineation lock.

SIGMA[3:0] When out of lock this is the number of consecutive correct frame HEC's required to gain frame delineation lock.

Receive Port B Descrambler Lock Thresholds—0x82 RBDSLKT

Receive Port B Descrambler Lock Thresholds Register has the address of 0x82 RBDSLKT and is illustrated in FIG. 79.

Type: Read/Write

Software Lock: Yes

Reset Value: 0x88

The Receive Port B Descrambler Lock Thresholds register controls the operation of the Port B descrambler lock state machine confidence counter. The descrambler lock status is reflected in the RBLDSLL bit of the RBLA register.

PSI[3:0] When in lock this is the threshold that the descrambler confidence counter must reach to lose descrambler lock. When in lock the descrambler confidence counter increments on incorrect HEC predictions and decrements on good HEC predictions.

RHO[3:0] When out of lock this is the threshold that the descrambler confidence counter must reach to gain descrambler lock. When out of lock the descrambler confidence counter decrements on incorrect HEC predictions and increments on good HEC predictions.

Receive Port B Bit Error Count—0x83 to 0x85 RBBEC2 to RBBEC0

Receive Port B Bit Error Count Register has the address of 0x83 to 0x85 RBBEC2 to RBBEC0 and is illustrated in FIG. 80.

Type: Read only/Clear on Read

Software Lock: No

Reset Value: 0x00

The RBBEC2, RBBEC1 and RBBEC0 registers contain the Port B received bit error count whenever the RBBEC bit of the RBCTL register is set. If the RBBEC bit of the RBCTL register is clear, these registers are cleared.

RBBEC2-RBBEC0 This register must be read in the order of most significant byte RBBEC2 first and least significant byte RBBEC0 last, or the value read will not be valid. This counter will not roll-over from 0xFFFFFF to 0x000000 but will stick at 0xFFFFFF.

UTOPIA Configuration—0xA0 UCFG

UTOPIA Configuration register has the address of 0x0A UCFG and is illustrated in FIG. 81.

Type: Read/Write

Software Lock: Yes

Reset Value: 0x00

The UTOPIA Configuration register defines the UTOPIA interface operating modes.

CLVM[1:0]: CLAV Mode bits. 11=Up to 31 ports using CLAV0, 01 or 10=Up to 31 ports using CLAV0 to CLAV3, 00=Up to 248 ports using CLAV0 to CLAV7.

BWIDTH: UTOPIA data bus width. Set=8-bit data bus and Clear=16-bit mode.

UBDEN UTOPIA Bidirectional pins enable. Set=the UTOPIA bidirectional pins take on the functionality as defined by the UMODE setting. Clear=Att UTOPIA interface bidirectional pins are tri-stated. This is to avoid pin contention at the UTOPIA pins on reset.

UMODE: UTOPIA ATM or PHY mode. Set=PHY Layer 14 interface and Clear=ATM Layer 12 Interface.

UTOPIA Connected Port List—0xA1 to 0xA4 UCPL3 to UCPL0

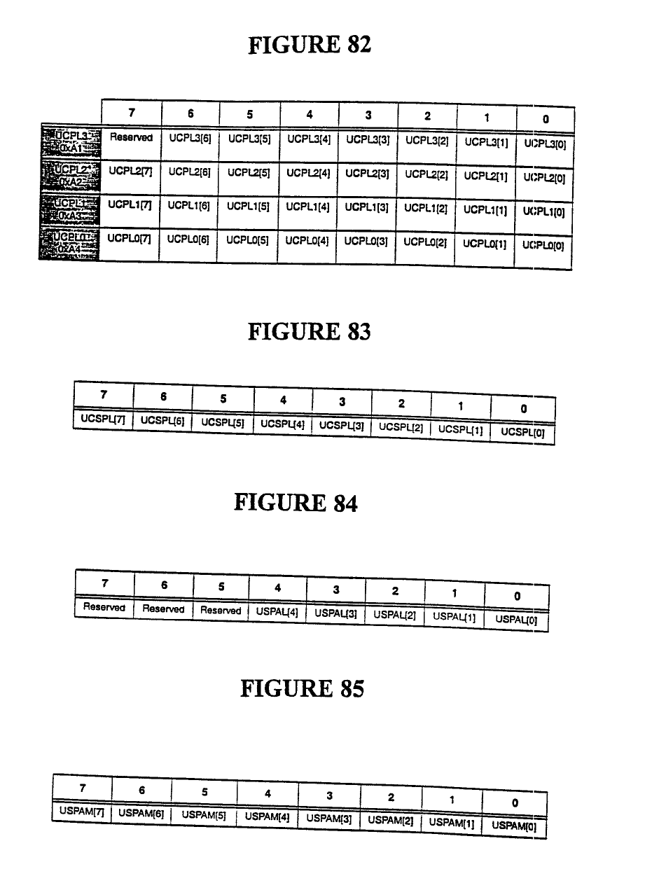

UTOPIA Connected Port List register has the address of 0xA1 to 0xA4 UCPL3 to UCPL0 and is illustrated in FIG. 82.

Type: Read/Write

Software Lock: Yes

Reset Value: 0xFF

The UCPL3, UCPL2, UCPL1 and UCPL0 registers define the connected UTOPIA ports for polling. The sub-ports present for the connected ports is defined in the UCSPL register.

UCPL3-UCPL0 UCPL3 [6]: corresponds to port 31 and UCPL0[0] corresponds to port 0. When a bit is set then the port is connected and will be polled, when clear the port is not connected and will not be polled.

UTOPIA Connected Sub-Port List—0xA6 UCSPL

UTOPIA Connected Sub-Port List register has the address of 0xA6 UCSPL and is illustrated in FIG. 83.

Type: Read/Write

Software Lock: Yes

Reset Value: 0x01

The UCSPL register defines the connected UTOPIA sub-ports within all ports for polling.

UCSPL UCSPL[7]: corresponds to sub-port 7 and UCSPL[0] corresponds to sub-port 0. When a bit is set then the sub-port is connected and will be polled, when clear the sub-port is not connected and will not be polled.

UTOPIA Sub-Port Address Location—0xA7 USPAL

UTOPIA Sub-Port Address Location register has the address of 0xA7 USPAL and is illustrated in FIG. 84.

Type: Read/Write

Software Lock: Yes

Reset Value: 0x00

The UTOPIA Sub-Port Address Location register defines the which byte of the PDU header the sub-port address is contained in when using Extended UTOPIA mode. The PDU header consists of the User Prepend, the ATM cell header and UDF bytes, and so can be a maximum of 18 bytes. The first of these bytes is denoted as byte 0. The corresponding USPAM register is used to define which bits in the byte contain the sub-port address.

USPAL[4:0]: Byte number of the PDU header byte which contains the UTOPIA sub-port address.

UTOPIA Sub-Port Address Mask—0xA8 USPAM

UTOPIA Sub-Port Address Mask register has the address of 0xA8 USPAM and is illustrated in FIG. 85.

Type: Read/Write

Software Lock: Yes

Reset Value: 0x07

The UTOPIA Sub-Port Address Mask register defines which bits of the PDU header byte defined by the USPAL register contain the sub-port address.

USPAM[7:0]: Set=This bit location contains valid sup-port address bit. Clear Ignore this bit location.

Note that only 3 bit locations must be set in this register to give the 3 bit sub-port address location. All others bits must be clear. By default, bits USPAM [2:0] are set, indicating that the sub-port address is located in bits [2:0] of the PDU header byte indicated by the USPAL register, with the MSB in bit [2] and the LSB in bit [0]. If USPAM bits [6], [4] and [1] were set, then the sub-port address would be located in bits [6], [4] and [1] of the PDU header byte indicated by the USPAL register, with the MSB in bit [6] and the LSB in bit [1].

MTB Queue Threshold—0xA9 to 0xC7 MTBQT30 to MTBQT0

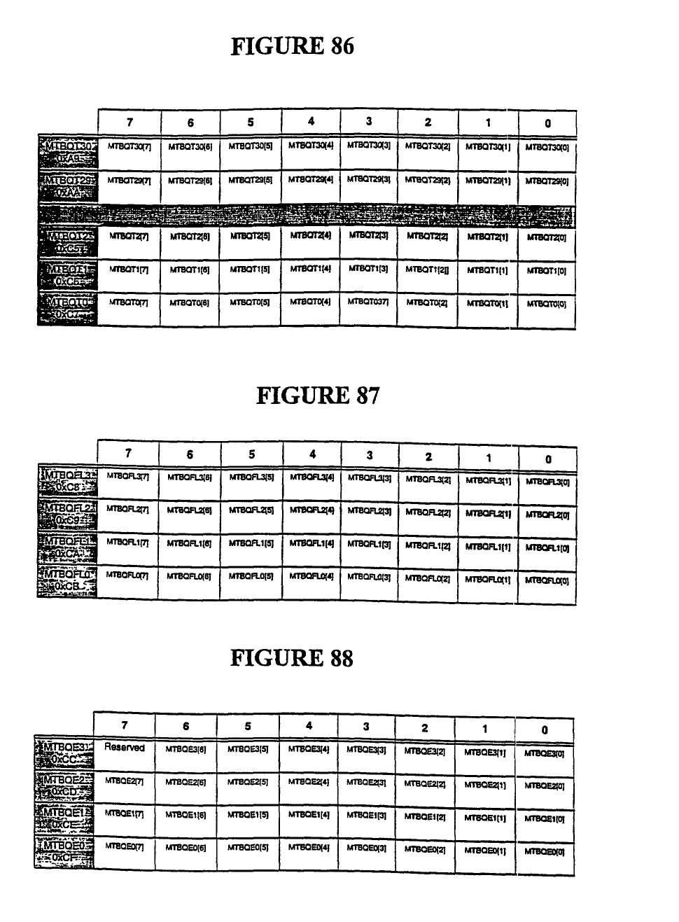

MTB Queue Threshold register has the address of 0xA9 to 0xC7 MTBQT30 to MTBQT0 and is illustrated in FIG. 86.

Type: Read/Write

Software Lock: Yes

Reset Value: 0x04

The MTB Queue Threshold registers define the maximum size in PDU cells of each of the 31 queues. If all 31 queues are being used it is recommended that the threshold be left at the default of 4 cells. If less than 31 queues are in use then the queue threshold may be raised according to the MTB Queue Configuration. Note that when the threshold on a queue is modified the queue should be flushed using the corresponding bit of the MTBQF3-MTBQF0 registers.

MTBQT30[7:0]: Maximum number of PDU cells for queue 30.

MTBQT29[7:0]: Maximum number of PDU cells for queue 29.

MTBQT1 [7:0]: Maximum number of PDU cells for queue 1.

MTBQT0[7:0]: Maximum number of PDU cells for queue 0.

MTB Queue Full—0xC8 to 0xCB MTBQFL3 to MTBQFL0

MTB Queue Full register has the address of 0xC8 to 0xCB MTBQFL3 to MTBQFL0 and is illustrated in FIG. 87.

Type: Read only

Software Lock: No

Reset Value: 0x00

The MTBQFL3, MTBQFL2, MTBQFL1 and MTBQFL0 registers show which queues are full.

MTBQFL3 [7] MTBQFL3 [7] bit indicates that the entire MTB is full. As memory resources are over assigned among the 31 individual queues then the MTB may be full while some of the individual queues may not be full. When this bit is set, then the entire queue is full and when clear, the queue is not full.

MTBQFL3-MTBQFL0: MTBQFL3 [6] corresponds to queue 31 and MTBQFL0[0] corresponds to queue 0. When a bit is set then the queue is full and when clear the queue is not full.

MTB Queue Empty—0xCC to 0xCF MTBQE0 to MTBQE0

MTB Queue Empty register has the address of 0xCC to 0xCF MTBQE0 to MTBQE0 and is illustrated in FIG. 88.

Type: Read only

Software Lock: No

Reset Value: 0xFF

The MTBQE3, MTBQE2, MTBQE1 and MTBQE0 registers show which queues are empty.

MTBQE3-MTBQE0 :MTBQE3[6] corresponds to queue 31 and MTBQE0[0] corresponds to queue 0. When a bit is set then the queue is empty and when clear the queue is not empty.

MTB Queue Flush—0xD0 to 0xD3 MTBQF3 to MTBQF0

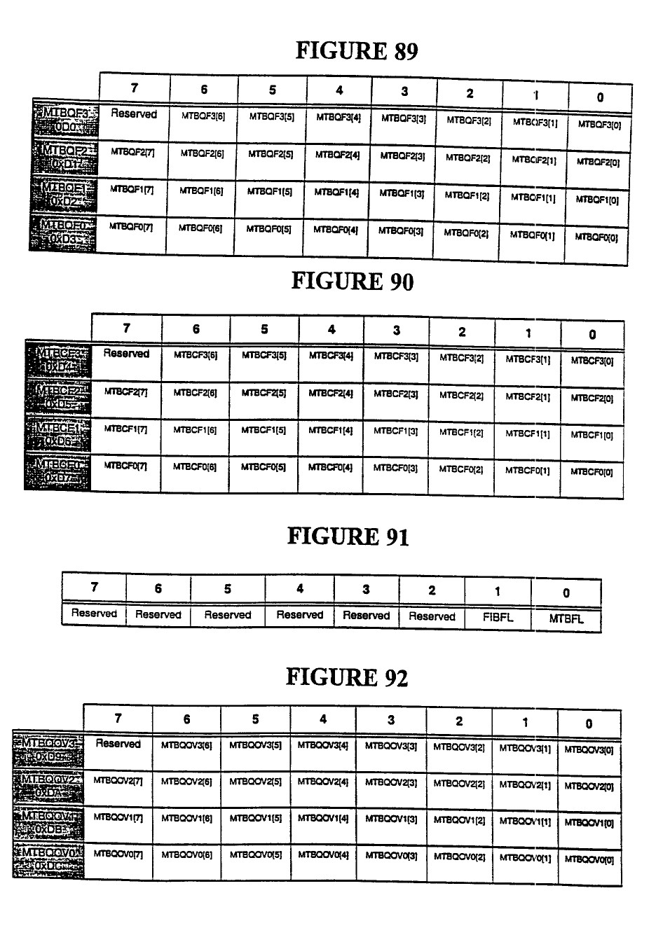

MTB Queue Flush register has the address of 0xDO to 0xCD7 MTBQF3 to MTBQF0 and is illustrated in FIG. 89.

Type: Read/Write

Software Lock: Yes

Reset Value: 0x00

The MTBQF3, MTBQF2, MTBQF 1 and MTBQF0 registers allow each of the queues to be flushed. Flushing a queue removes all PDU cells from the queue. The processor sets the appropriate bit in the MTBQF register to flush a queue. When this has been completed the hardware will clear the bit. So after setting a bit to flush a queue the processor should poll the MTBQF register to determine when the flushing has been completed.

MTBQF3-MTBQF0: MTBQF3[6] corresponds to queue 31 and MTBQF0[0] corresponds to queue 0. When a bit is set then a flush of the corresponding queue is initiated and when clear the queue flush is completed and the queue is now in normal operation.

MTB Cell Flush—0xD4 to 0xD7 MTBCF3 to MTBCF0

MTB Cell Flush register has the address of 0xD4 to 0xD7 MTBCF3 to MTBCF0 and is illustrated in FIG. 90.

Type: Read/Write

Software Lock: Yes

Reset Value: 0X00

The MTBCF3, MTBCF2, MTB CF1 and MTBCF0 registers allow the PDU cell at the head of each of the queues to be flushed. This removes the PDU cell from the head of the queue without corrupting the queue. The processor sets the appropriate bit in the MTBCF register to flush a cell from a queue. When this has been completed the hardware will clear the bit. So after setting a bit to reset a cell from a queue the processor should poll the MTBCF register to determine when the flush has been completed.

MTBCF3-MTBCF0: MTBCF3 [6] corresponds to queue 31 and MTBCF0[0] corresponds to queue 0. When a bit is set then a flush of the PDU cell at the head of the queue is initiated and when clear the cell flush is completed and the queue is now in normal operation.

Queue Flush—0xD8 QFL

Queue Flush register has the address of 0xD8 QFL and is illustrated in FIG. 91.

Type: Read/Write

Software Lock: Yes

Reset Value: 0x00

The Queue Flush register allows both the MTB and the FIB queues to be completely flushed. This removes all PDU cells from the targeted queue. The processor sets the appropriate bit in the QFL register to flush a queue. When this has been completed the hardware will clear the bit. So after setting a bit to reset a queue the processor should poll the QFL register to determine when the flush has been completed

FIBFL: When set then a flush of the FIB queue is initiated and when clear the FIB queue flush is completed and the queue is now in normal operation.

MTBFL: When set then a flush of the MTB queue is initiated and when clear the MTB queue flush is completed and the queue is now in normal operation.

MTB Queue Overflow—0xD9 to 0xDC MTBQOV3 to MTBQOV0

MTB Queue Overflow Register has the address of 0xD9 to 0xDC MTBQOV3 to MTBQOV0 and is illustrated in FIG. 92.

Type: Read only/Clear on Read

Software Lock: No

Reset Value: 0x00

The MTBQOV3, MTBQOV1 and MTBQOV0 registers indicate the overflow status of the thirty one queues in the MTB. If a queue has filled to it's threshold defined in the MTBQT31-MTBQT0 registers, and an attempt is made to write another cell to the queue, then the overflow bit for that queue will be set in these registers. This additional cell write will be rejected and the cell discarded automatically. These bits reflect that an attempt has been made to write to an already full queue and may be used as an indication of problems with the Flow Control mechanism. As the attempted write is rejected the queue will not fill beyond its threshold. A subsequent read of a cell from the specific queue out over the UTOPIA interface will be successful, but will not clear the overflow bit in this register. The overflow bits in these registers will only be cleared by a processor read. If any of the bits in these MTBQOV3-MTBQOV0 registers is set then the MTBSOVA bit of the UAA register will be set any may raise an interrupt.

MTBQOV3-MTBQOV0 MTBQOV3[6] corresponds to queue 31 and MTBQOV0[0] corresponds to queue 0. When a bit is set, then the corresponding queue has attempted to overflow.

ATM Down2Up Loopback Cell Count—0xE0 D2ULBCC

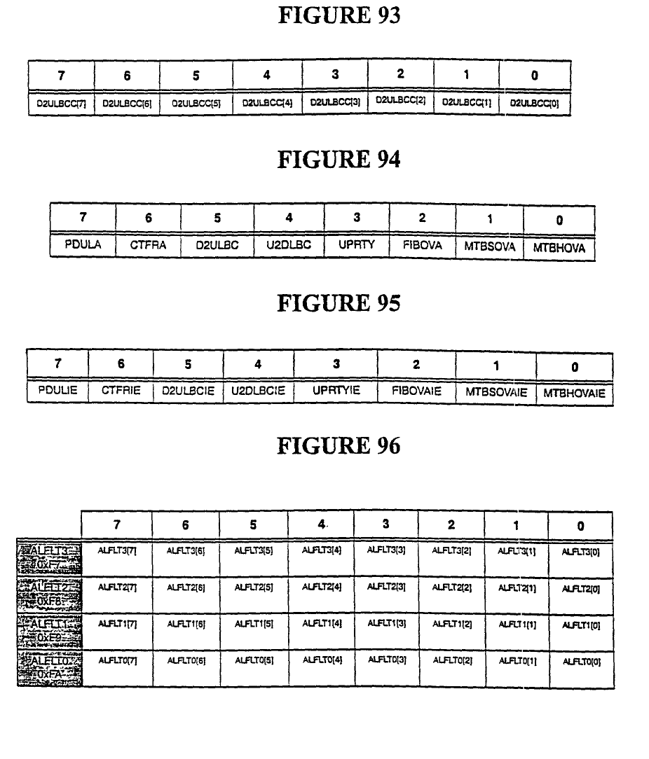

ATM Down2Up Loopback Cell Count register has the address of 0xE0 D2ULBCC and is illustrates in FIG. 93.

Type: Read only/Clear on Read

Software Lock: No

Reset Value: 0x00

The ATM Down2Up Loopback Cell Count register counts the number of incoming loopback cells detected from the UTOPIA interface when Down2Up loopback is enabled with the D2ULB bit of the ALBC register, as illustrated in FIG. 40.

D2ULBCC [7:0]: Down2Up Loopback Cell Count value. This register will not roll-over from 0x00 to 0xFF but will stick at 0xFF.

UTOPIA and ATM Alarms—0xE1 UAA

UTOPIA and ATM Alarms Register has the address of 0xE1 UAA and is illustrated in FIG. 94.

Type: Read only/Clear on Read

Software Lock: No

Reset Value: 0x00

The UTOPIA and ATM Alarms register monitors the UTOPIA interface, loopbacks, and queue overflows. When set these bits will raise an interrupt if the corresponding interrupt enables are set.

PDULA PDU Length Alarm bit. Set=PDU length as defined by the PDUCFG register is greater than the maximum PDU cell length of 64 bytes. Clear=PDU length is less than or equal to maximum of 64 bytes.

CTFRA Cell Transfer Alarm bit. This alarm is only valid when the devise is configured as a PHY Layer 14 by setting the UMODE bit of the UCFG register.

It indicates that the controlling ATM Layer 12 device has caused an incorrect cell transfer to or from the UTOPIA Bridge as described. Set=incorrect cell transfer has occurred on the UTOPIA transmit or receive interface.

D2ULBC Set D2ULBCC count register has changed value.

U2DLBC Set=U2DLBCC count register have changed value.

UPRTY Set=A parity error has occurred on an incoming ATM cell byte.

FIBOVA Set=FIB queue has overflowed. Clear=FIB queue not overflowed.

MTBSOVA Set=MTB Soft Overflow Alarm bit. Set=One or more of the bits in the MTBQOV1-MTBQOV0 registers are set. Clear=The MTBQOV3-MTBQOV0 registers are clear.

MTBHOVA MTB Hard Overflow Alarm bit. Set=MTB queue has attempted to overflow. This is a hard overflow as the overall MTB has attempted to fill beyond it's hard limit.

UTOPIA and ATM Interrupt Enables—0xE2 UAIE

UTOPIA and ATM Interrupt Enables Register has the address of 0xE2 UAIE and is illustrated in FIG. 95.

Type: Read/Write

Software Lock: No

Reset Value: 0x00

This register contains the interrupt enables for the alarms in the UAA register. Set=interrupt enabled and Clear=interrupt disabled.

ATM Loopback Cell Filter—0xF7 to 0xFA ALFLT3 to ALFLT0

ATM Loopback Cell Filter Register has the address of 0xF7 to 0xFA ALFLT3 to ALFLT0 and is illustrated in FIG. 96.

Type Read/Write

Software Lock: No

Reset Value: 0xFF

The ALBCF3, ALBCF2, ALBCF1 and ALBCF0 registers define the cell header bytes filter for detecting ATM loopback cells. Incoming ATM cells are compared against the loopback cell header format defined in the ALBCF3-ALBCF0 registers to determine if they are loopback cells. The filter defined in the ALFLT3-ALFLT0 registers is used to determine which bits of the four byte cell header are compared. If a bit is set then that bit in the incoming cell header is compared against the corresponding bit in the ALBCF3-ALBCF0 registers. Only those bits which are set in the ALFLT3-ALFLT0 registers are compared to determine if a cell is a loopback cell.

UTOPIA Interface Operation

This section describes the operation of the UTOPIA Interface of the UTOPIA-LVDS Bridge 100. The UTOPIA interface mode of operation is defined in the UTOPIA Configuration (UCFG) register of FIG. 81. The format of the PDU cells carried over this interface is defined in the PDU Configuration (PDUCFG) register as shown in FIG. 27.

The interface can operate in ATM Layer 12 mode or PHY Layer 14 mode. When operating as a Level 2 ATM Layer 12 interface, the protocol can be extended to cope with up to 248 PHY ports rather than the maximum 31 allowed by the standard Level 2 definition. This is achieved with eight CLAV and eight ENB signals.

On power up the device defaults to ATM Layer 12 mode. To prevent potential contention on the UTOPIA interface signals, all the UTOPIA pins which are bidirectional are configured as outputs in tri-state mode and the UTOPIA interface block is disabled. The user must select the device operating mode, ATM Layer 12 or PHY Layer 14, by writing the appropriate value to the UMODE bit of the UCGF register before enabling the UTOPIA interface block and releasing the UTOPIA interface pins. Enabling the UTOPIA interface and releasing the UTOPIA pins is achieved by setting the UBDEN bit of the UCFG register.

UTOPIA Basic Level 2 Mode—31 Ports (default mode)

In UTOPIA Level 2 mode:

8-bit or 16-bit data buses are used so only U_TxData [7:0] and U_RxData [7:0] are valid. Parity is calculated and checked only over these bits of the data buses.

The upper bits of the data buses are not used.

One ATM Layer 12 communicates with one PHY Layer 14 using U_TxCLAV[0], U_RxCLAV[0], U_TxENB[0] and U_RxENB[0].

U_TxCLAV[7:1], U_RxCLAV[7:1], U_TxENB[7:1], U_RxENB[7:1], U_TxAddr[4:0] and U_RxAddr[4:0] are not used.

Only Queues from 30 to 0 of the MTB may be used.

The connected ports lists defined by the UCPL3-UCPL0 registers are used. In ATM mode these registers are used to determine which ports should be polled.

In PHY mode these registers are used to determine which MPhy addresses the device should respond to during polling.

The sub-port address location defined by UCSPL register is not used.

The CLAV mode bits CLVM[1:0] of the UCFG register should be defined as CLVM [1:0]=00 are not used.

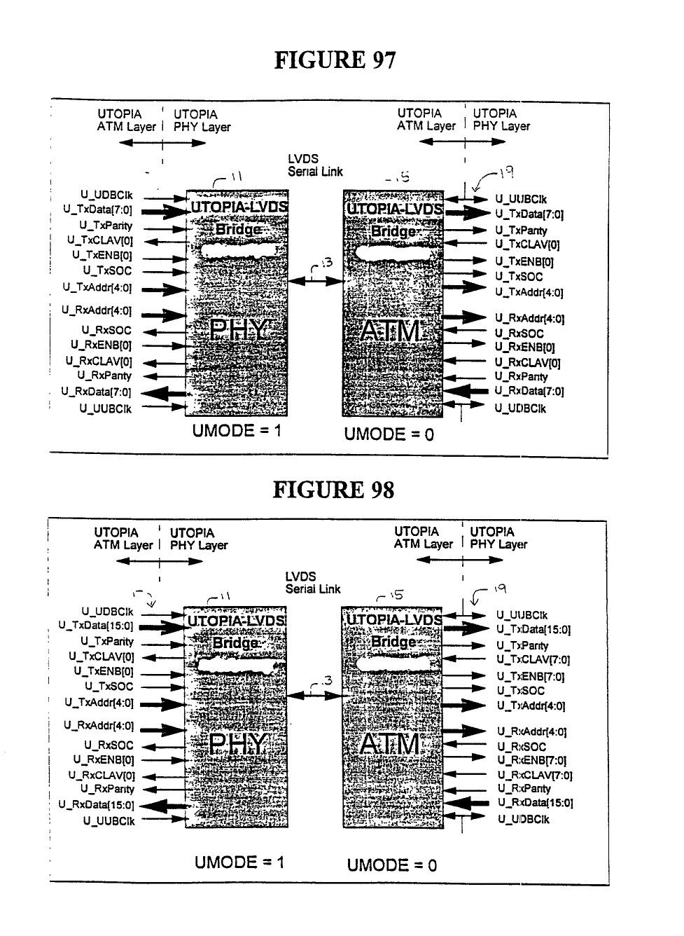

The configuration of the inputs/outputs of the UTOPIA Level 2 interface for ATM Layer 12 mode and PHY Layer 14 mode is illustrated in FIG. 97. The main difference is that in ATM mode the CLAV pins are inputs and the ENB pins are outputs, whereas in PHY mode the CLAV pins are outputs and the ENB pins are inputs.

Note that in ATM Layer 12 mode the UTOPIA-LVDS Bridge 100 does not generate the UTOPIA clocks but must be supplied with these clocks just as in PHY mode.

ATM Polling

When configured as an ATM Layer 12 device the UTOPIA-LVDS Bridge 100 polls the connected PHY ports using the MPhy address busses U_TxAddr and U_RxAddr. Only those ports which are connected will be polled. The connected ports list defined in the UCPL3-UCPL0 registers is used to determine which ports are connected. The PHY ports respond only on U_TxCLAV[0] and U_RxCLAV[0]. On reset the UCPL3-UCPL0 registers (FIG. 67) are all set to 0xFF so the UTOPIA-LVDS Bridge 100 will poll all ports.

PHY Polling

When configured as a PHY Layer 14 device the UTOPIA-LVDS Bridge 100 is polled by the connected ATM device. During polling the UTOPIA-LVDS Bridge 100 will only respond to MPhy addresses, on U_TxAddr and U_RxAddr, which are defined as connected. The connected ports list defined in the UCPL3-UCPL0 registers are used to determine which ports are connected. On reset the UCPL3-UCPL0 registers are all set to 0xFF so the UTOPIALVDS Bridge 100 will respond to all MPhy addresses during polling. The UTOPIA-LVDS Bridge 100 responds only on U_TxCLAV[0] and U_RxCLAV[0].

UTOPIA Extended Level 2 Mode—248 Ports

UTOPIA Extended Level 2 Mode—248 Ports is shown in FIG. 98.

In UTOPIA Extended Level 2 mode:

8-bit or 16-bit data buses may used controlled by the BWIDTH bit of the UCFG register. In 8-bit mode only U_TxData[7:0] and U_RxData[7:0] are valid, parity is calculated and checked only over these bits of the data buses and the upper bits of the data buses are not used. In 16-bit mode the full U_TxData[15:0] and U_RxData[15:0] are valid and parity is calculated and checked over all bits of the data buses.

In ATM mode the UTOPIA-LVDS Bridge 100 can communicate with up to 248 PHY ports using the MPhy address busses U_TxAddr[4:0] and U_RxAddr[4:0], and the control signals U_TxCLAV[7:0], U-RxCLAV[7:0], U_TxENB[7:0] and U_RxENB[7:0]. In PHY mode the UTOPIA-LVDS Bridge 100 behaves as a standard Level 2 device and only 31 ports are needed using the MPhy address busses U_TxAddr[4:0] and U_RxAddr[4:0], and the control signals U_TxCLAV[0], U_RxCLAV[0], U_TxENB[0] and U_RxENB[0].

All Queues from 30 to 0 of the MTB may be used. There is one queue for each MPhy address so the use of the queues will depend on the connected ports list defined by the UCPL3-UCPL0 registers.

The connected ports list defined by the UCPL3-UCPL0 registers and the connected sub-port list defined in the UCSPL register are used. In ATM mode these registers are used to determine which ports should be polled. In PHY mode these registers are used to determine which MPhy addresses the device should respond to during polling.

The sub-port address location defined by USPAL and USPAM registers is used in ATM mode to determine the location of the 3-bit sub-port address in the PDU cell. In PHY mode these registers are not used.

The CLAV mode bits CLVM[1:0] of the UCFG register should be defined as CLVM[1:0]=00.

The configuration of the inputs/outputs of the UTOPIA Level 2 interface for ATM Layer 12 mode and PHY Layer 14 mode is illustrated in FIG. 98.

The main difference is that in ATM mode the CLAV pins are inputs and the MPhy Address and ENB pins are outputs, whereas in PHY mode the CLAV pins are outputs and the MPhy Address and ENB pins are inputs. Also, in ATM mode all 8 CLAV and ENB pins are used, but in PHY mode only 1 of the CLAV and ENB pins are used.

Note that in ATM Layer 12 mode the UTOPIA-LVDS Bridge 100 does not generate the UTOPIA clocks but must be supplied with these clocks just as in PHY mode.

ATM Polling When configured as an ATM Layer 12 device the UTOPIA-LVDS Bridge 100 polls the connected PHY ports using the MPhy address busses U_TxAddr and U_RxAddr. Only those ports which are connected will be polled. The connected ports list defined in the UCPL3-UCPL0 registers is used to determine which ports are connected. The PHY ports respond on U_TxCLAV[7:0] and U_RxCLAV[7:0]. The MPhy address determines the Port and the CLAV number determines the Sub-port. Therefore up to 8 sub-ports may be connected to a port. Polling of a single MPhy address will get 8 responses on the 8 CLAV lines. TheUTOPIA-LVDS Bridge 100 uses the connected support list defined in the UCSPL register to determine which of these 8 sub-port responses are valid. On reset the UCPL3-UCPL0 and UCSPL registers are all set to 0xFF so the UTOPIA-LVDS Bridge 100 will poll all ports and assume all sub-ports are connected.

PHY Polling

When configured as a PHY Layer 14 device the UTOPIA-LVDS Bridge 100 is polled by the connected ATM device. During polling the UTOPIA-LVDS Bridge 100 will only respond to MPhy addresses, on U_TxAddr and U_RxAddr, which are defined as connected. The connected ports list defined in the UCPL3-UCPL0 registers is used to determine which ports are connected. On reset the UCPL3-UCPL0 registers are all set to 0xFF so the UTOPIA-LVDS Bridge 100 will respond to all MPhy addresses during polling.

Sub-Port Address

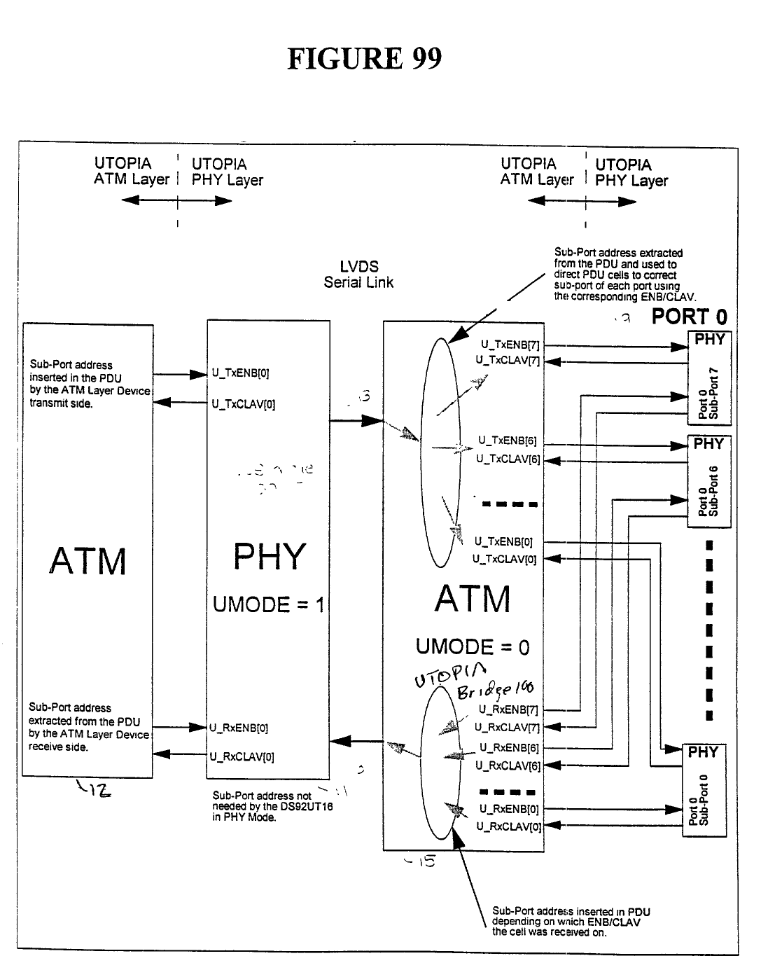

The operation of the sub-port address is illustrated in FIG. 99. To make use of the Extended Level 2 mode allowing up to 248 Ports to be addressed the ATM Layer 12 must be capable of inserting a three bit sub-port address in the PDU cell for use by the UTOPIA-LVDS Bridge 100. This 3-bit sub-port address must reside in the User Prepend, Cell Header or UDF bytes. It's location is defined in the UTOPIA Sub-Port Address Location (USPAL) and UTOPIA Sub-Port Address Mask (USPAM) registers. The USPAL register defines which byte of the User Prepend, Cell Header or UDF contains the address and the USPAM register defines which 3 bits of that byte are to be used as the sub-port address.

Transmit Path

The MPhy address is interpreted as the Port address. So a cell destined for the PHY designated as Port 0 Sub-Port 7 has the 3 bit sub-port address 7 (binary “111”) inserted into the PDU cell at the defined sub-port address location by the ATM Layer 12 at the head-end. It is then transmitted to the UTOPIA-LVDS Bridge 100 in PHY mode using MPhy address 0. The UTOPIA-LVDS Bridge 100 in PHY mode does not examine the sub port address as all cells are transmitted down-bridge anyway.

At the far end the UTOPIA-LVDS Bridge 100 when set in ATM mode extracts the sub-port address. This is used to determine which sub-port CLAV/ENB signals the destination PHY is connected to. A port address of 0 and a sub-port address of 7 means that the destination PHY is MPhy address 0 attached to U_TxENB[7] and U_TxCLAV[7]. The cell is then transmitted to that PHY.

Receive Path

A cell received by UTOPIA-LVDS Bridge 100 in ATM mode from the PHY with MPhy address 0 attached to U_RxENB[6] and U_RxCLAV[6] is designated as from Port 0 Sub-Port 6. The sub-port address 6 (binary “110”) is inserted into the sub-port address location of the received PDU and this is transmitted to the head-end. The head-end ATM Layer 12 device can then extract this sub-port address from the PDU to determine the full address of the originating PHY.

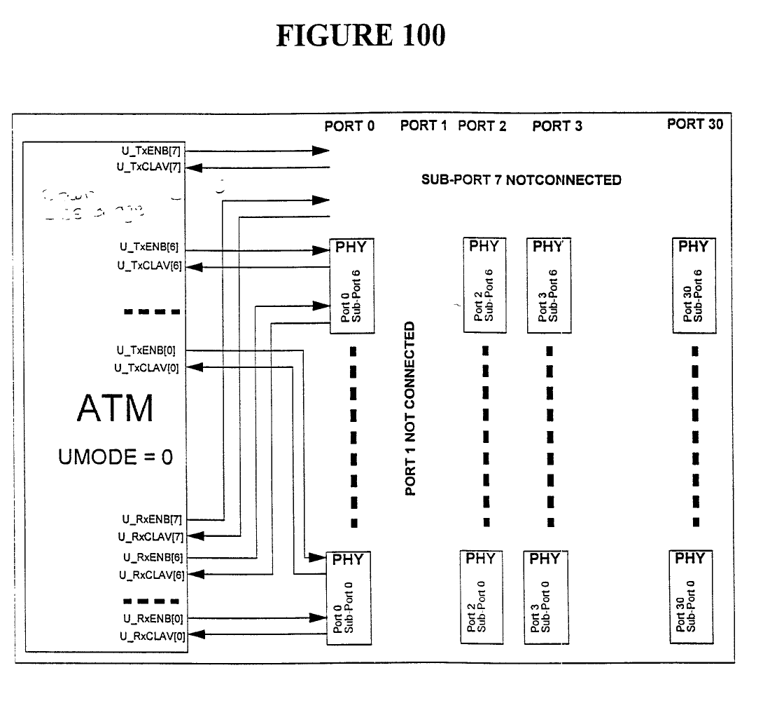

Connect Port and Sub-Port Lists FIG. 100 illustrates the usage of the connected port list (UCPL3-UCPL0) registers and the connected sub-port list register UCSPL. In this case, the UTOPIA-LVDS Bridge 100 is in ATM mode and Port 1 and Sub-port 7 and defined as not connected.

The UCPL3-UCPL0 registers contain 31 bits corresponding to the 31 possible Ports addressed by the MPhy address busses. If a bit location in the UCPL3-UCPL0 registers is set then that Port is connected. The sub-ports of that port which are connected is defined by the UCSPL register. If a bit location in the UCSPL register is set then that sub-port is connected.

In FIG. 100 the registers are set as follows: UCPL3=UCPL2=UCPL1=0xFF,

UCPL0=0xFD and UCSPL=0xEF

With bit 1 of UCPL0 cleared then Port 1 is not connected. This means that none of the 8 sub-ports of Port 1 is connected. So Port 1 Sub-port 7, Port1 Sub-port 6, Port1 Sub-port 5, Port1 Sub-port 4, Port1 Sub-port 3, Port1 Sub-port 2, Port1 Sub-port 1, Port1 Sub-port 0 are all not connected. Port 1 will therefore not be polled.

With bit 7 of UCSPL cleared then sub-port 7 is not connected. This means that subport 7 for all possible 31 ports in not connected. Port 31 Sub-port 7, Port 30 Sub-port 7, Port 29 Sub-port 7 . . . Port 0 Sub-port 7 are all not connected.

Therefore, clearing a bit in the UCPL3-UCPL0 registers will disconnect 8 possible PHY port locations and clearing a bit in the UCSPL register will disconnect 31 possible PHY port locations.

MTB Queue Configuration The Multi-port Traffic Buffer 103 is a 160 cell linked-list buffer that is shared across as many as 31 Port queues. There is a single queue per MPHY address.

In the up-bridge direction, a per queue flow control protocol prevents queue overflow. Each Port has a programmable upper fill threshold. Should any queue reach this upper threshold, back-pressure is applied over the serial link, via the flow control mechanism, to the far end (transmitting) device. The transmitting device uses the normal UTOPIA flow control handshaking to prevent any more cells being transferred to that MPHY and thus prevents overflow.

With link-list buffers, each queue may be over-assigned memory space, working on the assumption that not every queue will back up simultaneously. To accommodate the rare occasions where the buffer as a whole approaches full but individual queues are below their full threshold, the device also compares the overall buffer fill against a threshold. Should the overall buffer approach overflow, the flow control mechanism provides a global ‘halt’ command to ensure that no cells will be lost.

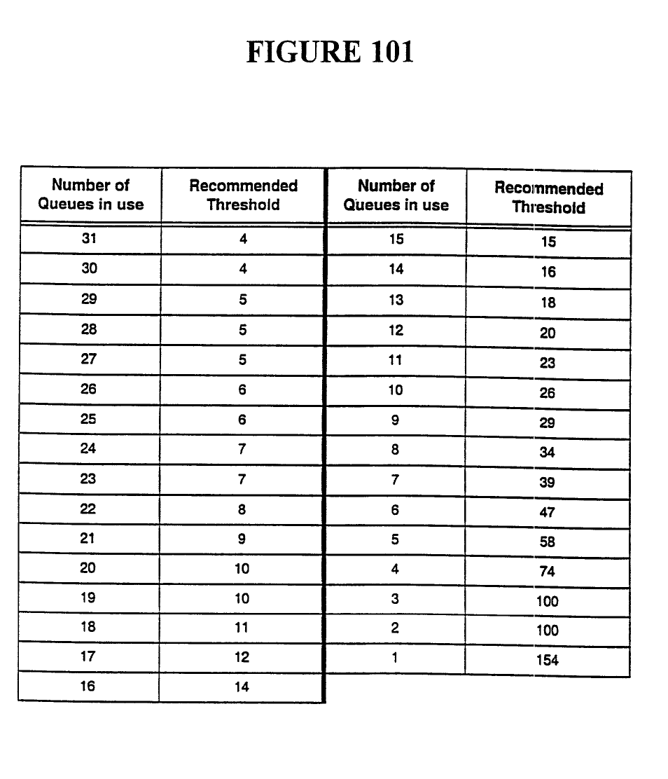

The MTB Queue Threshold, MTBQT30-MTBQT0 registers define the maximum size in PDU cells of each of the 31 queues. If all 31 queues are being used it is recommended that the threshold be left at the default of 4 cells. If less that 31 queues are in use then the queue thresholds may be raised if required. The recommended maximum queue thresholds are given in FIG. 101.

It is further recommended that any queue that is not being used is set with a threshold of 0. When a queue has reached its programmed threshold, then the device flow control mechanism will prevent the far end device from accepting cells for that MPHY address. Therefore, by setting the threshold of an unused a queue to 0, it prevents the UTOPIA interface of the far end deice from accepting cells for that MPHY address by either, not asserting the CLAV for that MPHY address when in PHY Mode, or not selecting that MPHY address when in ATM mode.

Also not that setting a threshold of 0 will cause the corresponding Queue Full bit in the MTBQFL3-MRBQFL0 registers to be continuously set for that queue.

Configuration and Traffic Inhibit Operation

Modifying some device configuration settings should not be carried out while traffic is flowing. A mechanism to inhibit traffic is provided, which should be used when changing any of the settings contained in the PDUCFG, UCFG, USPAL or USPAM registers.

The Traffic Inhibit mechanism causes traffic to stop. The UTOPIA interface will stop transmitting and receiving cells, the LVDS transmit section will transmit Idle cells, and the incoming cells on the active LVDS receive port will be discarded. It is controlled by the Configuration Traffic Inhibit (CT1) and Traffic Inhibit Status (TIS) bits of the General Control and Status (GCS) register.

The processor should set the CT1 bit before changing any of the PDUCFG, UCFG, USPAL or USPAM register settings. This will initiate the Traffic Inhibit mechanism. The TIS bit should then be polled. When the TIS bit is set, then traffic is inhibited and the device can safely be reconfigured. When configuration is completed, then the CT1 bit can be cleared by the processor and normal operations resumed.

Note that the CT1 bit is set on either power up of software reset and therefore the Traffic inhibit mechanism is active. When initialization of the device registers is completed by the processor the CT1 bit should be cleared

Note that the devices at both ends of the LVDS link should be configured with the same values for the PDUCFG, USPAL, or USPAM registers for correct operation

Note that when configuration of both ends of the link is complete then CT1 must not be disabled for at least two PDU transport times (ie the length of time it takes to transport two PDUs over the LVDS link) This CT1 disable holdoff period allows all PDUs of the old configuration to be received and discarded correctly. If this holdoff period is not respected then an idle cell PDU of the old PDU configuration may arrive at a device programmed with the new PDU configuration and incorrectly be interpreted as a valid cell.

Note that any change in the PDU configuration which changes the byte location of the TC HEC byte will cause the far end device to fall out of TC delineation. See FIG. 8.

Cell/Frame Delineation and Descrambler Operation

Each of the two Transmission Convergence Sub-Layer (TSC) Dissassemblers receives 16-bit data from the associated LVDS receive section. The Transport containers DisAssembler must first find the Transport Container (TC) boundaries, then the data can be descrambled and the Frame boundaries found. Once this has been achieved the received data can be disassembled.

After achieving Transport container Delineation and the Descrambler locking, then the cell data within each Transport container is valid and can be passed to the MTB. If Transport container delineation is lost, or the Descrambler is not locked, then cell data is invalid and is not passed to the MTB.

Frame delineation must be achieved before the bytes of the F Channel are considered valid. The F Channel consists of the ECC, Flow Control, BIP, Remote Alarm and Signalling and Link Label bytes. If Frame delineation is lost then:

the received ECC bytes are considered invalid and are assumed to retain the last valid values received

the Flow Control bytes are considered invalid and are assumed to be all ones, i.e. ‘halt’ all ports

the Remote Alarm and Signaling byte is considered invalid and is assumed to retain the last valid value received

and the Link Label byte is considered invalid and is assumed to retain the last valid value received.

Transport container and Frame Delineation is achieved using the HEC bytes of the Transport container's. The HEC bytes are not scrambled.

The Descrambler is loaded with the Scrambler sequence on start-up to achieve lock. The operation of these blocks is described below.

Transport Container Delineation

At the receive end of the LVDS link, the data will appear as a stream with no indication of Transport Container (TC) or frame boundaries. Transport container delineation is achieved by finding correct HEC's on the incoming data stream.

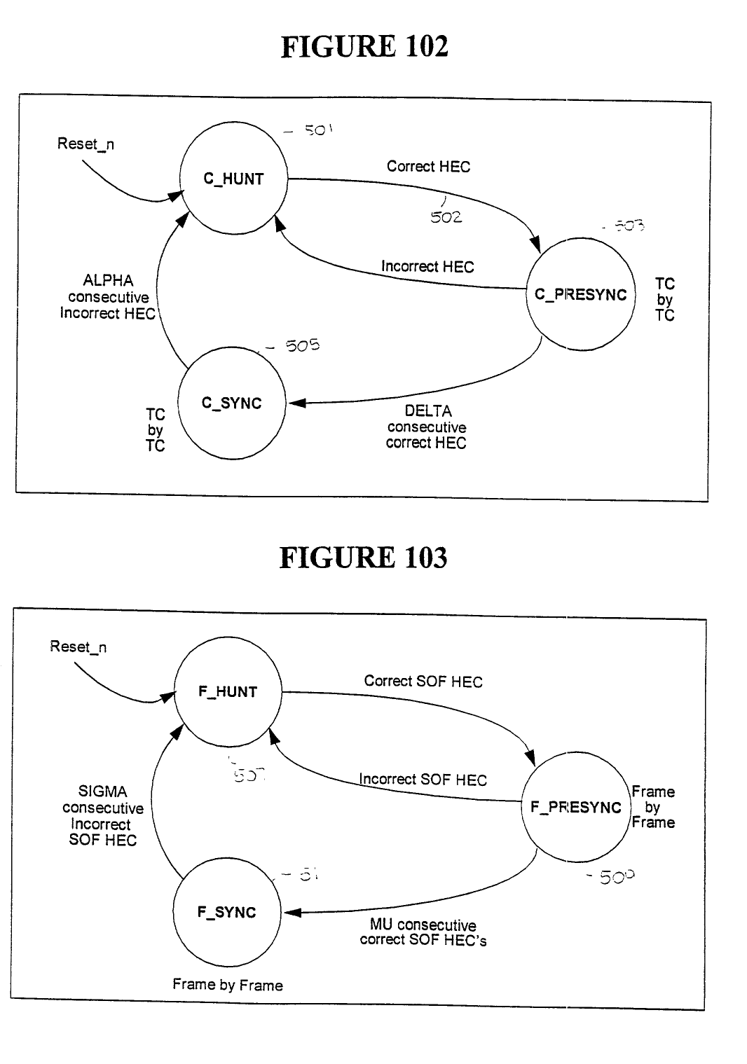

The Transport container delineation state diagram is shown in FIG. 102.

C_HUNT (501)—On reset, the Transport container delineation state machine starts in the C_HUNT state and Transport container delineation has not been achieved. In the C_HUNT state, a HEC is calculated word by word on a data stream equal in length to the Transport container Header and compared against the next received byte. The length of the Transport container header is derived from the PDUCFG register.(FIG. 27) This process is repeated until a correct HEC is detected. When a single correct HEC has been detected the state machine moves into the C_PRESYNC state (503).

Note that depending on the length of the Transport container and the length of the Transport container Header it may be necessary to word slip after a predefined number of HEC calculations in order to obtain a correct HEC.

In C_PRESYNC, if a correct HEC is found DELTA consecutive times then the state machine moves to the C_SYNC state (505) and the system has achieved Transport container delineation. If an erred HEC detected during the C PRESYNC state, the process moves back to the C HIUNT state.

In the C_SYNC (505) state, Transport container delineation is assumed to be lost if an erred HEC is obtained on ALPHA consecutive occasions. The state machine will move back to the C_HUNT (501) state.

The values of DELTA and ALPHA are programmable independently for Port A and Port B. They are contained in the RACDT and RBCDT registers (FIGS. 58 and 77) and the discussion thereto.

Frame Delineation

Once the system has achieved Transport container delineation, the Frame delineation process can begin. The Frame delineation process is achieved by checking for correct HEC's with the added coset x⁶+x⁴+x²+1. This added coset differentiates 'Start of Frame'Transport container HEC's. Only the HEC of Transport container 0 can always be differentiated from that of other Transport container's.

The Frame delineation state diagram is shown in FIG. 103.

F_HUNT (507)—On reset, the Frame delineation state machine starts in the F_HUNT 507 state and Frame delineation as not been achieved. Each received HEC is monitored to determine if it has the added coset and is therefor the Start of Frame (SOF) HEC. When a single correct SOF HEC is detected, the state machine enters the F_PRESYNC state (509).

F_PRESYNC—In the F_PRESYNC state if a correct SOF HEC is found MU consecutive times the state machine moves to the F SYNC 511 state and the system is said to have achieved Frame delineation. If an errored SOF HEC is detected during the F PRESYNC state the state machine moves back to the F HUNT 507 state.

F_SYNCH 511—In the F_SYNC state (511), Frame delineation will be assumed to be lost if an erred SOF HEC is obtained on SIGMA consecutive occasions. The state machine will move back to the F_HUNT 507 state.

The values of SIGMA and MU are programmable independently for Port A and Port B. They are contained in the RAFDT and RBFDT registers (FIGS. 59 and 78) and the discussion thereto. On reset, SIGMA=8 and MU=7.

Descrambler Operation

Once Transport container delineation has been obtained, the Descrambler synchronization can begin.

After reset, the Descrambler expects the far-end device to send it's Scrambler sequence so that the Descrambler can synchronize (lock) to it. This is achieved by means of the Remote Descrambler Loss of Lock bit (RDSLL) of the Remote Alarm and Signalling byte. This received bit is stored as the RARDSLL bit of the RARA register for Port A and RBRDSLL bit of the RBRA register for Port B.

The lock status of the Descrambler is transmitted to the far-end device as the RDSLL bit. If the Descrambler is out of lock, then the transmitted RDSLL=1. At the far end device, this is to be stored as RARDSLL or RBRDSLL. depending on which port it is connected to. When this bit is set for the active receive port, it causes the Transport containers Assembler 107 to transmit the Scrambler sequence embedded in Idle cells. The Descrambler loads this sequence and attempts to lock to it. Once the Descrambler is locked, it clears the RDSLL bit transmitted to the far-end device, which causes it to stop sending the Scrambler sequence embedded in Idle cells and to begin sending real traffic cells.

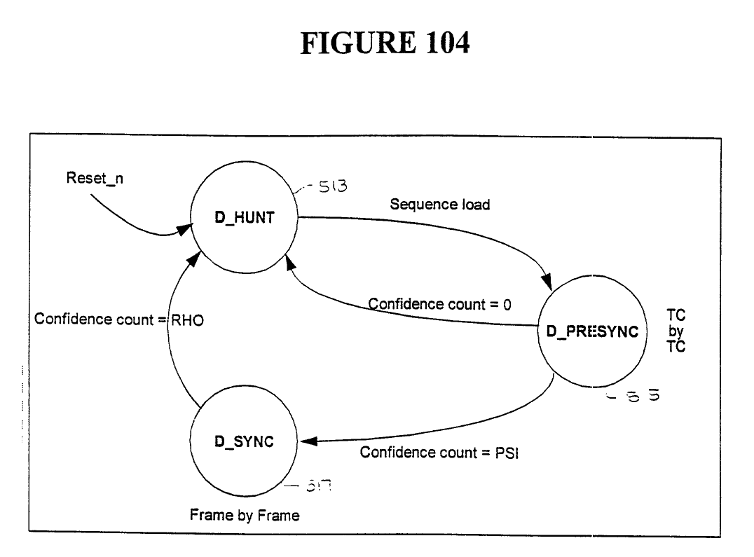

The Descrambler synchronization state diagram is shown in FIG. 104.

D HUNT (513)—On reset, the Descrambler synchronization state machine starts in the D_HUNT 513 state and the Descrambler is not in Lock. When Transport container delineation has been achieved, the transmitted Scrambler sequence is loaded into the Descrambler. The state machine enters the D_PRESYNC state (515).

D_PRESYNC—The received scrambler sequence and predicted sequences are compared for each Transport container. For each correct prediction, a confidence counter increments, and for each incorrect prediction, the confidence counter is decremented. When the confidence counter reaches PSI, then the state machine moves to the D_SYNCH state (517) and the system is said to have achieved scrambler Lock. If the confidence counter reaches 0 then the state machine moves back to the HUNT state.

D_SYNC—The comparison of received scrambler sequences and predicted sequences is repeated for Frame. for each correct prediction a confidence counter is decremented and for each incorrect prediction the confidence counter is incremented. The confidence counter has a lower limit of 0. If the confidence counter reaches RHO then the state machine moves back to the D_HUNT 513 state and the Descrambler is out of Lock.

The state machine will also return directly to D_HUNT 513 if Transport container delineation is lost.

The values of PSI and RHO are programmable indepedently for Port A and Port B. They are contained in the RADSLKT and RBDSLKT registers (FIGS. 60 and 79) and the discussion thereto. On reset PSI=8 and RHO=8.

### LVDS Interface Operation

The LVDS interface combines a transmit serializer and two receive deserializers. The Serializer 121 accepts 16-bit data from the Transport containers Assembler 107 block and transforms it into a serial data stream with embedded clock information. Each Deserializer 117 recovers the clock and data from the received serial data stream to deliver the resulting 16-bit wide words to the corresponding Transport containers DisAssembler Block.

The LVDS interface has a Transmit Serializer 121 block and 2 Receive Deserializer 117 blocks that can operate independent of each other. The transmit data is duplicated over 2 differential output pairs with independent tri-state controls. The transmit block has a power down control. Each receiver has a power down control. These features enable efficient operation in various applications.

The Serializer 121 and Deserializer 117 blocks each have 3 operating states. They are the Initialization, Data Transfer, and Resynchronization states. In addition, there are 2 passive states: Powerdown and TRI-STATE.

The following sections describe each operating mode and passive state. For clarity these descriptions refer only the receive Port A. The operation of receive Port B is the same.

Initialization

Before the device sends or receives data, it must initialize the links to and from another UTOPIA Bridge. Initialization refers to synchronizing the Serializer 121 and Deserializer's PLL's to local clocks. The local clocks must be the same frequency or within a specified range if from different sources. After the Serializers synchronize to the local clocks, the Deserializers synchronize to the Serializers as the second and final initialization step.

Step 1 After applying Vcc and GND to the Serializer 121 and Deserializer, the LVDS transmit outputs are held in TRI-STATE and the on-chip power-sequencing circuitry disables the internal circuits. When Vcc reaches VccOK in each device, the PLL in the Serializer 121 and Deserializer 117 begins locking to the local cloc. In the Serialzier, the local clock is the LVDS_TxClk, while the Port A Deserializer 1 17 is the reference clock, LVDS_ARefClk. A local on-board oscillator or other source provides the specified clock input to the LVDS_TxClk and LVDS_ARefClk pins Step 2 The Deserializer 117 PLL must synchronize to the Serializer 121 to complete the initialization. The Serializer 121 that is generating the stream to the Deserializer 117 must send random (non-repetitive) data patterns or sync-patterns during this step of the Initialization State. The Deserializer 117 will lock onto sync-patterns within a specified amount of time. The lock to random data depends on the data patterns and, therefore, the lock time is unspecified.

In order to lock to the incoming LVDS data stream, the Deserializer 117 identifies the rising clock edge in a sync-pattern and after XXXX clock cycles will synchronize. If the Deserializer 117 is locking to a random data stream from the Serializer, then it performs a series of operations to identify the rising clock edge and locks to it. Because this locking procedure depends on the data pattern, it is not possible to specify how long it will take. At the LL0SA bit of the ETXRXA register may be cleared and valid data is presented to the Transport containers Disassembler 109 block. Note that the LVDS-ALock_n signal is synchronous to valid data being presented to the Transport containers Disassembler 109.

Data Transfer

After initialization, the Serializer 121 is able to transfer data to the Deserializer. The serial data stream includes a start bit and stop bit appended by the serializer, which frame the 16 data bits. The start bit is always high and the stop bit is always low. The start and stop bits also function as clock bits embedded in the serial stream.

The Serializer 121 block accepts 16-bit data from the Transport containers Assembler 107 block. The internal version of the LVDS_TxClk signal latches the incoming data. If the LVDS_Synch input or the TXSYNC bit of the LVC register is high for 5 LVDS_TxClk cycles, the Serializer 121 does not latch data from the Transport containers Assembler 107 block.

The Serializer 121 transmits the data and clock bits at 18 times the LVDS TxClk frequency. For example, if LVDS_TxClk is 50 MHz, the serial rate is 50×18=900 Mpbs. Since only 16 bits are from input data, the serial “payload” rate is 16 times the LVDS_TxClk frequency. For instance, if LVDS_TxClk=50 MHz, the payload data rate is 50×16=800 Mbps. LVDS_TxClk is provided by the data source and must be in the range of 40 MHz to 70 MHz.

When the Port A Deserializer 117 channel synchronizes to the input from a Serializer, it drives its LVDS_ALock_n pin low, the LL0SA bit of the ETXRXA register may be cleared, and synchronously delivers valid data to the Transport containers Disassembler 109 The process flow is that the Port A Deserializer 117 locks to the embedded clock, uses it to generate multiple internal data strobes, and then drives the recovered clock on the LVDS_ARxClk pin. The LVDS_ARxClk is synchronous to the data delivered to the Transport containers Disassembler 109. While the LVDS_ALock_n pin is low data to the Transport containers Disassembler 109 is valid. Otherwise, the data is invalid and is ignored by the Transport containers Disassembler 109 and an interrupt may be raised on the LL0SA bit being set high.

LVDS_ALock_n and LVDS_ARxClk signals will drive a minimum of three CMOS input gates (15pF total load) at a 70 MHz clock rate.

The Port A Deserializer 117 input pins LVDS_ADin are high impedance during Receiver Powerdown (LVDS-APwdn pin low or bit RAPWDN or the LVC register set high) and power-off (VCC=OV).

Resynchronization

Whenever the Port A Deserializer 117 loses lock, it will automatically try to resynchronize. For example, if the embedded clock edge is not detected two times in succession, the PLL loses lock and the LVDS-ALock-n pin and the LL0SA bit are driven high. The port a Deserializer 117 then enters the operating mode where it tries to lock to a random data stream. It looks for the embedded clock edge, identifies it and then proceeds through the synchronization process.

The logic state of the LVDS-ALock-n pin indicates whether the data is valid; when it is low, the data is valid. The system must monitor the LVDS a lock pin and LL0SA bit to determine whether received data is valid. The UTOPIA Bridge facilitates this by allowing an interrupt to be raised on LL0SA being set. There is a short delay in response to the PLL losing synchronization to the incoming data stream.

The user can choose to re-synchronize to the random data stream or to force fast synchronization by pulsing the Serializer 121 LVDS_SYNCH pin or setting the TXSYNC bit. This scheme is left up to the user discretion. One recommendation is to provide a feedback loop using the LVDS_ALock_n pin itself to control the synch request of the Serializer, which is the LVDS_SYNCH pin.

Powerdown/TRI-STATE

The Powerdown state is a very low power consuming sleep mode that the Serializer 121 and Deserializer 117 will occupy which waiting for initialization. You can also use the LVDS_ADenb, LVDS_TxPwdn, LVDS_APwdn and LVDS_BPwdn pins, or the TXPWDN, TXADEN, TXBDBN, RAPWDN and RBPWDN bits of the LVC register to reduce power when there are no pending data transfers. The Port A Deserializer 117 enters Powerdown when LVDS_APwdn is driven low or the RAPWDN bit is set. In Powerdown, the PLL stops and the outputs go into TRI-STATE, which reduces supply current to the HA range.

To bring Port A Deserializer 117 block out of the Powerdown state, the system drives LVDS_APwdn high and the RAPWDN bit it cleared. When the Deserializer 117 exits Powerdown, it automatically enters the Initialization state. The system must then allow time for Initialization before data transfer can begin.

The LVDS_TxPwdn driven low or the TXPWDN bit clear, forces the Serializer 121 block into low power consumption where the supply current is the ua range. The Serializer 121 PLL stops and the output goes into a TRI-STATE condition.

To bring the Serializer 121 block out of the Powerdown state, the system drives LVDS_TxPwdn high and sets the TXPWDN bit. When the Serializer 121 exits Powerdown, its PLL must lock to the LVDS_TxClk before it is ready for the Initialization state. The system must then allow tie for Initialization before data transfer can begin.

Loopback Test Operation

The UTOPIA Bridge includes 2 Loopback modes for testing the device functionality and the transmission line continuity. The Line Loopback connects the serial data input (LVDS-ADin) to the serial data output (LVDS_ADout and LVDS_BDout) in addition to the parallel data output to the Transport containers Disassembler 109 The serial data output connection route goes through Deserializer 117 and Serializer 121 blocks.

The Local Loopback connects the parallel data output from the Deserializer 117 back to the parallel data input of the Serializer. The connection route includes all the functional blocks of the Transceiver.

The ALBC register controls the loopbacks with the LNEN, LNSEL, LCLA and LCLB bits.

Loop Timing Operation

The UTOPIA Bridge includes a Loop Timing mode controlled by the LT bit of the GCS register. On reset the LT bit is clear so the LVDS transmit clock is sourced directly from the LVDS_TxClk pin. Setting the LT bit will switch the transmit clock to be sourced from the recovered clock of the active receiver, as defined by the LBA bit of the LKSC register,. The LVDS transit and Transport container A block will then be driven by this internal clock and not the LVDS_TxClk pin.

During the switch the LVDS transmit data will be corrupted for XXX cycles. Note that this may cause the far-end device to lose scrambler lock, frame lock or cell delineation.

Note that both the input LVDS_TxClk clock and active port recovered clock must be present for the switch to complete successfully.

Note also that on reset the device will operate from the LVDS_TxClk input pin clock and therefore this clock must be present to ensure correct operation.

When operating in Loop Timing mode then a Loss of Lock on the active LVDS receiver, or a switch of active receiver will also cause the LVDS transmit data to be corrupted for XXX cycles.

### Switching Receive Ports

The UTOPIA-LVDS Bridge 100 has 2 independent receive sections designated Port A and Port B. Traffic can be received from either port. This LBA bit of the LKSC register, described in FIG. 30 and the discussion thereto controls this function.

The ECC 113 also has two independent receive sections. This is controlled by the settings of the ERXA and ERXB bits of the LKSC register. The selected ECC 113 receive port is independent of the active traffic port selection. Therefore, Port A may be selected as active for cell traffic by clearing the LBA bit, but the ECC 113 may be receiving on Port B by setting the ERXB bit. In this way the ECC 113 may communicate over either link without affecting the active cell traffic port.

The selection of active traffic receive ports is accomplished by simply changing the value of the LBA bit. When set high, then traffic cells are accepted from Port B, and when cleared low, traffic cells are accepted from Port A. When the LBA value is changed, the MTB will complete receiving the current cell before switching to the new Port. The MTB then waits for the next Start of Cell indication from the associated Transport containers Disassembler 109. This means that the MTB does not need to be flushed or reset in any way.

The switching from one port to another is completed XXXX clock cycles after the end of receiving the current cell into the MTB.

Changing the value of the LBA bit to switch ports will clear the ABSC bit of the LKSC register. When the switch from one port to the other is completed successfully then the hardware will set the ABSC bit. This bit can thus be polled by the processor to determine if the switch has been completed.

### Performance Monitoring

Live Traffic Performance Monitoring

Performance monitoring is carried out on live traffic it 2 ways. One is using the HEC bytes associated with each cell's Transport container. The other is the BIP bytes of the F channel embedded in the frame structure, as described in the sub-heading BIP.

A 24-bit count of errored HEC's received on Port A is contained in the RAHECC2-RAHECC0 registers. When the number of received erred HEC's exceeds the threshold defined in the RAHECC2-RAHECC0 registers, an interrupt may be raised on the RAXHEC alarm bit in the RAPA alarm register. The count register RAHECC2-RAHECC0 registers is reset on read.

A 24-bit count of erred BIP bytes is similarly maintained in RABIPC2-RABIPC0 registers. The associated erred BIP threshold is contained in the RABIPT2-RABIPT0 registers and an interrupt may be raised on the RAXBIP alarm bit in the RAPA alarm register. The count register RABIPC2-RABIPC0 is also reset on read.

The same mechanism is in place for Port B using the RBHECC2-RNBECC0, RBHECT2-RHHECT0, RBBIPC2-RBBIPC0, RBBIPT2-RBBIPT0 and RBPA registers.

In addition to the HEC and BIP monitoring, live traffic loopback cell monitoring and loopback cell counts are maintained and may raise interrupts on detection of a loopback cell as will be described under the sub-heading ATM Cell Loopback.

Bit Error Count Mode

In addition to live traffic performance monitoring, a PRBS based LVDS link bit error count facility is available. In this mode, no cells are transmitted and instead the raw scrambler pseudo-random sequence (polynomial x³¹+x²⁸+1) is transmitted. The descrambler will lock to this sequence and then count individual bit errors in the PRBS stream. This bit error count is maintained in a count register. As there is no data cell delineation, the frame delineation will be lost. This is not a live traffic test.

The device will transmit the PRBS data when the TXPRBS bit of the TERRCTL register is set. When this bit is set, no cell data is transmitted and the Transport containers Assembler 107 is paused. In addition, no cells will be read from the FIB queue.

The receive section of Port A can lock onto this sequence and maintain the bit error count when the RABEC bit of the RACTL register is set. The bit error count is maintained in the RABEC2-RABEC0 registers. This counter has no associated threshold register and will not generate an interrupt. The counter may be polled (read) at fixed intervals to determine a Bit Error Rate. This counter is reset on read. The count value is only valid when both the TXPRBS bit and the RABEC bit are set.

Port B can operate in the same fashion using the RBBEC bit of the RBCTL register and the RBBEC2-RBBEC0 registers.

### Loopback Operation

To assist in diagnostic testing, the UTOPIA-LVDS Bridge 100 provides both physical interface loopback and ATM cell loopback. The former is suitable for designer or commission testing when the device is not passing live traffic. The latter allows cell trace testing on live traffic. All loopback are programmable via the microprocessor interface.

ATM Cell Loopback

The ATM Cell Loopback functionality can operate 2 separate loopbacks. The Down2Up_ATM loopback can detect special loopback cells received on the UTOPIA interface and transmit them back out over the UTOPIA interface. The Up2Down_ATM loopback can detect special loopback cells received on the LVDS interface and transmit them back out over the LVDS interface. This is illustrated in FIGS. 20a and 20b.

The format of the special loopback cells is defined in the ATM Loopback Cell Format registers ALBCF3-ALBCF0. These registers define the contents of the four cell header bytes, which indicate that a receive cell is a loopback cell. Associated with the ALBCF3-ALBCF0 registers are the ATM loopback Cell filter registers ALFLT3-ALFTO. These registers define which bits of the cell header are compared with the loopback CELL header declared in the ALBCF3-ALBCF0 registers. It is therefore possible to mask out any bits of the cell header from comparison.

For Down2Up_ATM loopback on the UTOPIA interface only, the ATM loopback Mphy register ALBMP, defines the Mphy address on which loopback cells are to be detected, and also defines the Mphy address on which they will be sent back out of the device. Loopback cells are only detected on this Mohy address at the UTOPIA interface.

For Up2Down_ATM loopback on the LVDS interface the Mphy address is embedded in the incoming PDU and is simply transmitted back out. Therefore, the ALBMP register is not relevant.

The ATM and LVDS loopback control register ALBC controls the ATM cell loopback functionality. Bit D2ULB enables the Down2Up-ATM loopback and bit U2DLB enables the Up2Down_ATM loopback. Both may be enable at the same time.

For Down2Up-ATM loopback, only loopback cells as defined by the ALBMP, ALBCF3-ALBCF0 and ALFLT3-ALFLT0 registers are looped back and all other cells are passed as normal.

For Up2Down_ATM loopback, only loopback cells as defined by the ALBCF3-ALBCF0 and ALFLT3-ALFLT0 registers are looped back and all other cells are passed as normal.

A count of the number of loopback cells is maintained for the Down2Up loopback in the Down2Up loopback cell count register (FIG. 79) D2ULBCC and for the Up2Down loopback in the Up2Down loopback Cell Count register U2DLBCC. Whenever these counters change value the D2ULBC alarm in the UAA register is set.

For the Up2Down_ATM loopback, counts are maintain in both receivers in the receive Port A. Up 2Down Loopback Cell count register RAU2DLBC and the receive port B Up2Down Loopback Cell Count register RBU2DLBC. Whenever the counter in the Active receiver (as defined by the LBA bit of the LKSC register) increments the U2DLBC alarm in the UAA register is set. Although both counters may increment whenever they detect an incoming loopback cell, only increments only the counter of the active receive can set the alarm.

Alarms in the UAA register may raise an interrupt if the appropriate interrupt enables are set in the UAIE register.

Loopback cells are only counted and looped back in the appropriate loopback mode. If the loopback mode is not set then any incoming loopback cells are simply treated as normal traffic and passed by the device. In Up2Down_ATM loopback mode only cells from the active receiver will be looped back.

A loopback cell transmission may be initiated by the UTOPIA-LVDS Bridge 100 over the LVDS transmit link. The TXLVLB bit in the ULBC register controls this functionality. Setting the TXLVLB bit causes a single loopback cell to be transmitted over the LVDS transmit link. When transmission is finished the TXLVLB bit is cleared. So the processor, on setting the TXLVLB bit, should poll it to detect when it clears before sending another loopback cell. The loopback cell transmitted will have a header of the format defined by the ALBCF3-ALBCF0 registers and an Mphy address as defined by the ALBMP register.

### Embedded Communication Channel Operation

This section describes the operation of the ECC 113 in the UTOPIA-LVDS Bridge 100. The ECC 113 transmits 8 byte long messages over the link under software control. Flow control is used to ensure that messages are not overwritten at the receive end.

The message to be transmitted is written to the ETXD7-EXTD0 transmit buffer registers and the received messages are stored in the Port A ERAD7-ERAD0 or Port B ERBD7-ERBD0 receive buffer registers. Software control is achieved on the transmit side using the ECC 113 Transmit Buffer Ready (ETXBR) interrupt of the ETXRXA register and the ECC 113 Transmit Send (ETXSD) register.

There are independent receive sections in Port A and Port B and these are controlled by the ECC 113 Receive Port A Buffer Full (ERABF) interrupt of the Receive Port A Local Alarm (RALA) register, and the ECC 113 Receive Port B Buffer Full (ERBBF) interrupt of the Receive Port B Local Alarm (RBLA) register respectively. The choice of receiving ECC 113 messages on Port A or Port B is controlled by the ECCB and ECCA bits of the Link Status and Control (LKSC) register.

The Remote Alarm and Signaling Byte carries the ECC 113 signaling bits. The transmitted Remote Alarm and Signaling Byte carries the ESS signal for both of the local ECC 113 receive section, ESSA and ESSB. At the receiver a choice must be made as to which ESS bit of the received Remote Alarm and Signaling Byte is valid for the local ECC 113 transmitter. This is controlled by the RAFSS and RBESS bits of the RACTL and RBCTL registers respectively.

Basic ECC Protocol—One Transmit and One Receive

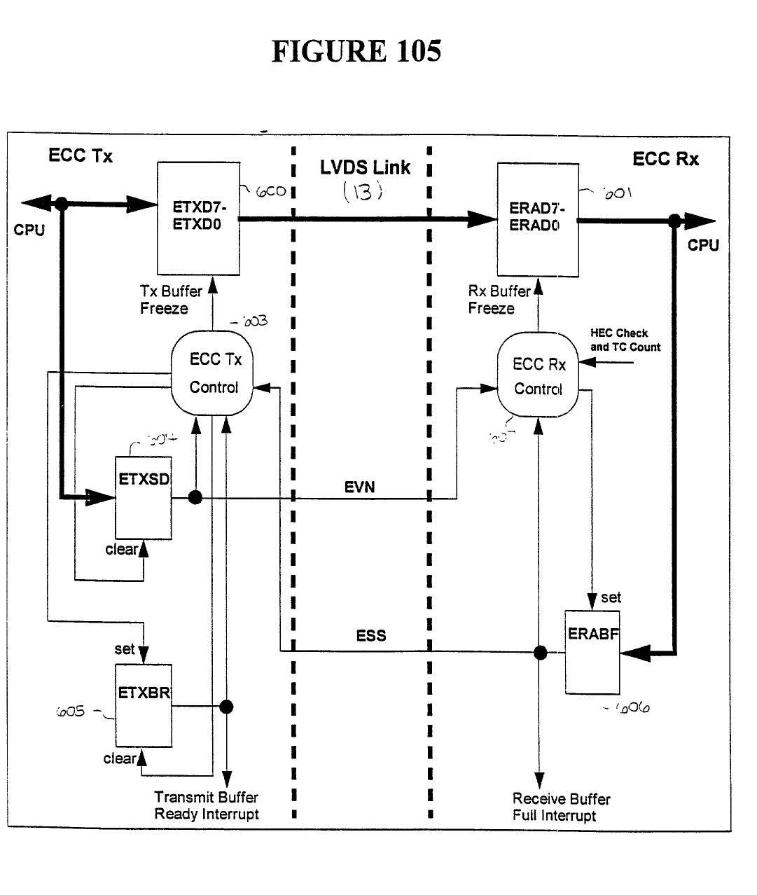

The basic structure of the ECC 113 is illustrated in FIG. 105.

The basic operation of an ECC 113 link is described here using the transmit section of the device at one end of the LVDS link and a single receive section (Port A) of the device at the other end of the link

The ECC 113 transmitter and receiver communicate via the embedded control signals EVN, ESSA, and ESSB in the Remote Alarm and Signaling byte contained in the F1 byte of Transport container 6.

Note that only one of the incoming remote ESS bits is valid on each link as the local transmitter cannot be connected to both receivers on another UTOPIA-LVDS Bridge 100.

The ENV and ESS bits are interpreted as follows:

EVN-Set=Valid ECC data in F1/F2 bytes of Transport container 13, Transport container 20, Transport container 41 and Transport container 48. Clear=Null (not valid) ECC data in F1/F2 bytes of Transport container 13, Transport container 20, Transport container 41 and Transport container 48.

ESS-Set=Stop sending ECC data as receive buffer is full. Clear=Send ECC data as receive buffer is ready.

The protocol for transmission of an ECC 113 message is as follows.

Reset

The transmit buffer ready ETXBR bit 605 is set indicating that the transmit buffer ETXD7-ETXDO 600 can be written to the Tx Buffer Freeze is clear (inactive).

The transmit buffer send ETXSD bit is clear indicating that no message is being sent and therefore EVN is clear indicating to the receiver that Null data is being transmitted.

The receive buffer full ERABF bit 60 is clear indicating that no message has been received and therefore ESS is clear indicating to the transmitter that it can send a message when ready.

Assembling a Message

As the ETXBR bit 605 is set the processor now has read/write access to the transmit buffer ETXD7-ETXD0 600 and can assemble a message by writing to these registers in any order. The message can be read back for checking. Writing to these registers does not affect the ETXBR 605 and ETXSD bits 605 and 604 or the EVN signal.

Transmitting a message

To transmit a message the processor simply sets the send bit ETXSD 604. This clears the ETXBR bit 605 preventing write access to the transmit buffer so the message being transmitted cannot be corrupted by writes to the ETXD7-ETXD0 registers 600 until transmission is completed. The setting of the ETXSD bit 604 also set the EVN signal indicating to the receiver that Valid data is being transmitted in the F1/F2 bytes of Transport container 13, Transport container 20, Transport container 41 and Transport container 48.

Note that transmitting a message depends on the incoming ESS signal. If ESS is clear indicating that a message can be sent then the processor can write to the ETXSD bit 604. However, if ESS is set indicating that a message cannot be sent then the ETXSD bit 604 is held in reset and cannot be written to by the processor to initiate transmission. This provides flow control from the receiver back to the transmitter.

Receiving a Message

As the receiver ERABF bit 606 is clear the ESS bit is clear indicating that the receiver can accept a message. The receiver monitors the incoming EVN signal to determine when valid data is being transmitted.

On detecting EVN set the receiver uses the Transport container number to extract the 8 ECC message bytes from the incoming data stream. If an errors HEC is detected on any of the ECC 113 message bytes then the receiver assumes all 8 bytes are corrupted and will re-extract the entire message on the next frame. The transmitter will continue to transmit the message as long as the ESS signal is clear.

When the receiver determines that it has received the entire message it sets the receive buffer full ERABF bit 606. This prevents the receive buffer ERAD7-ERAD0 602 being updated by the incoming ECC 113 bytes so that the message cannot be overwritten. It also raises an interrupt to the local processor to indicate that a valid ECC 113 message has been received.

The setting of the ERABF bit 606 also sets the ESS signal back to the transmitter indicating that it should stop transmission. This clears the ETXSD bit which clears the EVN signal thus indicating that transmitted ECC 113 data is Null (not valid).

At this stage the receive buffer is full and cannot receive any further messages. The transmit buffer ready ETXBR 6054 is still clear meaning that no new messages can be assembled and ETXSD 604 is held clear so no new messages can be transmitted. This flow control ensures that no new messages will be transmitted until the current received message is read. This situation will remain until the received message is read by the local processor.

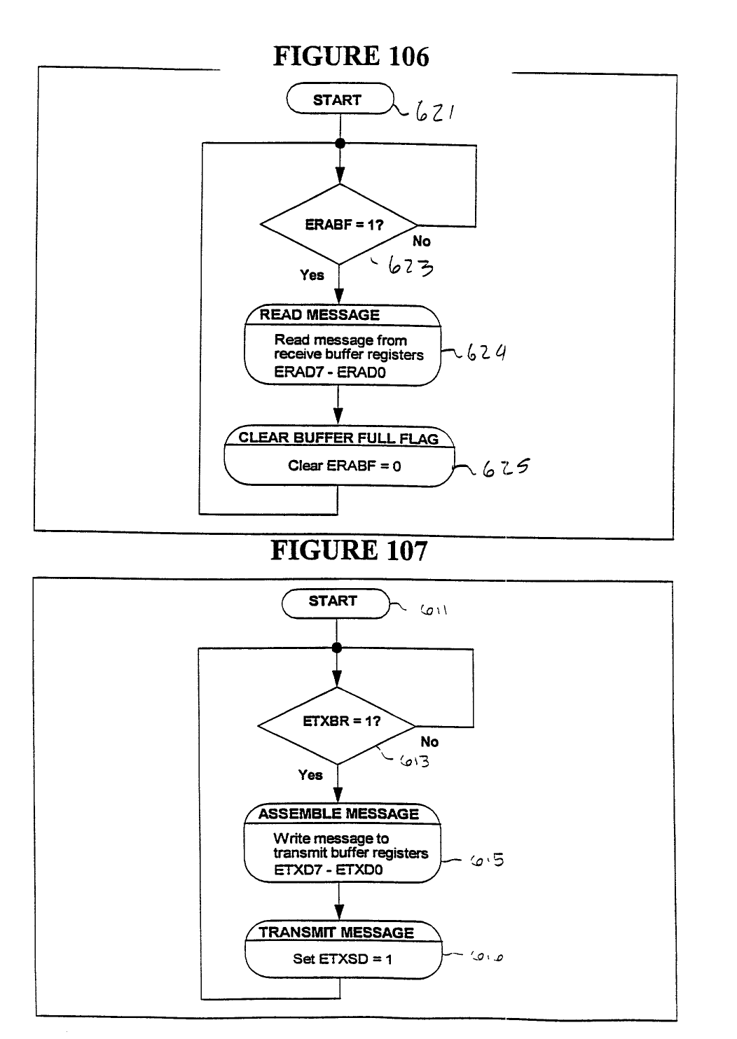

Reading a Message (FIG. 106)

The setting of the ERABF bit (block 623) in the receiver raises an interrupt to the local processor indicating that a valid ECC 113 message has been received and can be read.

The receive buffer registers ERAD7-ERAD0 (block 624) are read only. The processor may read theses registers in any order and the reading of them has no affect on the ERABF bit or the ESS signal.

When the processor is finished reading the message from the buffer it writes to the ERABF bit to clear it (Block 625). This allows the receiver to receive a new message (Block 621). The clearing of the ERABF bit clears the ESS signals indicating to the transmitter that it can send another message.

Transmitting a New Message

The clearing of the incoming ESS signal causes the transmitter to set the transmit buffer ETXBR bit (Block 613). This allows write access to the transmit buffer ETXD7ETXD0 for the assembly of a new message (at block 615). It also releases the ETXSD bit from reset and the processor can now set this bit to send a new message.

At this stage at the transmitter the ETXBR bit is set, the ETXSD bit is clear and EVN is clear. At the receiver the ERABF bit is clear and the ESS signal is clear. This is the same situation as after reset and therefore the same sequence as above can be followed to transmit a new message.

Note that the transmit buffer registers can be modified or overwritten to assemble a new message for transmission, or the existing message can be resent simply by setting the ETXSD bit again (Block 616).

Summary

Tx—If the ETXBR bit is clear then write the message to the ETXD7-ETXD0 registers (FIG. 35).

Tx—Set the ETXSD bit to send the message. This clears ETXBR.

Rx—When full message received the ERABF bit is set raising an interrupt

Rx—After reading the message clear the ERABF bit to allow new message to be received.

Tx—The clearing of the ERABF bit sets the ETXBR bit allowing a new message to be assembled and transmitted.

Flow Charts

The flow charts in FIGS. 106 and 107 summarize the control of the ECC 113 receive and transmit.

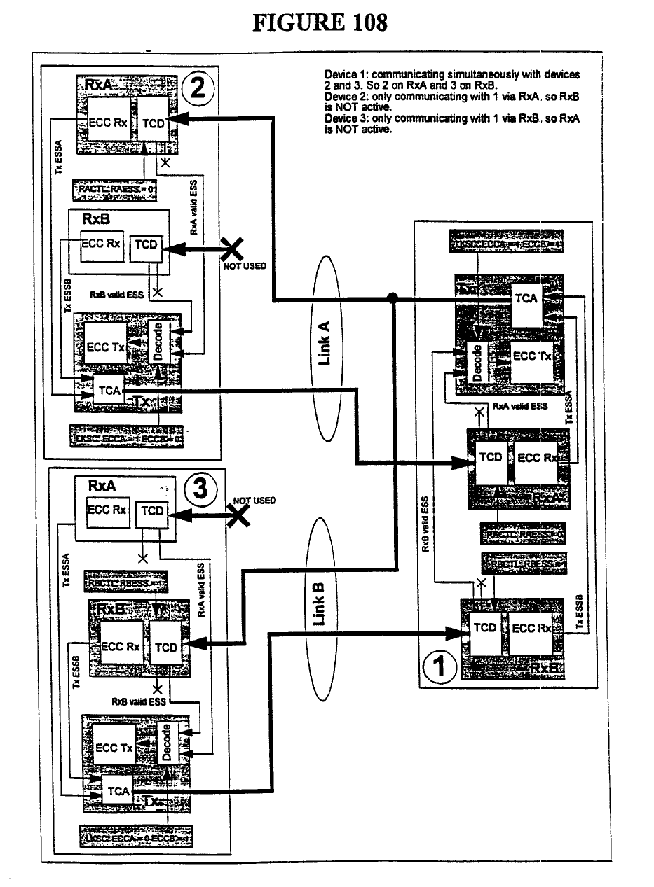

ECC Operation with Active and Standby Receivers (FIG. 108)

The UTOPIA-LVDS Bridge 100 has two independent receive sections, Port A and Port B. These each contain an ECC 113 receive section and the ECC 113 can be configured to operate over Port A or Port B or over both Port A and Port B together. The ECC 113 receive port can be selected independent of the traffic receive port. Therefore traffic data is received on the active port designated by the LBA bit of the LKSC register but the ECC 113 can receive on either Port A or Port B as designated by the ECCA and ECCB bits of the same LKSC register. In a protected system with an active and standby LVDS link this can be used to communicate with the standby link while traffic continues to be received from the active link.

ECC Receive on Port A: Communicating with Device 2 only.

For the ECC 113 to communicate across the active Link A only, the ECCA bit of the LKSC register is set and the ECCB bit is clear. The incoming valid ESS signal received over Link A “RxA valid ESS” is only one used by the ECC 113 transmit section in Tx. The RxA port is programmed to extract the incoming ESSA bit as the valid ESS, as Device 1 transmitter is connected to Device 2 receiver port A. This is accomplished by setting the RAESS bit of the RBCTL register.

In this case when an ECC 113 message is transmitted it is the RxA ESS signal is used to determine when the message has been successfully received by the far-end Device 2. So ECC 113 communications only occurs over Link B to between Device 1 and Device 2.

For device 2 the ECCA bit of the LKSC register is set and the ECCB bit is clear. The incoming valid ESS signal received over Link A “RxA valid ESS”, is only one used by the ECC 113 transmit section in Tx. The RxA port is programmed to extract the incoming ESSA bit as the valid ESS, as the Device 2 transmitter is connected to Device 1 receiver Port A. This is accompolished by setting the RAESS bit of the RBCTL register.

ECC Receive on Port B Communicating with Device 3 Only.

Referring to FIG. 108 in the case of Device 1 for the ECC 113 to communicate across the active Link B only, the ECCB bit of the LKSC register is clear and the ECCA bit is set. The incoming valid ESS signal received over Link B “RxB valid ESS” is only one used by the ECC 113 transmit section in Tx. The RxB port is programmed to extract the incoming ESSB bit as the valid ESS, as Device 1 transmitter is connected to Device 3 receiver port B. This is accomplished by setting the RBESS bit of the RBCTL register.

In this case when an ECC 113 message is transmitted it is the RxB ESS signal that is used to determine when the message has been successfully received by the far-end Device 3. So ECC 113 communications only occurs over Link B to between Device 1 and Device 3.

For device 3 the ECCA bit of the LKSC register is clear and the ECCB bit is set. The incoming valid ESS signal received over Link B “RxB valid ESS”, is only one used by the ECC 113 transmit section in Tx. The RxB port and is programmed to extract the incoming ESSB bit as the valid ESS, as the Device 3 transmitter is connected to Device 1 receiver Port B. This is accomplished by setting the RBESS bit of the RBCTL register.

ECC Receive on Port A and Port B Communicating with Device 2 and Device 1.

Referring to FIG. 108. In the device 1 for the ECC 113 to communicate across the both Link A and Link B, the ECCB and ECCA bits of the LKSC register are both set. The transmitted ESS signal “Tx ESS” is derived only from both the ECC 113 receive sections of RxB and RxB. The incoming ESS signals received over Link A “RxA ESS” and Link B “RxB ESS” are both used by the ECC 113 transmit section in Tx.

In this case when an ECC 113 message is transmitted both the RxA ESS and RxB ESS signals must be used to indicate that the message has been successfully received by both the far-end Active and Standby cards before a new message can be transmitted. The transmitted Tx ESS signal is determined by the RxA ECC and the RxB ECC receive sections. So only when both RxA and RxB have received a message can the Tx ESS be used to indicate to both the Active and Standby cards that they can transmit a new message. So ECC 113 communications only occurs over both Link A and Link B.

Device 2 and 3 are configured as above for communicating with only Device 1.

Note that, when Device 1 transmits a new message it must wait until both Device 2 and Device 3 indicate that they have received the last message. When Device 2 transmit a new message it must only wait until Device 1 indicated that it has received the last message. Similarly for device to transmit a new message it must wait until Device 1 indicates that it has received the last message.

Notes-Device 1: communicating simultaneously with devices 2 and 3. So 2 on RxA and 3 on RxB. Device 2: only communicating with 1 via RxA, so RxB is NOT active. Device 3: only communicating with 1 via RxB, so RxA is NOT active.

### REFERENCES

The Following References are Herein Incorporated by Referenced:

1.) The ATM Forum UTOPIA Level 2, Version 1.0 Specification, af-phy-0039.000, June 1995.

2.) ITU-T 1.432.1, B-ISDN User Network Interface-PHY Specification: General Characteristics, August 1996.

3.) The ATM Forum User Network Interface Specification, Version 3.1, September 1994.

4.) IEEE 1149.1 Standard-JTAG.

I claim:

1. A communication bridge comprising: an established protocol interface and the communication bridge further comprises; a means for programing the established protocol interface to first mode of operation and a second mode of operation, the established protocol interface includes a means for transferring established protocol cells between the communication bridge and the first device layers when in the first mode of operation and for transferring the established protocol cells between the communication bridge and the second device layers when in the second mode of operation;
a serial interface;
a down bridge direction and an up bridge direction and in the down bridge direction the communication bridge includes;
a means for detecting back pressure;
a means for converting the established protocol cell to a transport container, the means being operatively connected to the established protocol interface including an assembler means for embedding back pressure detection into the transport container, and being operatively connected to the means for detecting; and
a means for applying the transport container to the serial interface, the means for applying being operatively connected to the means for converting and to the serial interface.

2. The communication bridge according to claim 1, wherein the means for applying includes a means for arranging a predefined number of transport containers into a fame.

3. The communication bridge according to claim 2, wherein each transport container includes at least one control byte and the communication bridge comprises a means for embedding the detected back pressure into the control byte.

4. The communication bridge according to claim 3 further includes a means for embedding communication information into at least one control byte in a predefined transport container of each block.

5. The communication bridge according to claim 4 wherein the communication comprises a back pressure information.

6. The communication bridge according to claim 5 wherein each block represents a sub-port with each sub-port being capable of connecting to a plurality of ports and each of one of a plurality of bits in the at least one control byte being used to identify a port with back pressure, the communication bridge comprises a means for setting a first logic state in a bit identifying the port with back pressure.

7. A communication bridge comprising: an established protocol interface and the communication bridge further comprises; a means for programing the established protocol interface to first mode of operation and a second mode of operation, the established protocol interface includes a means for transferring established protocol cells between the communication bridge and the first device layers when in the first mode of operation and for transferring the established protocol cells between the communication bridge and the second device layers when in the second mode of operation;
a serial interface;
a down bridge direction and an up bridge direction and in the up bridge direction the communication bridge includes;
a means for receiving a transport container including a header, and a payload field and at least one control byte with each byte comprising a plurality of bits;
a means for detecting back pressure being operatively connected to the means for receiving;
a means for converting the transport container to the established protocol cell, the means being operatively connected to the established protocol interface and to the means for receiving; and
a means for applying the established protocol cell to the established protocol interface, the means for applying being operatively connected to the means for converting and to the established protocol interface.

8. The communication bridge according to claim 7, wherein the means for receiving the transport container includes a means for receiving a fame having a predefined number of transport containers.

9. The communication bridge according to claim 8, wherein the frame being composed of N blocks of transport containers where N is a positive number with each block including M transport containers where M is a positive number and each transport container includes at least one control byte, and the means for receiving the transport containers includes a means for sequentially receiving a first transport container of a first block through a a last transport container of a last block.

10. The communication bridge according to claim 9 wherein the means for receiving includes a means for detecting communication information in the at least one control byte in a predefined transport container of each block.

11. The communication bridge according to claim 10 wherein the means for detecting communication information further comprises a means for detecting back pressure information in the at least one control byte in selected transport containers.

12. The communication bridge according to claim 11 wherein each block represents a sub-port with each sub-port being capable of connecting to a plurality of ports and preselected ones the plurality of bits in the at least one control byte being used to identify a port with back pressure, wherein the means for detecting communication information further comprises a means for detecting back pressure information in the at least one control byte in selected transport containers, the means for detecting pressure includes a means for detecting a first logic state of a bit identifying the port with back pressure.
